(19) United States
(12) Patent Application Publication
(10) Pub. No.: US 2005/0073206 A1
(43) Pub. Date: Apr. 7, 2005

(54) Bipolar machine

(76) Inventor: Doris Wilsdorf, Charlottesville, VA (US)

Correspondence Address: Bryan D. Wright, Esquire;Williams Mullen, Suite 101, 401 E. Market St., Charlottesville, VA, 22902, US

(21) Appl. No.: 10/918,689

(22) Filed: Aug. 14, 2004

Related U.S. Application Data
(63) Continuation of application No. 10/139,533, filed on May 6, 2002, now abandoned.
(60) Provisional application No. 60/303,394, filed on Jul. 9, 2001.
(60) Provisional application No. 60/313,001, filed on Aug. 20, 2001.
(60) Provisional application No. 60/329,550, filed on Oct. 17, 2001.

(51) Int. Cl. H02K 31/00

(52) U.S. Cl. 310/178

(57) ABSTRACT

A novel homopolar machine with at least one electrically conductive rotatable rotor having at least one predetermined current path, a plurality of current channel insulation layers, and a magnetic field source configured to apply a magnetic field penetrating the rotor and intersecting the current channels when the rotor rotates. The current channel insulation layers are configured for anisotropic current flow both to inhibit eddy currents and to channel current flow between predetermined correlated brush pairs. Two particular configurations are proposed, wherein the source of magnetization generates in the rotor two separate zones with magnetic flux in opposite directions, while the current channel insulation layers guide the current consecutively through these so as to generate the same rotation-sense of Lorentz force.

### REFERENCE TO PARENT APPLICATION

This application is a Continuation of “Bipolar Machines—a new class of homopolar motor/generator,” U.S. Ser. No. 10/139,533, filed May 6, 2002, which is incorporated herein by reference.

This application claims the benefit of U.S. Provisional Patent Application No. 60/303,394, filed Jul. 9, 2001, U.S. Provisional Patent Application No. 60/313,001, filed Aug. 20, 2001, and U.S. Provisional Patent Application No. 60/329,550, filed Oct. 17, 2001.

### CROSS REFERENCE TO OTHER RELATED APPLICATIONS

“Eddy Current Barriers”, D. Kuhlmann-Wilsdorf Provisional Patent Application Ser. No. 60/289,123, Filed May 8, 2001

“Optimizing Homopolar Motors/Generators”, D. Kuhlmann-Wilsdorf, Provisional Patent Application Ser. No. 60/297,283, Filed Jun. 12, 2001

“Bipolar Machines—A New Class of Homopolar Motor/Generator”, D. Kuhlmann-Wilsdorf; Provisional Patent Application, Ser. No. 212657US-20PROV, Filed Aug. 20, 2001

### BACKGROUND OF THE INVENTION

1. Field of the Invention

The present invention relates to a “bipolar machine,” a class of homopolar motor/generator, or in general homopolar machine, with increased voltage per current turn, the capability of operating with direct and alternating or three-phase current, and other advantages.

2. Background

Three basic types of homopolar motors are depicted (PRIOR ART) in FIG. 1 (type I), FIG. 2 (type II), FIG. 3 (type III), and a practical example of a type III machine previously reported to have been constructed but without evidence that it ever operated (FIGS. 4 and 5).

In the past, the practical use of homopolar motors and generators has been inhibited by the large resistance of conventional graphite-based electrical brushes. In principle, multi-contact metal brushes, including metal fiber brushes, foil brushes, and hybrid brushes, i.e. comprising resilient multi-contact metal material that will establish a multitude of electrical contact spots when loaded with light pressure against a slip ring or other metal surface, have removed the previously critical bottleneck that prevented the practical use of homopolar machines. Even so there remain other problems to be overcome. The first and most important problem is low machine efficiency. No homopolar motor has yet achieved efficiency in the range of the high ninety percentile, as is forecast for the motor in FIGS. 4 and 5.

Another obstacle against the widespread use of homopolar machines has been the need for a large number of brushes in brush holders that at the same time permit the application of a substantially constant, rather light (typically less than 1 N/cm²) brush force while large currents are transmitted (e.g. in the order of 650 A/in²≅10⁶ A/m²), and permit the almost frictionless, gradual advance of the brushes as they wear in course of time.

A third obstacle is a too low machine voltage, based on the modest voltage per current “turn”, i.e. passage of current through a rotor moving in a magnetic field, typical for known homopolar machines namely rarely exceeding 20 Volts per turn. This condition necessitates the use of several to many “turns”, and hence a multitude of brushes and brush holders, in order to attain a voltage of at least 100 Volts, and up to many thousands.

Lastly, homopolar motors require direct current and thus are more cumbersome in that voltages cannot be simply changed by the use of conventional transformers.

### SUMMARY OF THE INVENTION

Overcoming Four Impediments Against the Widespread Use of Homopolar Machines

The present invention overcomes these four problems by providing (i) improved efficiency, (ii) improved brush holders, (iii) increased voltage per turn and (iv) the capability of operating, interchangeably if so desired, on DC, AC, and 3-phase current.

Regarding impediment (i), machine function is improved through elimination, or at least strong weakening, of eddy currents in rotors. In the framework of the present invention, this is accomplished by means of narrow insulating barriers parallel to the intended current direction that not only inhibit circulating, or eddy currents, but at the same time may also be employed for guiding currents in predetermined paths. For this reason they have been named “current channeling insulation layers”. As indicated, these (i) provide improved efficiency through inhibition of eddy currents and (ii) may be employed to guide currents in predetermined paths, typically so as to force currents to flow in regions of high magnetic field density that without such channeling would be avoided, and typically between predetermined paired brushes on different slip rings.

Regarding the scientific background the following: According to the present invention, the inefficient operation of conventional homopolar machines is at least largely attributable to the neglect of transverse, unintended voltages, as described by the Hall effect, and the closely related eddy current effect. In fact, the dissipation of energy through joule heating on account of circulatory currents, i.e. the eddy current effect, has so far remained unrecognized for the case of homopolar machines, even though it is well known for electric machine parts without deliberate current, in particular iron cores of electromagnets, transformers, in which eddy currents are suppressed by means of laminating metal instead of using bulk shapes. Yet, eddy current losses can result in such a degree of inefficiency that homopolar machines may be only about 70% or less efficient which may well be the reason why homopolar machines do not appear in practical use except for type I in kilowatt-hour meters in the meter boxes of electrical companies.

The Hall effect and the eddy current effect are closely related. They are direct consequences of the Lorentz force. Namely, the Lorentz force moves charges in a direction normal to the magnetic flux and the momentary velocity vector, in accordance with the vector cross product [v×B],—which is, of course, the very basis of electric motor and generator action (compare FIG. 1). In general, eddy currents are circulating currents normal to the direction of B, induced because the [v×B] vector direction is normal to both B and the velocity vector v of the mobile charge no matter in which direction v may point, thereby leading to disorganized circular currents unless somehow inhibited.

In conductive materials, i.e. materials comprising mobile charges, finite v vectors arise either because the material moves relative to a magnetic field vector B or because mobile charges move within a stationary material on account of an electric field, i.e. in machinery on account of an applied voltage, or a combination of both. In conductors whose dimensions normal to the causative magnetic field are smaller than the eddy current diameter, the eddy currents cannot be completed because the charges impinge on their surfaces. The resulting surface charges cause the Hall effect, i.e. a transverse voltage in, say, horizontal conductors that carry lengthwise induced currents in vertical magnetic fields. As a result, in connection with deliberate current flow in electrical machinery the Hall and the eddy current effect is not widely known or addressed, except for the already mentioned suppression of eddy currents via laminations of iron cores in electromagnets and transformers. This is so because currents are overwhelmingly conducted through wires, which on account of their limited diameter, inherently limit transverse voltage (i.e. Hall voltage) and block eddy currents.

Conductors having dimensions greater than that of winding wire in motors and generators are susceptible to the Hall effect and the Eddy Current effect. The joule losses caused by these effects are negligible or nil in wires because with barriers in the form of electrically insulated wire surfaces, they cannot cause currents. Thus in the coils of conventional machines using wires, Hall voltages remain ineffective and hidden. However, in geometrically wide conductors, i.e. in ribbon- or bar-like conductors and especially in the cylindrical rotors of homopolar machines penetrated by a strong magnetic flux, circulating current loops, i.e. eddy currents, can be completed and their associated joule heat losses can be sizeable.

The same effect exists, whether in the presence or in the absence of voluntary electrical currents, in any conductor that moves in a magnetic field. In this situation the effect is best understood in terms of cyclotron movements of charges in a magnetic field, so well known from high-energy particle accelerators and intensely studied by astronomers as the source of a wide range of cosmic electromagnetic radiation from x-rays to radio wavelengths. To wit, a moving metal in a magnetic field comprises equally high densities of positive and negative charges, i.e. of the positive ions that form the rigid structure of the material, the other of the mobile conduction electrons.

While the Lorentz force acts on all of those potential current carriers, only the conduction electrons are mobile enough to respond with cyclotron movements and in the process generate eddy currents and Joule heat losses. Currents deliberately imposed by EMF's in substantially two-dimensional conductors, such as rotors in homopolar motors, similarly carried only by the conduction electrons, do not remove the effects that cause eddy currents and the associated Joule heat loss.

As part of the present invention, it has been recognized that the low-efficiency of homopolar motors, as for example the one shown in FIG. 3 reproduced from reference [4], may be ascribed to eddy currents circulating in the cylindrical rotor. In that case, losses due to eddy currents were approximately one third of machine power. Namely, as seen from reference [4], the torque required to externally rotate the axle of the machine when disconnected from the current supply, was found to rise by about thirty percent when the magnet current was turned on as compared to it being off. Moreover, with the magnet current turned on, changing the rotation speed from 2000 rpm to 2500 rpm increased the extra loss due to the turned-on magnetic field, roughly in proportion with the velocity, as expected from the above outlined theory of eddy currents, i.e. as driven by the Lorentz force of [v×B].

According to the present invention, the eddy current effect in homopolar machines may be effectively eliminated by interrupting the path of the circular eddy currents within the homogeneous rotor, respectively, the wide bars that form the rotor in the “Superconducting DC Machine” of U.S. Pat. No. 5,032,748 by Sakuraba and Mori (1). This may be accomplished by means of “eddy current barriers” in the form of slots or nonconductive boundaries across the circular eddy current paths. Judging by practical experience, eddy currents are increasingly strongly suppressed by barriers spaced less than 1 cm, 5 mm or, say, 1 mm apart, somewhat depending on magnetic field strength and metal conductivity that in turn depends on temperature.

According to the present invention, an additional valuable feature of eddy current barriers, besides the effective elimination of eddy current losses in homopolar machines, is that they can be configured to provide “current channels,” i.e. structural configurations that constrain currents to flow in intended directions along intended paths (e.g., in a region of high radial magnetic flux, B, that otherwise would be avoided) in the rotor, as will be further explained in connection with FIG. 1. They do this by inhibiting significant current flow at right angles to the intended direction of the current. In one form, current channels, like eddy current barriers, may be created by substantially parallel nonconductive barriers such as slits or cuts through the thickness (i.e., preventing bypass) of a conductive rotor of a homopolar machine, at right angles to the local direction of motion during normal operation that extend in the intended direction of the current, or some combination of conductive and dielectric material configured for the same effect.

Structurally, a “current channel” is thus a conductive path, including its defining or contiguous current channel insulation, configured for anisotropic current flow (i.e., including inhibiting transverse currents in the conductive path.) For the purpose of current channeling, (e.g. between electrical brushes on different slip rings as for example in FIG. 1, which pair-wise brush connection is of central importance for the present invention), conductive connections between neighboring current channels that could permit current flow in other than a predetermined path, of the kind that would be acceptable or harmless in blocking eddy currents, should preferably be avoided.

Further, the relative size of the transverse width of the conductive path to the electrical brush at an end of a predetermined current path of predetermined course and transverse width, e.g. along a “zone” of radial magnetic flux, B, is a factor of concern. In order to create effective current channeling, the transverse width of the conductive path within the current channels in electrical contact with an electrical brush should optimally be smaller than the transverse width of the electrical brush, so as to induce or permit current flow in the desired direction throughout the transverse width of the conductive path and conversely to prevent current flow into or out of the brush from neighboring current channels that are not in electrical contact with the brush (i.e., anisotropic current flow). In this way, a pattern of current channels can guide current between pre-selected brush pairs while preventing current flow along other paths.

Typically the restriction of channel width to smaller than electrical brush width, will not require current channeling barriers to be more closely spaced than the limits already cited for eddy current barriers. However, if a transverse width of the conductive path of a current channel is larger than the brush, then current channeling is incomplete and less efficient because portions of the conductive path are unsupported for the intended current, yet available for current flow that bypasses the brush. Thus, depending on the embodiment and rotor configuration, for the purposes of current channeling the transverse width of the brushes should preferably be larger than two times the transverse width of the conductive path in the current channels so that at any time a brush is electrically connected to at least three current channels. In addition, preferably current channel insulation is a minimum effective width in the transverse direction in order to maximize efficiency and brush contact with the conductive paths.

That a set of substantially parallel barriers against current flow in the rotors of homopolar machines, is capable of suppressing potentially large energy losses through circulating (i.e. eddy) currents, as well as of channeling currents in a pre-determined pattern and especially between brushes on different slip rings, is an important novel part of the present invention That this part of the invention is valuable and not obvious, is proven not only by the low efficiency of the machine in FIG. 3 as already discussed in connection with ref.4, but also by the already cited patent “Superconducting DC Machine” to Sakuraba and Mori, U.S. Pat. No. 5,032,748. In that patent, currents are led in consecutive “turns” along mutually insulated parallel bars (called “segments” that superficially might be mistaken for current channels), which collectively form the rotor (called “armature drum”) of a homopolar machine. In this manner, Sakuraba et al's invention accommodates a multiplicity of current “turns” in one rotor by passing the machine current between brushes at the opposite ends of the bars (e.g., FIG. 4B in U.S. Pat. No. 5,032,748, labeled 5₁ and 5₂, 5₃ and 5₄ etc.), spacing the brushes more than one bar width apart, and transferring the current back to the next bar via current leads between brushes 5₂ and 5₃, 5₄ and 5₅, etc.

This construction reveals that Sakuraba and Mori (1) did not address eddy current losses since the insulation layers between their bars are too widely spaced as to interrupt eddy currents, and (2) did not utilize current channeling because their invention explicitly (e.g. in their claims 1 and 7) requires that the “number of pairs of said brushes is not more than half of the number of segments of the armature drum,” thereby ensuring that no brush would ever contact more than two bars at once. As a result, on average Sakuraba and Mori patent results in the use of only one half of the bars. Had the inventors realized the possibility of current channeling, they would have made their bars suitably slender and placed brushes next to each other at a distance of only one or two (of the now very slender) bars. Thereby they would not only have inhibited transverse currents and eddy current losses, but they would also have essentially doubled the number of “turns”. And they would certainly not have neglected to do so had they recognized this opportunity, because the very object of their invention was to obtain a multiplicity of “turns” and correspondingly increased the voltage of their homopolar machine.

In view of the close relationship between the morphology and electrical properties of eddy current barriers and current channeling patterns, and the fact that both are comprised of locally parallel, reasonably closely spaced insulating layers in the material that are parallel to the intended current direction and thereby inhibit current flow normal to the layers, in the following they are both subsumed under the name “current channel insulation layers”.

From case to case, one or the other aspect of these, (i.e. inhibition of eddy currents or guiding currents between brushes on different slip rings), may be the most, or perhaps the only important, feature. In the former case, (i.e. suppression of circulatory currents), it is not essential that the layers are continuous. E.g. eddy currents will be suppressed by a fibrous structure of high-resistance barriers, provided only that they are closely spaced, i.e. below 1 cm and perhaps down to micrometers. Eddy current would be inhibited even if there existed continuous fairly low-resistance current paths at right angles to the barriers. However, such a geometry is liable to be useless for current channeling because the electrical resistance on the intended path could greatly exceed that of available other paths, e.g. such as to bypass the area of strong magnetic flux in FIG. 1 as will be further discussed below. For current channeling, therefore, the “current channel insulation layers” will typically have to be continuous without opportunities for bypassing.

With this explanation, then, from here on the term “current channeling insulation layers” will be used for both, eddy current barriers and current channeling patterns.

The general form or embodiment of current channelling is a series of mutually electrically insulated substantially parallel electrical conductors that extend in the intended direction of the desired current path, but provide narrow spatial dimension at right angles thereto. Optimally, this current channeling pattern extends through the thickness of the rotors of homopolar machines, setting the intended direction of the current path and being, in effect, assemblies of electrically insulated conductors. Examples of such current channels are strips oriented radially in homopolar rotors, and further assemblies of substantially parallel conductors, such as conductive fibers, that are electrically insulated, such as being embedded in a composite or insulating matrix material, and extended in the direction of the intended current flow, i.e. axially in homopolar rotors. Other examples are assemblies of substantially parallel, electrically insulated metal rods, or foils, or films having a thin dimension normal to both the direction of the intended current path and the direction of the magnetic field. Further, one may use mixtures of any of the above with elements of any size below about 1 cm or one half or less of the brush width, as the case may be. The insulating voidage or insulating/separating material between the substantially parallel electrical conductors is the current channel insulation.

The above embodiments are exemplary, and those skilled in the art will readily see that configurations of a homopolar rotor that interrupt transverse currents, support current channeling, while also interrupting eddy currents and meeting the remaining design needs of the application, are desirable.

Thus, according to one embodiment of the present invention there is provided a homopolar machine including a stator and at least one electrically conductive rotatable rotor configured to flow current in a multiplicity of current paths when it is driven by the current source; a magnetic field source configured to apply a magnetic field penetrating the rotor and intersecting at least one current path when the motor is driven by the current source.

The rotor features current channel insulation layers that extend through the thickness of the rotor, parallel to said multiplicity of current paths during rotation of the rotor, and thus typically but not necessarily at right angles to the local direction of motion of the rotor during normal operation

In preferred embodiments, the current channel insulation layers may intersect the circumferential surface of the rotor, preferably the slip ring surfaces electrically connected to the rotor.

According to a further embodiment of the present invention, there is provided a homopolar generator configured to generate a current when rotated by a mechanical torque, including at least one electrically conductive rotatable rotor configured to flow a current in a multiplicity of current paths when the generator is rotated by a mechanical torque; a magnetic field source configured to apply a magnetic field penetrating the rotor and intersecting at least one current path when the generator is rotated by a mechanical torque. The rotor features current channel insulation layers that extend through the thickness of the rotor provided so as to be parallel to the multiplicity of current paths during rotation of said rotor, and thus typically but not necessarily at right angles to the local direction of motion of the rotor during normal operation.

As with the motor of the invention, it is advantageous in the generator of the present invention that the rotor further includes current channel insulation layers that define the current path and inhibit transverse currents. As with the motor of the invention, it is advantageous in the generator of the present invention that the current channel insulation layers intersect a circumferential surface of the rotor, preferably slip ring surfaces electrically connected to the rotor.

Regarding impediment (ii) Improved Brush Holders, the present invention introduces “Brush Plates”—Holders for Large Numbers of Brushes.

In order to better understand this aspect of the present invention it will be useful to briefly outline some basic facts regarding homopolar machines, as follows: In order to increase the machine voltage, homopolar machines may comprise “sets” of mutually electrically insulated but mechanically fused and geometrically similar electrically conductive rotatable rotors through which the machine current is guided consecutively from, say, the stator to rotor 1, consecutively through rotors 2, 3 . . . to rotor N, and back to the stator. The advantage herein is the fact that the voltages for each current “turn” (i.e. as the current passes any one time through the magnetic field that penetrates the respective rotor) add much like the voltages in a set of electrical batteries connected “in series”. In fact, “current turns” in homopolar motors are the equivalent of wire turns in electric motors with wound armatures as has been recognized already long ago.

A current path with “turns” requires the consecutive passage of the current through at least one brush into and at least one other brush out of any particular rotor, for a total of at least 2N_{R} brushes if N_{R} is the number of nested, stacked or otherwise assembled rotors in a “set” of rotors. Therefore, if the individual rotor (in all significant prior designs accounting for n=1 (i.e. one) current turn) provides a voltage of ¹V_{R}=10 [V], a desired V_{M}=220 [M] machine voltage requires a minimum of
N_{R}=V_{M}/₁V_{R}=22 (1)
rotors, and requires a minimum of 2N_{R}=44 brushes Moreover, the relatively low voltages in previous homopolar machines entail correspondingly high currents at same total nominal (i.e. disregarding losses) machine power W_{M}. Thus for a W_{M}=5000 hp=3.8×10⁶ watt homopolar machine of V_{M}=220V (which in fact is already a high voltage in terms of previous designs), a current of
i=W_{M}/V_{M}=W_{M}/N_{R 1}V_{R}=3.8×10⁶[w]/220[V]=17,300 [A] (2)
is required which puts a considerable burden on the external electrical connections (i.e. “buses”) that supply the machine power.

Correspondingly, a large number of electrical brushes is needed that, in practice, limits the design and forecast use of homopolar machines. Even though multi-contact metal brushes have in principle removed the previously insurmountable problem of the associated power loss, namely equivalent to roughly I V per traditional graphite-based brush, including electrical and mechanical power loss, as compared to about 0.1 V per brush for multi-contact metal brushes, the installation, cost and maintenance of electrical brushes in homopolar machines remain a problem. Specifically, the current density in multi-contact metal brushes is, empirically, so far limited to j_{B,max}≅2×10⁶[A/m²]. Moreover, adsorbed moisture is needed for brush operation outside of liquids, and this is depleted unless humidity has access to slip ring areas between brushes. Therefore, again empirically to-date, in the open atmosphere at reasonable humidity or in a moisturized CO₂ atmosphere, only a fraction f_{B} of available slip ring area may be covered with brush foot prints, at maximum, to present best knowledge, f_{Bmax}≅50% of slip ring area (compare ref. [12]). Furthermore, again in order to not deplete absorbed water, according to present best empirical experience the length of continuous metal fiber brush foot print in sliding direction is at most, L_{BSmax}=5 cm. And finally, with large numbers of rotors with parallel slip rings, one does not want to unduly extend the machine length and, therefore, will try to make slip ring widths, Δ, as small as possible. But this in turn is limited by the needs of brush construction and to avoid short circuits among brushes on neighboring slip rings. It is therefore tentatively concluded that at a minimum a slip ring width of Δₘᵢₙ≧0.25 cm=2.5×10⁻³ [m] is required.

The result of these considerations is that numerous brushes are needed on a minimum total slip ring area of
A_{S}≧2N_{R}i/f_{Bmax}j_{Bmax}=2W_{M}/(₁V_{R}f_{Bmax}J_{B,max}) (3a)
which, as seen, is independent of N_{R}, the number of rotors used, but is inversely proportional to ₁V_{R}, the voltage per turn. Thus for the present example of a W_{M}=5000 hp=3.8×10⁶ watt machine with ₁V_{R}=10[V], the minimum slip ring area is
A_{S}≧2×3.8×10⁶[w]/{10[V]×0.5×2×10⁶[A/m²}}=0.76[m^{2]} (3b)
while in this example, i.e. with V_{M}=220V, ₁V_{R}=10V and N_{R}=V_{M}/₁V_{R}=, the minimum total slip ring width, and hence the extra machine length on account of slip rings, is a modest
L_{S}≧2N_{R}×Δₘᵢₙ=2×22×2.5×10⁻³=0.11 m. (3c)

However, the minimum number of brushes (N_{B}) on slip rings of width Δₘᵢₙ, with maximum brush length in sliding direction L_{Bmax}=5 cm and with f_{Bmax}=½ slip ring occupancy, is large, namely

N_{B}=½A_{S}/(fₘₐₓL_{Bmax}Δₘᵢₙ)=½0.76[m²]/{5×10⁻²[m]×2.5×10⁻³[m]}=3,040 (3d)

This is such a formidable number of electrical brushes that one will prefer to increase the slip ring width to, say, Δ=1 cm, and the working area per brush to A_{B}=5 cm² so as to reduce the number of required brushes for the discussed hypothetical W_{M}=5000 hp motor to
N_{B}=½A_{S}/A_{B}=½×0.76/5×10⁻⁴=760 brushes (3e)

The above example will have made it clear that the future of homopolar motors depends on decreasing the number of brushes and on simplifying their installation and management. As seen, this problem is independent of the number of turns. As it is, a large number of turns, N_{R}, is very beneficial since it increases the machine voltage, thereby inversely decreasing the required current at fixed machine power, and thus the required wiring/busing to and from the machines, but it is no aid in the brush problem.

According to the present invention, the discussed problem of the cumbersome management of large numbers of individual brushes, in individual brush holders, is alleviated by the use of rigid “brush plates,” comprising mutually electrically insulated parallel metal strips, from which, in lieu of individual brushes, protrude segments of multi-contact metal brush strips that slide on correlated parallel mutually insulated slip rings. Between segments of brush strips, gaps ought to be left for the access of moisture where needed. The brush plates are configured to simultaneously conduct current to or from the brush strips, to apply brush pressure to the brush strips, and to geometrically advance the brush strips as they wear.

Thus, according to one embodiment of the present invention, there is provided a novel homopolar machine configured to be driven by a current source when operating in motor mode and to generate a current when operating in generator mode, including a plurality of mutually electrically insulated conductive rotatable rotors configured to flow a current in a path from a stator consecutively through the rotors along current channels and back to the stator; a magnetic field source configured to apply a magnetic field penetrating the rotors and intersecting the current channels; a plurality of electrical brushes in the form of strips of multi-contact metal material for providing a low-resistance current path between mutually electrically insulated slip rings on said rotatable rotors, and at least one brush plate for providing a low-resistance path between said stator and said electrical brushes in the form of strips of resilient multi-contact metal material, wherein said at least one brush plate is configured to at the same time apply a mechanical force and establish an electrical connection between said multi-contact metal brush strips and correlated slip rings on said plurality of electrically conductive rotatable rotors.

Overcoming the third Impediment: (iii) Increased Voltage Through the Bipolar Design

(a) General Considerations

In line with eqs. 1 to 3, it would be highly desirable to increase the value of 1VR in order to proportionately increase the machine voltage, V_{M}, at fixed W_{M} thereby to simultaneously reduce the required current i, the number of rotors N_{R}, the total slip ring area A_{S}, and the number of brushes N_{B}. Physically, for a cylindrical rotor of radius R_{R}, that is intersected over length L_{R} by a radial magnetic flux B and spins about its axis with angular velocity ω=RPM/60 [rad/sec], i.e. surface speed v_{R}=ωR_{R}=(RPM/60) R_{R}, it is ₁V_{R}=n[v_{R}×B]L_{R}. If, as is generally the case, v_{R}, L_{R} and B are mutually perpendicular,
₁V_{R}=n v_{R}BL_{R}=n(RPM/60)R_{R}L_{R}B (4)

Here n is the number of times the flux intersects the rotor (a factor that will be explained below). Similarly, for a circular rotor of radius R_{R} spinning about its rotational axis at circumferential speed v_{R} while intersected by axial flux B between outer and inner radii R_{R} and R_{A}=αR_{R}
₁V_{R}=½nv_{R}R_{R}(1−α²)B=½n(RPM/60)R_{R}²(1−α²)B (5)

Consequently, the desired increase of ₁V_{R} can be accomplished by raising any one or more of n, v_{R} (i.e. RPM), R_{R}, L_{R} and B. Previous designers of homopolar machines have considered the same factors except for n, but opportunities for increasing ₁V_{R} are limited, as follows:
(i) R_{R} and L_{R} are limited by the volume of the intense magnetic flux field, and previously no solution was found to extend R_{R} and/or L_{R} to much above about 1 m.
(ii) The magnitude of the flux density B is linked to the magnets used. Very roughly, B=1 tesla for permanent and electromagnets, and B up to perhaps 4 tesla for superconducting magnets. This increase of B and attendant increase of ₁V_{R} is the reason why over the past several years only superconducting homopolar machines have been under serious consideration. However, the requisite cryogenic installations are costly and voluminous and, further, are feasible only for large machines, ruling out use in passenger cars or hand-held tools, for example.
(iii) v_{R} is limited by, firstly, the maximum safe, long-term sliding speed of multi-contact electrical brushes, that empirically is about 30 m/sec. Secondly, in order to adapt high rotation speeds of homopolar machines to practical applications, e.g. about 100 to 150 RPM for many naval (shipboard) uses, reduction gears are needed. These add to the cost and volume and, critically for naval applications, are avoided because of noise.
(iv) n has apparently not been considered in the past.

The present invention addresses all four of the above factors, i.e. (i), (ii), (iii) and (iv) above, as follows.

(b) Increased Value of L_{R}

In one form of the invention, the stationary magnetic field source is a bar magnet or a plurality of adjoining similar bar-type magnets, in the shape of a flattened rod that is elongated in the direction of the rotation axis and whose axis of magnetization is at right angles to the rotation axis and which is enclosed within a set of nested mutually electrically insulated rotatable cylindrical rotors, as indicated in FIG. 15B. The cylindrical rotors are provided with axially oriented current channels over their length, excepting a zone at one end dubbed the “return end,” which extends beyond the length of the source of magnetization. The nested rotatable cylindrical rotors extend beyond the length of the stationary magnetic source also at the opposite end that is provided with current channels, dubbed the “entry end”.

The strips of north and south poles of the source of magnetization thus generate two stationary diametrically opposite bands of magnetic flux source of length L_{R}, designated as (a) and (b), that extend parallel to the axis, wherein the flux radially penetrates the cylindrical rotors in the same direction on both the (a) and the (b) side. The flux return for the magnetic field between the (a) and (b) sides of the described source of magnetization is a thick-walled tubing of magnetically soft material that surrounds the cylindrical rotors (see FIG. 15B).

In order to create the requisite current paths that intersect the magnetic flux at right angles, the cylindrical rotors may be provided with slip rings about both ends, and with at least one electrical brush per slip ring that is electrically insulated from all brushes on parallel slip rings, which brushes are positioned in at least one of the zones of magnetization. In such an arrangement, current may be fed into a brush, say brush 1e, sliding on the slip ring on the entry end of the innermost rotor, dubbed rotor #1, and be extracted from rotor #1 by the at least one electrical brush on the slip ring on the opposite side, say brush 1r at the return end of rotor #1.

The voltage difference between brushes 1e and 1r, and in fact any pair of brushes on opposite ends of one rotor, is then given by eq. 4 with n=1 and R_{R} the radius of the cylindrical rotor. Unlike L_{R}, the value of R_{R}, which normally will approximate the separation distance between the poles of the source of magnetization, cannot be arbitrarily increased because this requires the corresponding increase of the radius of the flux return cylinder with a weight penalty that rises as R_{R}², whereas at constant current the voltage, and thus the motor power, increases only linearly with R_{R}. By contrast, at same current and other parameters, to a first approximation the motor power as well as the weight rise proportionally with L_{R}.

A second “turn” may be added by electrically connecting brush 1r to brush 23 sliding on the entry end of rotor #2 in the same zone, e.g. (a), whence the current flows to brush 2r on the return end, on to brush 3e and so on. The advantage of this arrangement will be a possible almost indefinite increase of L_{R}, to potentially much larger values than the previously achievable maximum of up to 1 m, e.g. in podded ship drives perhaps up to 12 m or even more.

(c) Flux Density

In the present invention, permanent magnets are envisioned for most of the embodiments considered herein, simply for reasons of practical configuration and cost. Electromagnets, though currently feasible, may become more practical as pricing and technology change.

(d) Increase of v_{R}

Since in the described arrangement, the slip rings are positioned beyond the magnets, they may be narrowed to a radius well below R_{R}, depending only on considerations of mechanical construction that will be discussed below. Thus by halving the slip ring radius, both the brush sliding speed, v_{R}, and the dimensionless brush wear rate may be halved at same motor rotation speed. This is a valuable option when high rotation speeds are acceptable, but less so for large ship drive motors which require low rotation speeds.

(e) Increase of “turns” to n=2 per Rotor

If in the current path described under (i) above, brush 1r were to be connected to a brush 23 that is situated on the (b) side, the current passage from 23 to 2r would cause a potential difference of opposite sign than if 23 were situated on the same side as brush 1e, i.e. on the (a) side. Namely, in the geometry of FIG. 15B, current passages from return end (r-end) to entry end (e-end) or vice versa cause equal and opposite potential differences on the (a) and (b) side, since the current path is reversed relative to the cross product of v_{R} and B. Correspondingly, instead of connecting brushes 1r and 23 on the (a) side, or similarly both brushes on the (b) side, one may let the current flow from the e-end to the r-end on the (a) side and cycle back from the r-end to the e-end on the (b) side thereby doubling the potential difference within one rotor, thus obtaining n=2 in equation 4. Machines with this design, in which n=2, are dubbed “bipolar”.

Not only is the bipolar design very favorable in terms of the voltage difference, but it halves the number of required brushes per unit potential difference since it does not require any brushes on the return end, i.e. the r-end. This is so because, as already indicated, the r-end is made to be free of the current channels so that (a) and (b) brushes would be short-circuited on the r-end, while (a) and (b) brushes are electrically insulated on the e-end. The only requisite connections between brushes are therefore, in general, from the (b) brush on rotor n to the (a) brush of rotor (n+1).

The modified bipolar design is also possible with circular instead of cylindrical rotors. In that case the requisite equal and opposite areas of magnetic flux may be generated by two pairs of horse-shoe-type magnets that face each other across the plane of the rotors as in FIG. 7.

(iv) Operation with DC, AC and/or 3-Phase AC

While positioning of more than one brush on one slip ring on rotors without current channel insulation layers penetrating the slip ring surface, is tantamount to short-circuiting them, brushes on slip rings that are intersected by current channel insulation layers are therefore mutually electrically isolated at distances exceeding the spacing of those layers. Thus by omitting the return end that in the already discussed design is free of current channels, and instead extending the current channels from end to end, any bipolar motor can be used with DC, AC or 3-phase current, depending on electrical connections among brushes. Specifically, positioning separate brushes on the (a) side and on the (b) side, both on the e-end and on the r-end, and designating them as (a,e), (a,r), (b,e) and (b,r), respectively, the already described DC operation is obtained by interconnecting the (a,r) and (b,r) brushes for any one rotor and electrically connecting, in general terms, the (b,r) brush(es) of rotor (n) to the (a,e) brush(es) of rotor (n+1 ).

Operation with alternating current, whether one phase or three-phase, requires treating the (a) and (b) sides as separate motors and operating them on the + and − phase by means of rectifiers, but in opposite directions. In that case, therefore, there are no connections between any (a) and (b) brushes, and the turns from rotor to rotor are accomplished by, in general terms, connecting brush (a,r) of rotor n to brush (a,e) of rotor (n+1) and similarly connecting brush (b,e) of rotor n to brush (a,r) of rotor (n+1). Methods for efficiently changing brush connections in individual machines so as to switch between DC and AC, will have to be worked out and may be cumbersome when large numbers of brushes are involved, although the use of brush plates may offer a solution. However, reversal of rotation direction is effected very simply by interchanging the + and − phase connections to the machine.

Alternatively, according to the present invention, operation that can be easily switched between DC and AC or 3-phase power, is accomplished by “in tandem” operation of two similar machines, i.e. by means of two similar machines operating on the same axle. When driven by direct current, the two motors may be electrically connected in series, in which case the power delivered to, or extracted from, the axle is twice that for the single machine at same current but at twice the applied voltage needed for, or delivered by, one machine. This, then, is a means of increasing the machine voltage. Alternatively, the “in tandem” machine pair may be electrically connected in parallel. In that case, again, the power delivered to or extracted from the axle is twice that for the single machine but at same voltage and doubled current. For AC operation of the same machines in tandem, rectifiers are placed in the electricity supply to the two machines, and are hooked up in one direction for one machine and in the opposite direction for the other machine, e.g. for a +phase input into the (a) side of one machine and a −phase input into the (b) side of the other machine.

While both motors and generators may be operated with AC as indicated, the output of bipolar generators will be rippled DC. There is as yet no proposal of how to generate alternating current by means of the bipolar design.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 (PRIOR ART) is a perspective view of a type I homopolar generator according to Faraday (1831) that if connected to a current source instead of to a galvanometer will serve as a motor.

FIG. 2 (PRIOR ART) is a cross section through a type II homopolar motor/generator.

FIG. 3 (PRIOR ART) is a perspective view, partly in section of a recent type III homopolar motor/generator.

FIG. 4 (PRIOR ART) is a side elevation, partly in section, of a type III homopolar generator of 1959.

FIG. 5 (PRIOR ART) is a sketch of the homopolar generator of FIG. 4.

FIG. 6 is a sketch of possible embodiments of eddy current barriers or current channel insulation layers, whether by cuts or with insulating material between electrically conducting material, in any form of current channeling, according to the present invention; (A) for type I machines, (B) for type III machines and (C) for type II machines.

FIG. 7A is a perspective view of the magnet arrangement in a bipolar machine with circular rotors.

FIG. 7B is a perspective view of a lengthwise cross section through a bipolar machine of the type in FIG. 7A without showing the magnets.

FIG. 7C is a cross-sectional view and indicated current flow lines normal to the axis of the bipolar machine with circular rotors shown in FIGS. 7A and 7B.

FIG. 8A is a cross section of “scarfed” slip rings provided with insulating “separators” between neighboring slip rings suitable for any homopolar or bipolar machine.

FIG. 8B is like FIG. 8A but with the slip ring metal extending onto one side of each insulating “separator” between neighboring slip rings.

FIG. 8C is like FIGS. 8A and B but with separators eliminated by slip ring shaping.

FIG. 8D shows slip rings with angled metallic extensions with scarfed brushes.

FIGS. 9A and B illustrate methods of fastening fiber brush material to brush holder strips (A) by means of dove tailing and (B) by means of conductive adhesive.

FIG. 9C is a semi-schematic view of brush holder strips from inside a brush plate.

FIG. 10A is a perspective view of a brush plate with flexible joints and bridge connectors between brush holder sections.

FIG. 10B illustrates the interfacing of brush plates with a stationary rigid bridge. 30

FIG. 11 is a cross section of brush plates with brushes and rigid bridges to clarify the problem of brush and brush plate adjustment to non-uniform brush wear.

FIG. 12A is a perspective view with partial cut-out of two similar bipolar machines with circular rotors in tandem, arranged for operation with alternating current.

FIG. 12B is a perspective view of one of the machines in FIG. 12A but without cutout showing a possible brush plate arrangement.

FIG. 13A is a perspective view of part of a brush plate with fibers (not shown) slanted in the plane parallel to the sliding direction.

FIG. 13B is a plan view (including fibers) of FIG. 13A.

FIG. 13C is a perspective view of part of a brush plate with fibers (not shown) slanted in the plane normal to the sliding direction, i.e. in “scarfed” orientation.

FIG. 14 shows lengthwise cuts through a bipolar type machine with circular rotors and reduced slip ring diameters for minimizing brush sliding velocities, with less (top) and more detail (bottom).

FIG. 15A shows a schematic perspective view of the axle, magnet and flux return of a bipolar machine with cylindrical rotors.

FIG. 15B shows a cross sectional view of the machine of FIG. 15A, including the set of rotors with indicated magnetic field lines.

FIG. 15C is a schematic perspective view of a bipolar machine as in FIGS. 15A and 15B, showing rotors, rotor rims and brushes with indicated current flow and connections between brushes by means of bridges.

FIG. 15D shows a cross sectional view of the type of bipolar machine as in FIGS. 15A to C but with an alternative arrangement of brushes on two slip rings.

FIG. 16 is a schematic lengthwise cut of a bipolar machine with cup-shaped rotors, clarifying the mechanical construction.

FIG. 17 illustrates method 1 of making a bipolar machine with cylindrical rotors. (A) Perspective view of stack of layered sheets half-way wound for making a set of cylindrical rotors. (B) Perspective view of assembled machine. (C) Adjoining, aligned magnets in tray or shaped tubing that replace one long magnet.

FIG. 18 is a perspective view with cut-out that illustrates method 2 of making a set of cylindrical rotors of a bipolar machine.

FIG. 19 shows a method by which current channels may be made in the course of method 1 or 2 of making bipolar machines with cylindrical rotors.

FIG. 20 illustrates how, in method 2, slip rings and separators can be made for a bipolar machine with cylindrical rotors. (A) Section through rotors, rims, slip rings and barriers between slip rings. (B) Enlargement of part of A. (C) Perspective view of a pre-formed slip ring and separator that may be used in method 2 of making bipolar motors with cylindrical rotors.

FIG. 21A is a cross section parallel to the axle of an assembled bipolar machine with cylindrical rotors and slip rings of reduced diameters, showing the arrangement of the various components.

FIG. 21B shows a detail of (A) to clarify how pre-formed slip rings with reduced radii can be fitted to the cylindrical part of the rotors.

FIG. 22 is a lengthwise cut through a rotor made of a current channeling material with attached slip rings and bottom strips. (A) Overview of one particular configuration. (B) Alternative configurations of slip rings and brushes. (C) Overview of another particular configuration. (D) Additional alternative slip ring/brush/brush plate configurations, and (E) to (G) are further modifications.

FIG. 23 is a schematic side view of a long bipolar machine composed of three sections that have been fitted together.

FIG. 24 clarifies three different ways for electrically interconnecting brushes in a bipolar machine with cylindrical rotors and current channels that extend the whole length of the machine. (A) Outline of the rotors. (B) Connections and current flow in the basic bipolar design. (C) Connections and current flow when the two sides of the machine are operated with DC “in parallel”. (D) Connections and current flow lines for use with AC current.

FIG. 25 identifies symbols used in calculating the performance of a bipolar machine with cylindrical rotors.

FIG. 26 illustrates the basic geometry of rails and fibers in the manufacture of the fibrous parts of rail strips with fibers slanted in accordance with FIG. 13.

FIG. 27 are perspective views of rails with profiling for making different fiber slants. (A) Rails with the morphology of concrete rebars. (B) Rails with protrusions. (C) Cross sectional view of (B).

FIG. 28 shows fiber tow wrappings on rails in making the fibrous parts of brush strips. (A) Simple winding. (B) Winding on hooks on either side of pair. (C) Figure-eight winding.

FIG. 29 shows different ways of crimping a sheath about the rails and fibers wound on them in the manufacture of brush strips. (A) Crimping by means of segments of a slotted tubing. (B) Crimping by means of a shaped metal sheath in conjunction with a shaped rail.

FIG. 30 is a cross section of a rail including a cavity, with fibers wound on it, before and after crimping a sheath over it.

FIG. 31 shows cross sections of rails with fibers after crimping. (A) Protrusions or hooks as in FIGS. 27B/C and 28B after crimping. (B) Fibers after figure-eight winding as in FIG. 28C after cutting the two rails apart in the manufacture of brush strips.

FIG. 32 is a schematic top view of a production line for brush strips, including cutting the fibers between rails after embedding them in a temporary matrix, curving the pieces to the shape of their intended brush plates, and cutting them into sections lengths.

FIG. 33 (left) is a top view of a completed brush strip, and (right) is a cross section of a completed brush strip with inclined fibers as in FIG. 13A, 13B or 13C.

FIG. 34 is a perspective view of wound fibers on a rail pair, temporarily stitched on either side of the future cut of the fibers between the rails as in FIG. 32, with an easily removable stitching, to facilitate insertion of the future brush plate on a series of slip rings.

### DESCRIPTION OF THE PREFERRED EMBODIMENTS

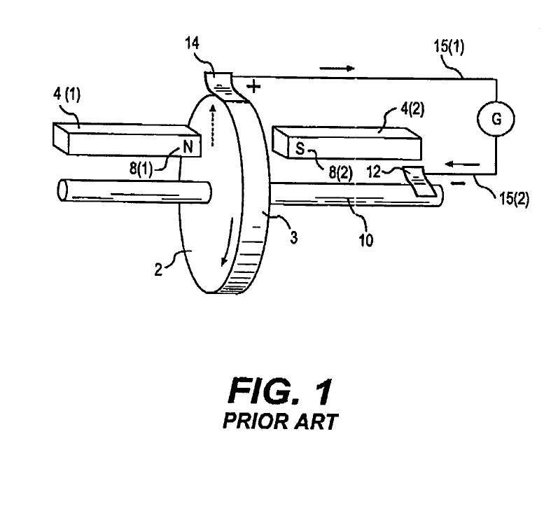

A. Regarding Current Channeling Means (FIGS. 1 to 6)

Referring now to the drawings, wherein like reference numerals designate identical or corresponding parts throughout the several views, the present invention will now be described.

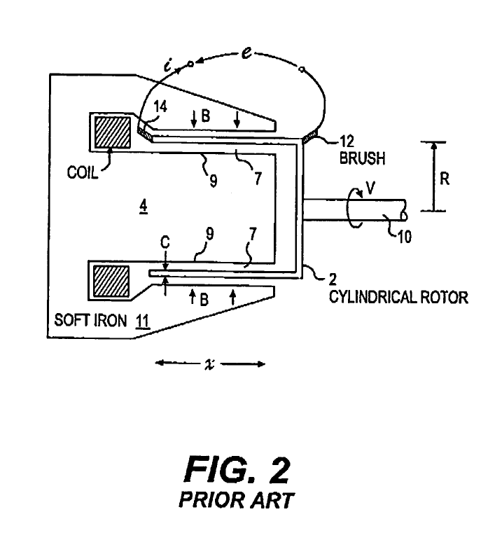

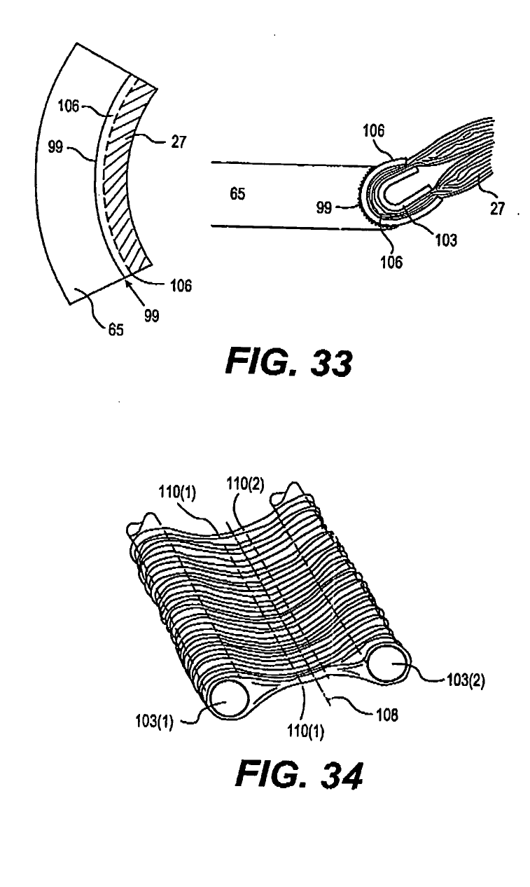

FIG. 1 (prior art) is a reproduction of FIGS. 2-38of ref [1]. It is a perspective view that shows the basic structure of type I homopolar machines as invented 1831 by Michael Faraday. Herein FIG. 1 depicts the type I homopolar machine as a generator, but it can be also used as a motor. It includes an electrically conductive rotor 2 between magnetic poles 8(1) and 8(2) of two bar magnets 4(1) and 4(2) and is mechanically rotated in counter-clockwise direction by means of electrically conductive axle 10, to which rotor 2 is electrically connected. As a result of the motion of rotor 2 an EMF is induced in the area of rotor 2 that is penetrated by the magnetic flux, B, of magnets 4(1) and 4(2). By magnitude and direction that EMF is proportional to [v×B] where v is the local velocity of rotor 2 relative to magnets 4(1) and 4(2). Consequently the EMF is radial as indicated by the vertical arrow. The EMF produces a current that is measured by galvanometer G in the circuit that will now be described.

The current travels through the circuit beginning in the upper portion of rotor 2, travels via the circumferential electrical brush 14 sliding on rim 3 of rotor 2 through the electrical cable 15(1) to the positive terminal of galvanometer G. The current exits at the negative terminal of galvanometer G though electrical cable 15(2) and from there travels via the axial brush 12 that slides on the axle 10 back into rotor 2.

Brushes 12 and 14 are shown in the form of flexible metal strips that were used by Faraday. In modern machines other types of brushes would be used, and one would place the rotor between similarly positioned poles of one toroidal magnet instead of the poles of two separate bar magnets as used by Faraday. However, toroidal permanent magnets, i.e. magnets that are shaped such that their two poles face each other, were not available to Faraday, and even less toroidal electromagnets, let alone toroidal superconducting magnets that now are the tools of choice for homopolar machines.

The type I homopolar generator depicted in FIG. 1 converts the mechanical energy input through the torque applied to axle 10 to rotate rotor 2 into electric energy, as do virtually all electrical generators based on electromagnetic induction, except for the following losses: (i) a typically minor loss through mechanical friction, including that due to the brushes; (ii) a major loss to be discussed below due to eddy currents; and (iii) another loss due to the current bypassing the rotor area that is penetrated by magnetic flux, so that it does not convert mechanical into electrical energy but generates Joule heat in the rotor, brushes and electrical cabling.

In the set-up of FIG. 1 the generated electrical energy is not utilized and is simply converted into Joule heat within galvanometer G, within the wiring 15(1) and 15(2), through the electrical impedance within rotor 2 including that through eddy currents and current bypassing, and on its passage through brushes 12 and 14. In actual practice, a “load”, e.g. a paying customer in the case of utilities, would abstract the electrical energy for other purposes at the position of G.

By reversing the operation, i.e. by supplying electrical energy through passing a current through the same circuit by means of an externally applied EMF, a torque is generated in the rotor and the type I homopolar generator of FIG. 1 is converted into a type I homopolar motor, without any structural changes whatever. With some minor exceptions, the same reversibility applies to all electric generators and, conversely, motors that depend on electrical induction. For this reason, in the present invention the word homopolar machine is used whenever the device could be used either as a motor or a generator.

FIG. 2 (prior art) is a reproduction of FIG. P1.31 of ref. [2] that shows the basic structure of a type 11 homopolar machine. It is characterized by cup-shaped rotor 2 (in the drawing somewhat inaccurately labeled “cylindrical rotor”) whose cylinder wall of indicated thickness c, extends with some clearance into a matching cylindrical gap 7 between the pole-pieces of electromagnet 4. Electromagnet 4 consists of a specially shaped soft iron core 11 that is energized by the indicated electric coil such that the magnetic field (marked by arrows B) between the pole pieces on either side of the cylindrical gap penetrates the cylindrical part of rotor 2 uniformly everywhere from the outside to the inside. When rotor 2 is mechanically rotated by means of axle 10, in clockwise direction as indicated by arrow v, an EMF in the axial direction is induced in the cylindrical part of rotor 2. An electrical circuit that is symbolized by curved arrows near the top of the drawing is established by means of the axial electrical brush 12 and circumferential brush 14 whose brush holders are, as in FIG. 1, not shown. The disk-shaped bottom part of cup-shaped rotor 2 is outside of the magnetic field area at its left and serves the mechanical function of joining the cylindrical part of rotor 2 to axle 10 but does not contribute to the generator function of the machine. The general considerations regarding homopolar machines given in conjunction with type I homopolar machines above, apply also to type 11 machines. In fact, in principle type I and type II machines are alike except in the geometry of their magnets and rotors and, most importantly, of the absence of losses through current bypassing in type II since in it all of the active area of rotor 2 is uniformly penetrated by flux.

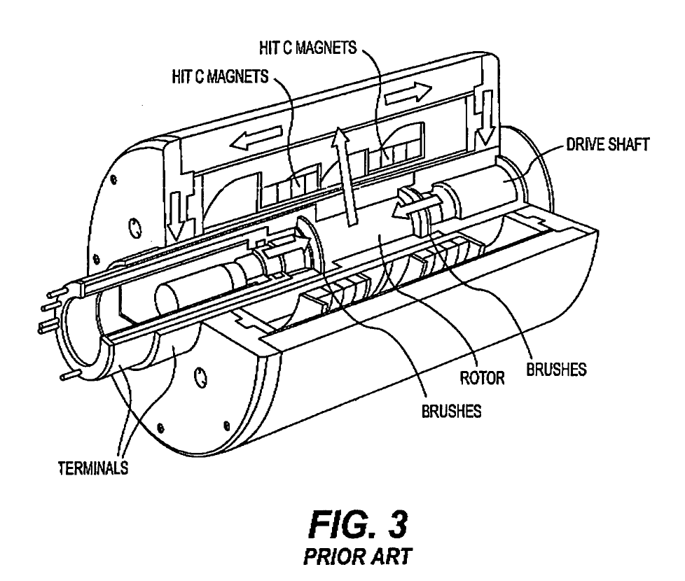

FIG. 3 (prior art) is a reproduction of FIG. 1 of ref. [4] that shows a modern type III homopolar machine. This differs from types I and 11 by utilizing two similar, axially aligned but opposing magnets. The resulting flux path is indicated by broad arrows and intersects the cylinder surface of the rotor at nearly right angles everywhere. In the specific case of FIG. 3, and typical for modern type III homopolar motors, these are superconducting magnets, i.e. solenoids of many turns of superconducting wire cooled to below their critical temperature.

In principle, the source of the magnetic flux penetrating the rotor or rotors, whether permanent magnets, electromagnets or superconducting magnets, does not affect the generator or motor action of homopolar machines of any type. Even so, type III machines are typically based on superconducting magnets because, (i) they can achieve much higher flux densities, B, and (ii) unlike electromagnets and permanent magnets, superconducting magnets do not require a core filled with a ferromagnetic material. Therefore they can be lighter in addition to being more powerful than ordinary electromagnets, which in turn tend to surpass permanent magnets. Moreover, hollow spaces inside the opposing superconducting magnets such as in FIG. 3, can accommodate the two ends of a single cylindrical rotor, or a set of nested cylindrical rotors, of a type III machine, as well as their slip rings and the brushes and their brush holders sliding thereon. However, the expense and volume requirements of a superconducting magnet and its cooling system are justifiable only for relatively large machines, e.g. are ruled out for cars, let alone handheld tools.

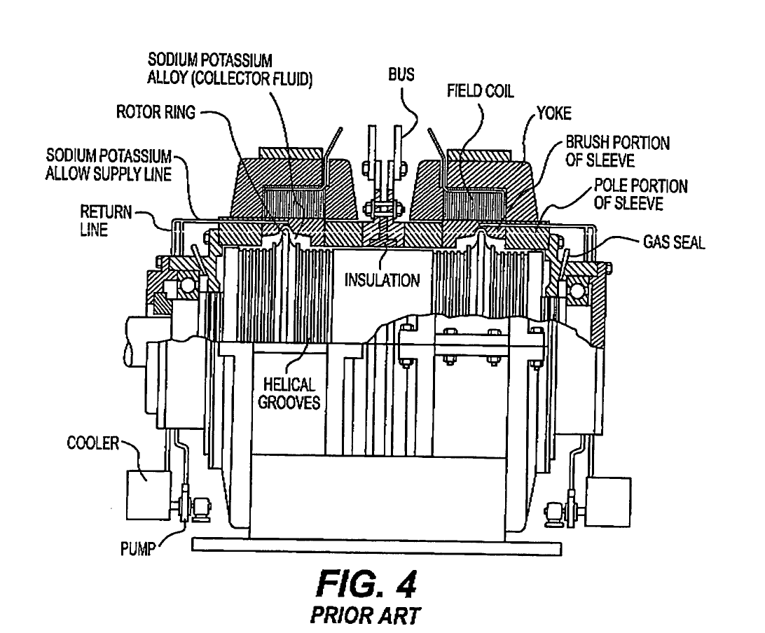

FIG. 4 (prior art) is a reproduction of FIGS. 2-40 of ref [1] showing the side elevation, partly in section, of a homopolar machine of type III which at the time of writing of ref [1] was in process of development by the Allis-Chalmers Manufacturing Company. It was rated at 80,000 amp at 75 volts, i.e. 8,000 hp, with an expected efficiency of 98% and was designed to use Na—K liquid metal brushes.

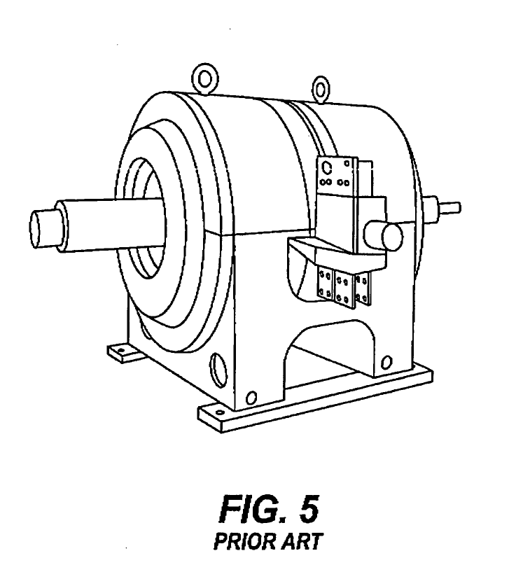

FIG. 5 (prior art) is a sketch based on a photograph of the machine of FIG. 4. It is doubtful that the machine was ever successfully completed on account of problems with the liquid metal Na—K brushes. At the least, there is no record that the machine was ever in use, whereas an intense effort to develop similar Na—K liquid metal brushes was abandoned after several years of development effort at the previous David Taylor Naval Research and Development Laboratory in Annapolis, Md., when liquid metal Na—K leaks through seals could not be prevented. Independently, it is extremely doubtful that the motor of FIGS. 4 and 5 could have achieved 98% efficiency since there is no indication that steps were taken to prevent eddy current losses to be further discussed below.

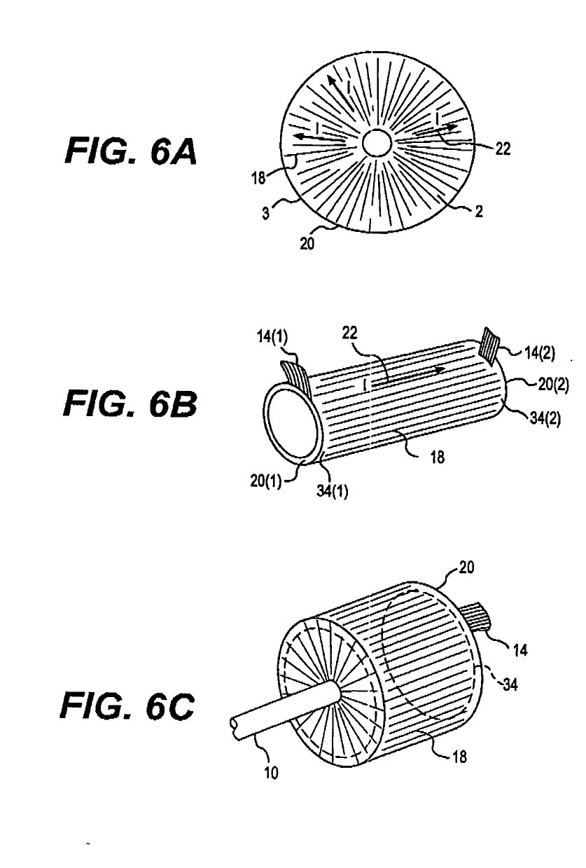

FIG. 6 demonstrates different geometries of eddy current barriers or current channel insulation layers for curtailing the Joule losses on account of eddy currents according to the present invention. For such an embodiment with a rotor made of conductive material, current channels may be defined by the current channel insulation layers 18 separating the conductive channels or neighboring conductive parts of the rotor. Current channel insulation layers 18 interrupt the transverse current component, i.e. the component at right angles to the intended direction of currents, I, in a rotor or stack of rotors 2 that result from the eddy current effect. The intended currents, I, flow between the current channel insulation layers, along the current channels. For the purpose of suppressing Joule losses through the eddy currents, current channels and their insulation 18 are preferably located in those areas of rotors 2 that are penetrated by strong magnetic flux and, further, current channel insulation 18 is preferably arranged parallel to the intended current direction 22. They are therefore preferably radial in circular, i.e. disk-shaped rotors of type I homopolar machines as in FIG. 6A, axial in the cylindrical part of rotors of type II homopolar machines as in FIG. 6C, and axial in rotors of type III homopolar machines as in FIG. 6B. Also the circular part of the cup-shaped rotor 2 in FIG. 6C, i.e. what would be the bottom of the cup, might be provided with radial current channel insulation layers, but those are not required because this part of the rotor is not inside a high magnetic flux area. Current channel insulation layers 18 may be slots or cuts all the way through the rotor 2 or set of rotors (and thus force the current to travel in the solid portion of the rotor 2 between adjacent current channel insulation layers in the intended direction of the current 22). In order not to unnecessarily increase the Joule loss due to the intended current flow in the rotor, slots or cuts, like other current channel insulation, such as insulating layers on, or insulating matrix material between, metal fibers or foils, should be as narrow as possible, consistent with their function of providing very high local resistance to currents transverse to the intended current direction 22 but minimal interference with the intended current flow. Therefore current channel insulation layers may include preferably a suitable insulator material, e.g. lacquer within slots or cuts, or between conductive foils, as may at the same time be advantageously used in joining rotors in an electrically insulating manner within a set, so as to forestall accidental contact between opposite conductors. As an important additional benefit, such filling of slots or cuts will mechanically strengthen rotors.

It depends on the severity of the eddy current effect, as well as on the intended efficiency of a homopolar machine what fraction of rotor areas may need eddy current barriers. In general, let the power loss (in units of energy per unit time) due to eddy currents, W_{H}, amount to x % of ideal machine power, W_{Max}, in the absence of eddy current barriers (or in general any current channel insulation layer pattern that will inhibit eddy currents). Let this loss decrease to hx % if eddy current barriers or current channels insulation layers were applied to all of the active rotor area, meaning essentially all of the rotor area that is responsible for the machine operation, but let only the fraction c of the active rotor area actually be configured with eddy current barriers or current channel insulation layers. Lastly, let the desired machine power be 100%-y %, and let all other machine losses (including windage, friction losses, brush losses, Joule heat losses on account of ordinary rotor and wiring resistivity) be z %<y % of W_{Max}. In that case, the actual machine efficiency would be
W_{Machine=}W_{Max}{1−z−(1−c)x−chx} (6a)
which would yield the desired machine efficiency of W_{Machine}=W_{Max}{1−y) for
{1−z−(1−c)x−chx} (6a)
i.e. for
c=(y−z)/[x(1−h)] (6b)

In other words, for the desired machine efficiency of (100%−y %), barriers to inhibit eddy currents would have to be supplied on at least the fraction c=(y−z)/[x(1−h)] of the rotor area that cumulatively generates 100% of the machine effect, i.e. torque in the case of motors and current in the case of generators

Since 0≦c≦100%, it follows that the machine efficiency, E_{Machine}=W_{Machine}/W_{Max} is at best
E_{Max}=100%−z−hx (7)

By way of numerical example, consider the machine in FIG. 3. Based on eq. (6a) and the discussed measurements of x≅30%=0.3, with c=0 since the machine includes no eddy current barriers and an estimated z=2%, the machine efficiency is expected to be
E_{Machine}=1−z−x=100%−2%−30%=68% (8a)

In fact, judging by the data of ref. 4, the machine does indeed have a similarly low if not lower efficiency. In this case, therefore, eddy current barriers should be distributed over the whole active rotor area, for c=100%, spaced so densely that h≦5%=0.05. If so, in accordance with eq.(6a) the motor efficiency would rise to
E_{Machine}=100%−z−chx≧100%−2%−0.05×30%=96.5% (8b)
and if h=0 should be approached by sufficiently narrow current channels (e.g., spacing the current channel insulation sufficiently closely), eq.7 yields the maximum possible efficiency of
E_{Max}=100%−z=98% (8c)

Through the persistent previous neglect of the eddy current effect, it is this inflated estimate of machine efficiency that has been used in the past,—presumably also for the machine in FIGS. 4 and 5.

As already introduced above, in addition to the discussed effect of current channel insulation layers suppressing eddy currents, current channels with their insulation can play another role that is peculiar to machines in which (unlike the machines of FIGS. 2 and 3) only a part of the geometric rotor area is in fact “active,” i.e. is traversed by current and penetrated by magnetic flux which is the necessary condition for electromagnetic induction. This will be appreciated by reference to FIG. 1 as follows: If operated as a machine, a current, i in the rotor, driven by the induced EMF, E, will supply electrical energy at the rate of
Wᵢₙ=i E (9)
causing the axle to provide a torque M at rotational velocity w for the rate of work output of
Wₒᵤₜ=Mω (10)

Assuming 100% machine efficiency, i.e. that Wᵢₙ=W_{Out}, the EMF in the rotor across the length of the current lines between the pole pieces would be
E=Mω/i (11)

For a modest Mω=11 watt work output, therefore, in a 110 Volt machine, drawing i=0.1 A of current, it would be E=11 watt/0.1 A=110V, even while the ohmic resistance of its copper rotor of, say, t=0.1 cm thickness, and of R_{R}=1.25 cm diameter mounted on an R_{A}=0.2 cm axle and resistivity of ρ_{Cu}=1.6×10⁻⁶ Ωcm would be only
R_{R}=(ρ/2πt_{R})ln(R_{R}/R_{A})≅5×10⁻⁶Ω (12a)
i.e. giving rise to an associated ohmic voltage drop of
V_{Ω}=i R_{R}=5×10⁻⁷ [V] (12a)

Hence the voltage required to overcome the ohmic resistance against the current in the rotor would be small compared to the back EMF, E.

In light of the above, it is seen that the voltage required to drive the current against the ohmic resistance of the coils of conventional motors, and similarly through the rotors of homopolar motors, is insignificant compared to the electromagnetic back-voltages by which the electric energy is converted into mechanical energy. It follows that a type I homopolar motor patterned after FIG. 1 will have a small efficiency at any reasonable rate of rotation because, independent of the position of the circumferential brush relative to the magnets, the current will preferentially bypass the magnetic gap area.

According to the present invention, the problem of current bypassing can be avoided by channeling the current between insulation to form current channels. The effect thereof is to interpose regions of high ohmic resistance on undesired current paths.

In some embodiments, it would be preferable that certain types of current channel insulation not cross a slip ring because it may cause increased brush wear rates or bouncing of brushes. However, unless the active rotor area of a type I machine completely encircles the slip ring of the axial brush, current channel insulation though the rotor circumference will be essential because the circumference of a rotor will provide a low-resistance path unless it is intersected by current channel insulation. Thus, some of the current channel insulation 18 shown in the example of FIG. 6A intersects the outside circumference 20 of the rotor 2. By contrast, none of the current channel insulation 18 crosses the circumferences 20(1) and 20(2) of the cylindrical edge of the type II cup-shaped rotor of FIG. 6C, and similarly none of it intersects either of the two circumferences at the ends of the type III cylindrical rotor of FIG. 6B where the respective slip rings are liable to be located. This is so because rotors of type II and type III homopolar machines are uniformly penetrated by magnetic flux and therefore do not provide bypassing paths for the current and, further, their slip rings are outside of the area of strong magnetic field. Some materials, such as fillers or insulation, that may be used with current channel insulation is discussed below.

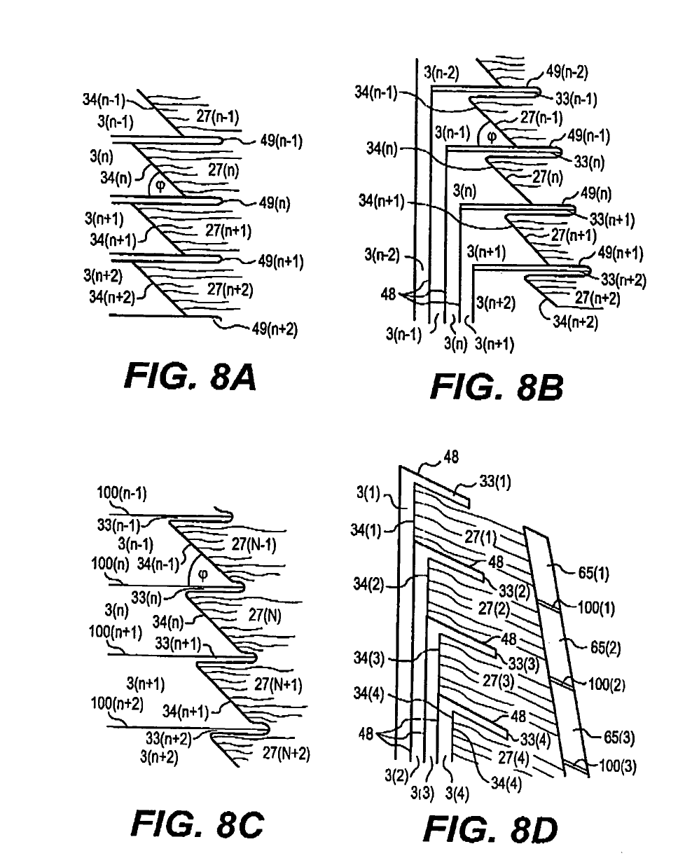

B. Bipolar Machines with Circular Rotors and Brush Plates (FIGS. 8 to 14)

(a) Basics of the Bipolar Design

In section 3e, bipolar machines have been introduced as having n=2, i.e. two current “turns” per rotor, thereby at the same time doubling the voltage at otherwise the same parameters and halving the number of required brushes. Two basic versions are proposed according to the present invention, namely machines with circular rotors and machines with cylindrical rotors of which a variant are machines with cup-shaped rotors. An important feature throughout the present invention of bipolar machines is the establishment, in any one rotor, of two areas of similar extent but opposite magnetic flux direction through which the current flows consecutively before passing to the next rotor.

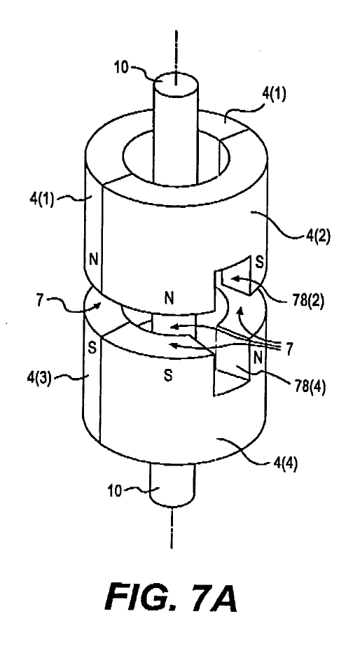

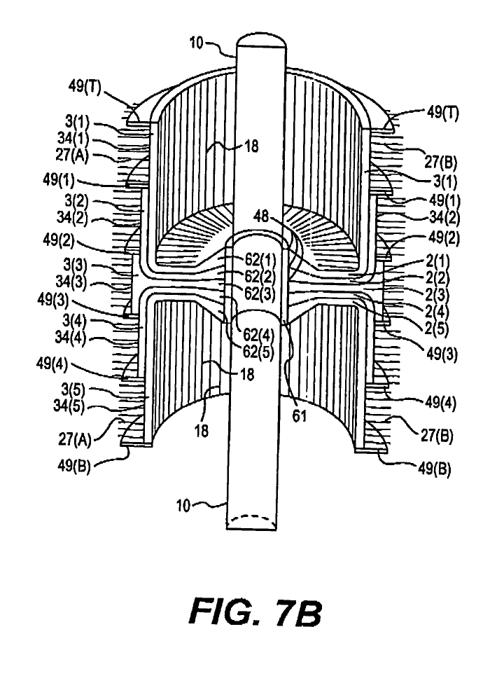

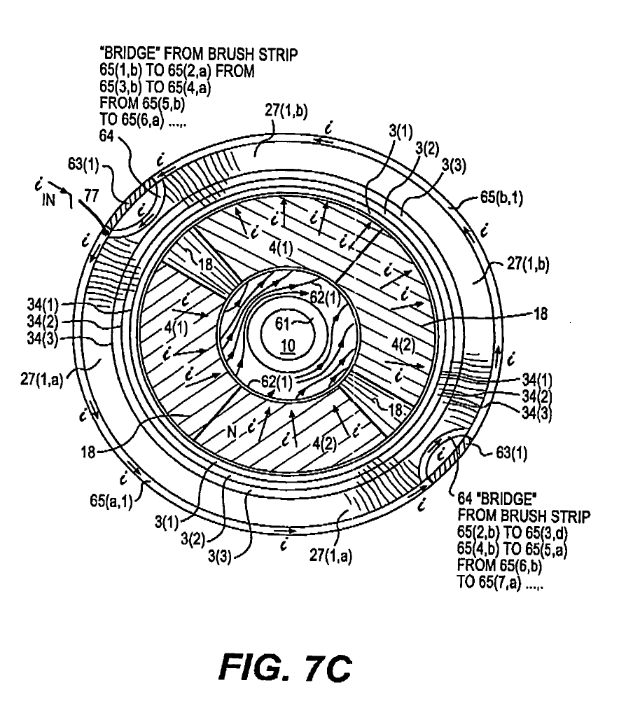

The principle is clarified in FIG. 7 for the case in which circular rotors are used. Herein, FIG. 7A shows a perspective view of a magnet shape and arrangement for a bipolar machine with circular rotors according to the present invention, in position relative to the axle 10. The arrangement comprises four geometrically similar horseshoe-type magnets, bent into cylinder arcs to form two pairs. One pair comprises magnets 4(1) and 4(2) that face their mirror image of a pair of magnets of opposite polarity, 4(3) and 4(4). Together the four magnets define an annular magnetic gap 7 of N/S polarity over somewhat less than one half of the gap area, and its mirror image of S/N polarity, over the symmetrical nearly half of the gap, in which the circular rotors rotate.

Note that the specific shape of the magnets is subject to many possible variations, e.g. (i) the pole pieces need not be flat but can be curved in radial section for intensifying the flux intensity in the gap, (ii) the radial magnet thickness need not be uniform but may be variously shaped to optimize the flux in the gap and/or to optimize the length of the machine, (iii) the magnets need not be cylindrical but could be conical, e.g. so as to permit the rotor rims to lean inward towards the axle and thereby to reduce the brush sliding speed or conversely lean outwards to increase slip ring area, (iv) the ends of the magnets away from the gap may not form flat rings but be shaped three-dimensionally to save weight, optimize flux density, improve shock resistance of the magnets and/or reduce cost, (v) the magnets may be shaped including any combination of the above for any combination of the above reasons, plus any other modifications, e.g. fluting if there should be good reason for doing so

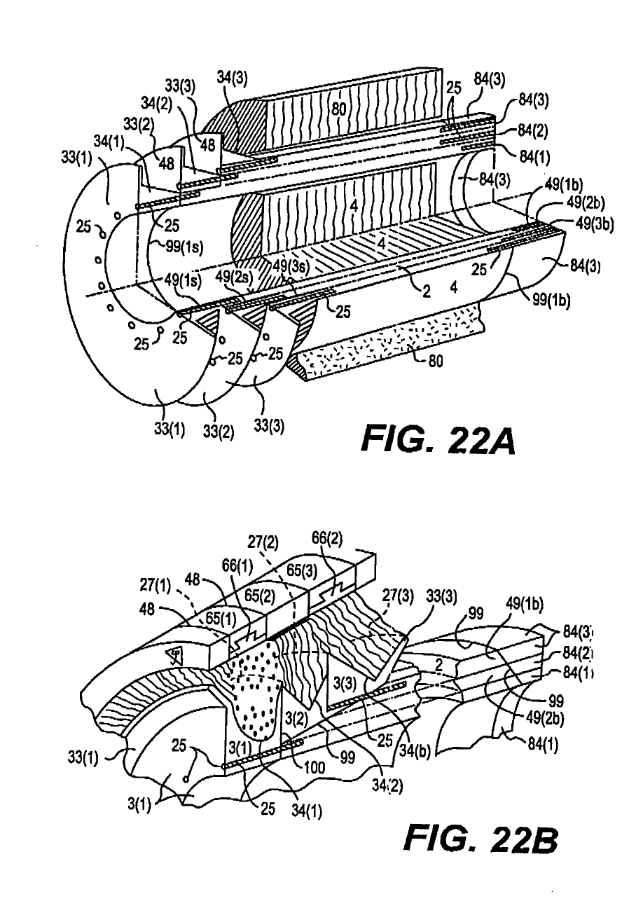

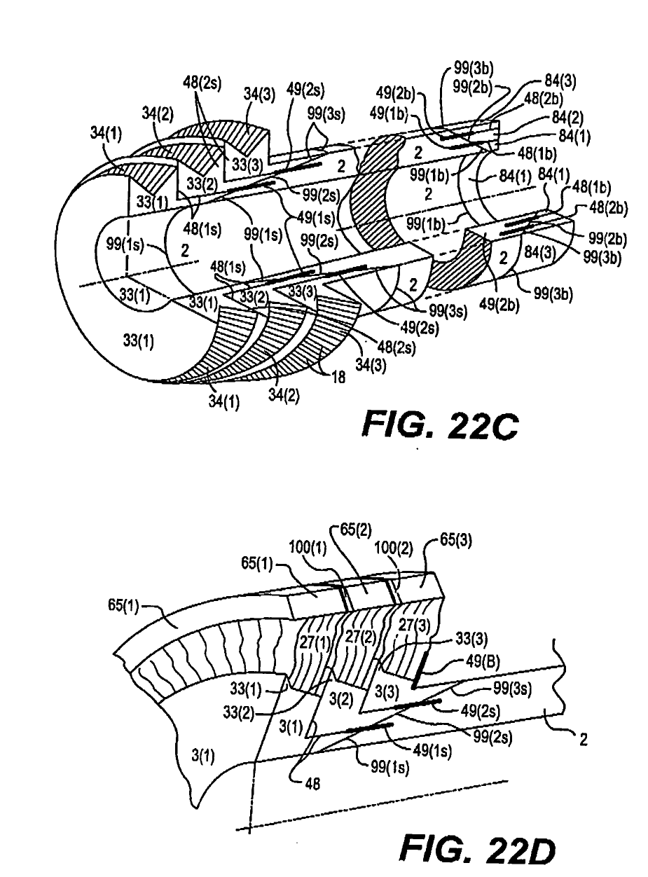

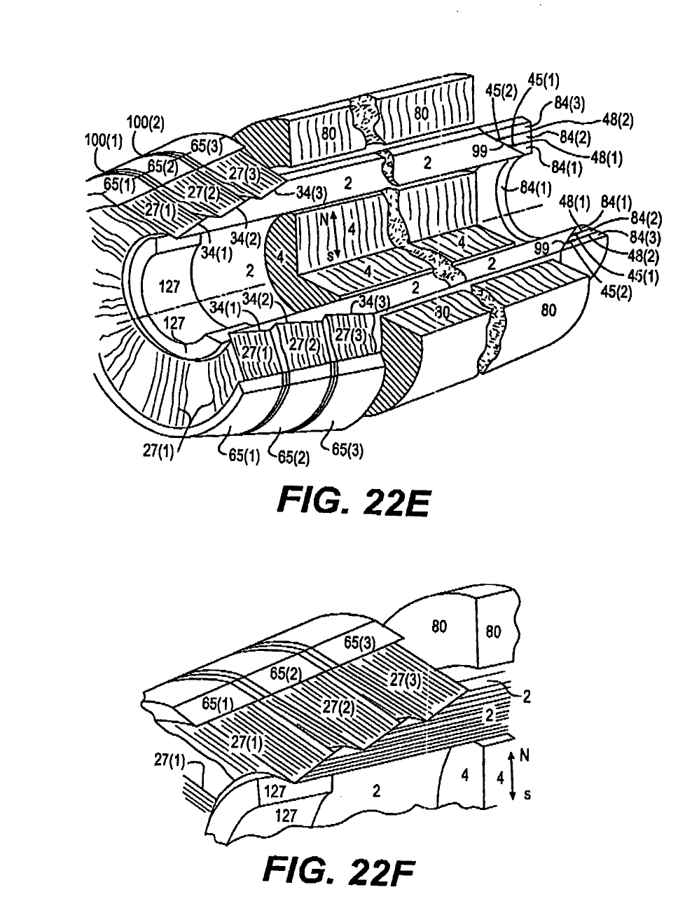

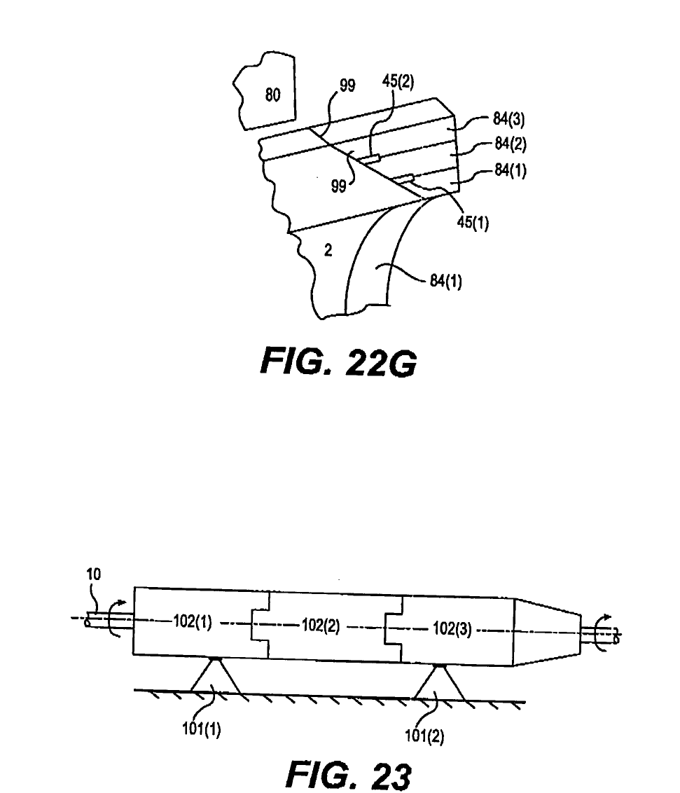

As shown in FIG. 7B, an embodiment of the machine further includes a stack of circular rotors (2) that are capable of rotating in the magnetic gap 7 and are mutually electrically insulated, preferably via “dielectric breakdown bonding” layers 100 that are not shown in FIG. 7B and serve as a protection against brush failure, to be more fully discussed later and in connection with FIG. 22. The rotors are provided with angled rims (3), meaning extensions that project beyond the magnetic gap and out of the plane of the circular rotors. Most typically but not necessarily the rims are oriented parallel to the rotation axis in the manner of FIG. 7B. The purpose of the extended, angled rims is to provide slip rings 34 for the brushes 27 that conduct the current from one rotor to the next as well as into and out of the machine and may be mounted in individual brush holders or in brush strips that may be assembled into brush plates. Through extending the dimension of the angled rims in axial direction, the total available slip ring area, that tends to be a limiting factor in homopolar motors designs especially of type I, can be almost arbitrarily increased.

The particular example of FIG. 7B shows a lengthwise section of the rotor set in the machine, parallel to the axle 10. The rotor set comprises five rotors 2(1) to 2(5). FIG. 7B further shows an example of means 61 for mechanically fastening the rotor set to axle 10.

In greater detail, FIG. 7B shows a set of brushes 27(a) that run on slip rings 34(1) to 34(5) on rims 3(1) to 3(5) on the N/S-side (dubbed the (a)-side) of the magnetic gap 7, and the mirror-image set of brushes 27(b) that similarly slide on slip rings 34(1) to 34(5) on rims 3(1) to 3(5) (not all numbered in FIG. 7B) on the S/N-side (dubbed the b-side) of the magnetic gap 7. For clarity, FIG. 7B does not show the brush holders. These could be individual brush holders or could be extending from “brush plates” in the form of brush strips rather than individual brushes as further discussed in section B(c).

Rotors 2(1) to 2(5) and their rims 3(1) to 3(5) including their slip rings 34(5) are mutually electrically insulated by insulating layers 48 (not shown in FIG. 7) and are supplied with radially oriented current channeling means, in any form of current channel insulation layers 18 shown. Collectively, though not necessarily individually, the current channel insulation layers 18 extends from the inner edge of the annular magnetic gap area through the magnetic gap area 7, through the rims 3(1) to 3(5) and through the sip rings 34(1) to 34(5), so as to inhibit circumferential current flow between magnetic areas (a) and (b) and thereby electrically to insulate brushes 27(n,a) from brushes 27(n,b). However, the rotor area 62 about the axle 10 up to the magnetic gap, is free of current channel insulation layers. Moreover, in order to lower internal machine resistance and thus Joule losses, in area 62 the thickness of the rotors is optionally increased as indicated in FIG. 7B by numerals 62(1) to 62(5), and in the general case by numerals 62(n) for any arbitrary number of rotors.

The inside edges of rotor parts 62(1) to 62(5), and in general 62(n), are fastened to axle 10 via part 61 that is electrically insulated from rotor parts 62(n). For example, part 61 could have cylinder shape as in FIG. 7B, could be made of metal or an insulator, and by means of some suitable adhesive could be glued to both axle 10 and rotor parts 62(n). Anyway, as already stressed and is the rule for all rotor sets in all homopolar machines, the different rotors in the set, including their rims and their parts in the area 62 about the axle, must be electrically insulated from each other by layers 48. This could be very easily accomplished by spraying with a stop-off lacquer before assembling the set of rotors while the lacquer is still wet or at the least “tacky”. Thereby eddy cuts will be glued shut if these should be the current channeling insulation material employed, which would aid mechanical strength.

The objective of the outlined construction is to force current i to flow consecutively from rotor 2(1) to 2(N), and in each of the rotors across both the (a) and (b) parts of the magnetic gap as indicated in FIG. 7C which is a plan view of the described bipolar machine according to the present invention. In a motor, current i will thereby be subjected to the corresponding increments of magnetic force on each pass through the annular magnetic flux area, and in a generator it will generate additive increments of induced voltage, always in the same direction, thereby causing n of eq.4 to equal n=2.

To clarify the current flow in greater detail, consider the machine in FIG. 7 to be a motor, wherein the voltage is applied between brush holder strip 65(1,a) at the top of the stack on the (a)-side), and brush holder strip 65(N,b) at the bottom of the stack on the b-side. In this arrangement, current i enters brush holder strip 65(1,a) via switch 77. From there, driven by the applied voltage increment between rotor brush holder strip 65(1,a) and 65(1,b) and constrained by current channel insulation layers 18, the current flows in axial direction through rim 3(1) towards the (a), i.e. N/S polarity, part of the gap between magnet pair 4(1)/4(2) above and pair 4(3)/4(4) at the bottom of the stack. Still constrained by current channel insulation layers the current next flows radially inwards through the axial N/S magnetic field and in the process is acted upon by the corresponding counterclockwise force. Leaving the gap area into area 62(1), and there unconstrained by current channel insulation but still driven by the voltage between brush holder strips 65(1,a) and 65((1,b), current i circuits about axle 10 into the (b), i.e. S/N polarity, part of the gap. Now again constrained by current channel insulation layers, the current flows outward in radial direction and is again subject to a counterclockwise Lorentz force in the (b) part of the gap. From there, still constrained by current channel insulation layers 18 and driven by the applied voltage, the current flows in axial direction through rim 3(1,b) and leaves rotor 2(1) through brush strip 27(1,b) into brush holder strip 65(1,b). With this the rotor has been traversed and has yielded twice the induced voltage due to a single passage of the current through the magnetic flux. The next current turn begins as the current continues to follow the applied potential gradient through “bridge” 64(1) into brush holder strip 65(2,a) on through fiber brush strip 27(2,a) to repeat the same course through rotor 2(2) etc. until it finally exits at brush holder strip 65(N,b) after N current turns.

(b) Slip Rings

In all cases, neighboring slip rings as well as brushes and brush holding devices must be electrically insulated. This may be done by means of insulating joints 48, e.g. composed of “stop-off lacquer”. In order in particular to prevent electrical contact between brushes on neighboring slip rings, stiff, thin insulating layers 49, also called “separators”, may be provided between parallel brush tracks as shown in FIGS. 7B and 8A and similarly insulating end layers 49(T) and 49(B) at top and bottom of the series of parallel slip rings may be used to prevent brushes from sliding off the slip rings, as shown in FIG. 7B.

Rims 3(1) to 3(5), and in the general case 3(n), need not be of uniform thickness but may optionally be less than or exceed the thickness of the rotors in the magnetic gap area, e.g. so as to reduce ohmic electrical resistance. Moreover the thickness of the rims need not be the same for all rims nor be uniform over the whole extent of any one rim. One application here is “scarfing”, i.e. inclining the brush-rotor interface against the brush fiber direction in a plane normal to the sliding direction, which facilitates reversal of sliding direction attendant on reversal of sense of machine rotation.

Simple scarfing is illustrated in FIG. 8A, wherein slip rings are conical with opening angle φ, in either direction relative to the rotation axis. As a result, radially oriented metal fiber brushes or brush strips 27(n) as in FIG. 7B slide on slip rings 34(n) with their axes inclined by angle (p against the slip ring normal in a plane parallel to the rotation axis. In general, compared to cylindrical slip rings, the angle of inclination of arbitrarily oriented brushes against the same slip ring surface will be decreased by the angle φ if the brush axis, i.e. the brush fiber direction, is slanted in the same sense and increased by the angle φ in case of opposite slant.

The ease and safety with which the brush sliding direction, and hence the machine rotation direction, can be reversed may increase with the angle φ of inclination of the brush fibers against the slip ring normal. However, increasing the angle φ at the same time causes the brushes to be driven increasingly forcefully towards the slip ring side with the smaller radius. The possible resulting contact with, and friction between, the brush fibers and separators 49 may cause wear damage to the separators 49 and eventually wear them out. In order to prevent this, it may be advantageous to clad at least one side of separators 49(n) with slip ring extensions (33). This variation in accordance with the present invention is indicated in FIG. 8B by means of a set of rims 3(n) mutually electrically insulated by means of insulating joints 48, comparable to those at the right of FIG. 7B, with slip ring extensions 33(n) mechanically joined to slip ring separators 49(n). Slip ring extensions are intended to inhibit separator wear and to incidentally also mildly increase the available slip ring area when brushes are contacting the separators.

Further, advantageously separators 49(n) may be eliminated by means of slip ring extensions from both sides as indicated in FIG. 8C. From the view point of manufacturing that means that suitably shaped rims (3) with, typically differently shaped, slip ring extensions (33) on both sides, may be simply joined together by means of insulating joints 48 that provide electrical insulation between rotors, and bonds them mechanically. It is anticipated that this may at the same time enhance long-term reliability in preventing electrical contact between brushes on adjoining slip rings, and on account of eliminating separators (49) may reduce manufacturing cost.

Another form of scarfing, angling the brushes instead of the slip rings, is obtained by providing rims with angled slip ring extensions 33 as in FIG. 8D. Shown in this figure is a set of mutually electrically insulated rims, 3(1) to 3(4), comparable to those at the right of FIG. 7B, provided with angled extensions 33(1) to 33(4) each of which is covered with insulating material 48 on one side. Fiber brush strips 27(1) to 27(4) extending from brush plate strips 65(1) to 65(4) slide on slip rings 34(1) to 34(4) that are formed by the exposed parts of rims 3(1) to 3(4) between neighboring slip ring extensions 33(1) to 33(4), e.g. slip ring 34(3) on the surface of rim 3(3) between extensions 33(3) and 33(4) on which slides fibrous part 27(3) extending from brush strip 65(3). It may be noted that electrical contact between brush 27(n) with the bare side of the adjacent angled extension 33(n) will be harmless or even beneficial, while the applied brush force drives brush 27(n) away from the insulation 48 on extension 33(n+1) thereby reducing or eliminating wear on the side of 33(n+1). However, wearing through layer 48 would give rise to highly detrimental short-circuiting between neighboring slip rings and ought to be avoided. Correspondingly, according to the present invention, any combination between the two-sided cladding of the joints between neighboring slip rings as in FIG. 8C and the angling of slip ring extensions, brushes, brush strips and/or brush plates as in FIG. 8D, may be advantageous depending on the circumstances.

(c) Brush Plates and Brush Strips—Basic Construction

According to a feature of the present invention and as depicted in FIG. 8D, fiber brushes or brush strips (27) are favorably positioned on brush holder strips (65) already introduced, and the brush holder strips are favorably integrated in the form of rigid “brush plates” (68). Thus brush plates are composed of parallel brush holder strips (65) that can carry brushes (27) in the form of multi-contact metal strips that are electrically insulated from each other via insulating layers (48) or (100) including dielectric breakdown bonding that will be further discussed below.

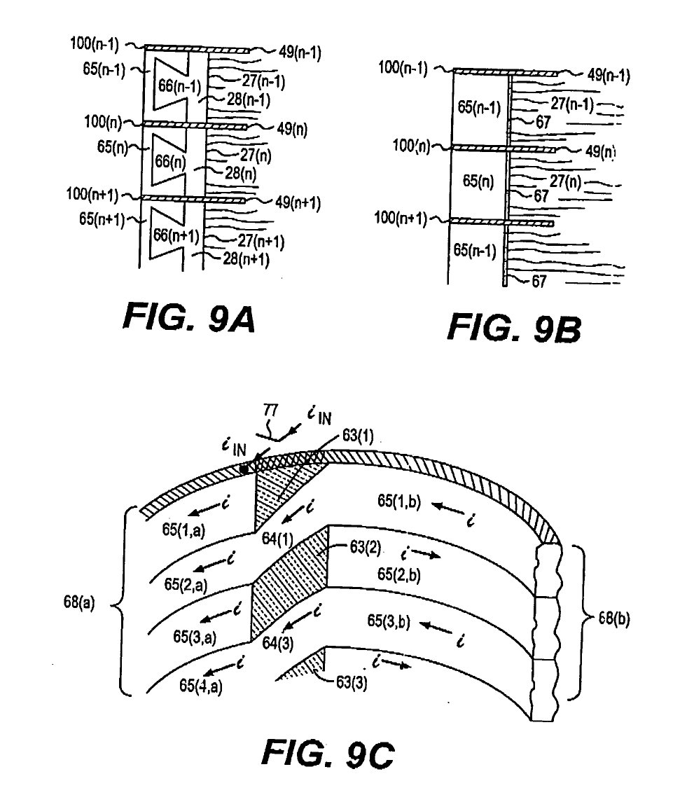

Brush plates (68) can substitute for large numbers of individual brush holders, and can achieve smaller slip ring widths than would be possible with individual brushes and brush holders. Brush plates according to the present invention are further discussed in connection with FIGS. 9 to 13.

According to FIG. 7D, for example, brush strips 27(1,a) and 27(1,b) and their respective brush holder strips 65(1,a) and 65(1,b), collectively extend over not quite half the circumference of rotor rim 3(1) on the a- and b-side, respectively, and similarly brush strips 27(n,a) and 27(n,b) projecting from brush holder strips 65(n,a) and 65(n,b) extend over most of rotor rim 3(n) on it's a- and b-side, respectively. As explained, the electrical potentials of 27(n,a) and 27(n,b) differ on account of the current passing twice through the magnetic flux between the (a) and the (b) side of rotor 3(n). Therefore brush holder strips 65(n,a) and 65(n,b) which in axial direction are rigidly connected to their neighbors 65(n−1, a) and 65(n+1,a) via insulating layers 48 as in FIG. 8D or, as seen plan view (from the inside without the fiber parts) in FIG. 9A, must be electrically separated from each other. This is the function of the two oppositely located insulating sections 63(1) for rotor rim 3(1) and in general 63(n) for rotor rim 3(n) that are aligned with the dividing line between the (a) and (b) side of the machine, where the B-field has no normal component with respect to the plane of the rotors. Thus insulators 63 are located at the positions of the gaps between the opposing poles of the individual magnets, i.e. gaps 78(1)/78(3) (not seen in FIG. 7A) between the N and S poles of magnets 4(1) and 4(3) and gaps 74(2)/78(4) between the S and N poles of magnets 4(2) and 4(4) on the opposite side of the machine.

Rigid brush holder strips 65 perform the normal dual function of any brush holders, namely of conducting current to and from the fiber brush strips 27 while they press these against slip rings 34 with more or less constant brush pressure. Fiber brush strips 27 may be affixed to their respective holder strips 65 by a variety of means known in the art, e.g. mechanically by means of dove tailing 66 as indicated in FIG. 9A, or fastened by means of gluing with a conductive adhesive 67, e.g. epoxy filled with metal powder, as shown in FIG. 9B, or they may be fastened through soldering, or any other method that yields a firm electrically conductive bond. Dielectric bonding (100) may be used to protect machines against brush failure (see below).

If operated in a protective atmosphere or in the open air, gaps should preferably be left between segments of brush strips in the sliding direction to permit adequate supply of moisture. In general, in a gaseous humid atmosphere not much more than the previously introduced fraction f_{Bmax}=50% of the slip ring area may preferably be covered by brush foot print, and according to present best knowledge, the individual length of continuous foot print should preferably not exceed L_{BSmax}=5 cm. Note that these quoted values are very rough estimates since they greatly depend on conditions and the particular embodiment, with more gap widths and shorter continuous foot print lengths needed for high than for low speeds, for high than for low humidity, and for high than for low fiber packing fraction (compare ref.12).

While two insulating gaps 63(n) are needed per rotor, to electrically isolate brush holder strips 65(n,a) and 65(n,b), as explained, there must be no more than a single current connection (dubbed a “bridge”) 64(n) to conduct the current from brush holder strip 65(n) to 65(n+1) since otherwise the current would simply take the shortest route between 65(n,a) and 65(n+1,b) without traversing magnetic gap 7. Moreover, advantageously, not only the insulating gaps (63(n) but also the bridges 64(n), e.g. as shown in FIG. 9A, should be located at the positions of the gaps between the poles of the four magnets. As a result, much like in an irrigation channel the water flow is at maximum at its inflow point and is successively depleted by the water flowing into successive furrows, so the circumferential current density in any one brush holder strip is depleted by the current flowing out into the rotors through the fiber brush strips, until the current vanishes at the insulating gaps 63. The resulting non-uniform evolution of Joule heat in the brush holder strips may, in accordance with the present invention, be smoothed out by alternating the positions of the bridges 64 between the two discussed opposite circumferential positions, as indicated in FIG. 7C.

Short-circuiting between adjoining current turns via unintended contact between brushes on neighboring slip rings is inhibited by means of insulating separators/barriers 49(1) to 49(4) between adjoining brush tracks in FIG. 7B, and in general labeled 49(n), or extensions from slip rings 33(n) as already discussed in conjunction with FIG. 8. Optionally, similar separators of both types, at both ends of the slip ring zone, in FIG. 7B indicated as 49(T) and 49(B) (for T=top and B=bottom) may be employed to constrain outermost fibers, if any, from splaying out too much.

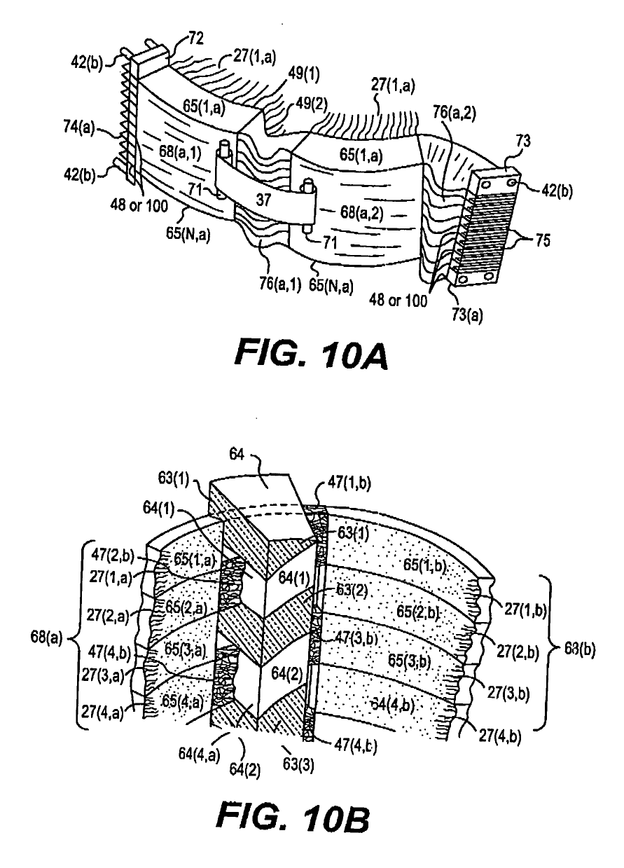

Even though bridges 64 in FIGS. 7C and 9C are drawn as flat strips, those skilled in the art will recognize that configuration as just one example of their possible morphology. These may take the form of “joints” 76 interposed between the rigid holder strips that may be made of flexible cabling or of foils as indicated in FIG. 10A The tangential component of the brush force among neighboring sections may be maintained by springs, e.g. constant force spring 37 in FIG. 10A, or similar structures known to those in the field. In fact, due to the radial inward movement of the stiff brush holder strips on account of brush wear, the construction of the flexible joints and bridges between sections of the brush plates is a challenge that is identified and overcome in the present invention as clarified by means of FIGS. 10 to 12. Hence the depiction of the insulating gaps 63 and the bridges 64 in FIGS. 7C and 9C are only schematic to show the current flow directions and general geometry involved, but do not reflect the potential variations or actual (and rather more complicated) morphology.

(d) Construction, Operation and Manufacture of Brush Plates

Those skilled in the art may consider brush plates, including rigid brush strips 65 and fibrous brush strips 27 extending therefrom, as consumable (i.e., akin to graphitic brushes in motors and generators.) Instead of repairing a worn out or defective brush plate, it maybe removed and replaced by a fresh plate. One consideration is how to maintain a steady brush force and more or less uniform rate of brush wear. Specifically, as rigid brush holder strips 65(n) move toward the axle 10 in the course of brush wear, both bridges 64(n) as well as insulating sections 63(n) of FIGS. 7C and 9C must either deform without offering much mechanical resistance if they are somehow fused to the brush holder strips, or if insulators 63(n) and/or bridges 64(n) are stiff and fixed in position as in FIG. 9C, the brush holder strips must be able to slide relative to them.

This poses no difficulty in regard to insulating sections 63(n) since these could be made of polymer foam or even be empty spaces. In the latter case, the cross sectional areas of brush holder strips facing each other across the empty gap may, to prevent possible short-circuiting through wear debris or other, be covered with an insulating lacquer or paint.

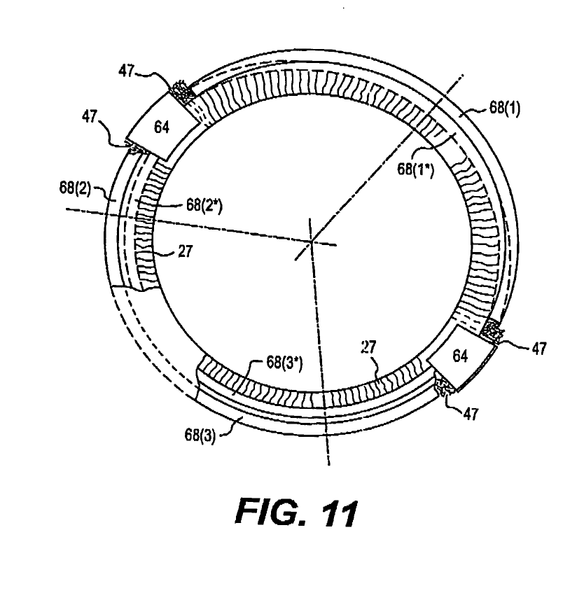

The challenge is not so easily solved in regard to bridges, as seen by considering the movements of brush plates 68 of different circumferential extent relative to stiff, stationary bridges 64 and/or insulators 63 that accompany the same brush wear lengths, as sketched in FIG. 11. Specifically, FIG. 11 considers brush plate displacement on account of the same brush wear length at the center of the plate, i.e. displacement of the center of brush plate 68 towards the axis by the same distance, as a function of the angular extent of the plate. As seen, brush plate 68(1), spanning an arc of θ≅180°, moves into position 68(1*), while brush plates 68(2) and 68(3) with θ≅90° and θ≅60°, respectively, move into positions 68(2*) and 68(3*). As the outer edges of the brush plates displace at angles θ/2 relative to the adjoining stationary bridges 64, the relative wear lengths of brushes in the middle and at the edges of the same brush plate, i.e. δL_{B, center}/δL_{B,edge}, is 1/cosθ/2. Thus the edges of plate 68(1) move almost directly towards bridges 64 with strong brush wear at the center of the plate and virtually none at its edges. Evidently, with this morphology, the brush force is similarly skewed to be very low near the edges and to be at maximum about the center of the plate. It follows that a total of two≅180° brush plates about the circumference of a machine would lead to uneven brush pressure and unsatisfactory brush wear, regardless of how the gap for bridges 64 would be achieved.

The parallel displacement of the plate edges, compared to the normal displacement component of the plate edges relative to bridges 64, is ≅cos(θ/2)/sin(θ/2). Numerically, the displacement ratio parallel and normal to a stationary bridge or insulator would be ≅cos90°/sin90°=0:1 by the use of two ≅180° brush plates about the machine circumference, would be ≅1:1 for a total of four ≅90° brush plates like 68(2), would be ≅cos30°/sin30°=1:0.58 for six ≅60° brush plates like 68(3), and would reduce to ≅cos22.5°/sin22.5°=1:0.414. by the use of eight similar ≅360°/8=45° brush plates about the machine circumference. Meanwhile the relative brush wear rates between the middle and edges of the brush plates would be ≅1/cos90° [symbol] ∞ by the use of just two 180° brush plates, one each on the (a) and (b) side, whereas with 4, 6 and 8 brush plates per circumference the relative brush wear rates, and by implication correlated brush pressures, would be ≅1/cos45°=1.41, ≅1/cos30°=1.15, and ≅1/cos22.5°=1.08.

It follows that, based on non-uniformity of brush wear alone, one ≅180° plate per side will be unacceptable, two plates per side, i.e. ≅90° brush plates, will barely do, three ≅60° brush plates per side will fulfill practical requirements, and still narrower brush plates would be ample. Correspondingly, for a circular rotor one or more flexible brush plate “joints” per side, in addition to the required current bridges, is preferable.

Having settled this question, the practical challenge of how to accommodate the needed parallel and normal displacements is much more severe for stationary bridges, as in FIG. 10B, than for flexible bridges that move with the plates, as in FIG. 10A. The best solution for stationary, stiff bridges is probably via resilient multi-contact metal material 47 indicated in FIGS. 10B and 11. However, at, say, 2 cm total average brush wear the resilient multi-contact material would have to accommodate a change of gap width of more than 1 cm even with 60° brush plates. This would be quite difficult to achieve and would possibly lead to arcing as the contacts between plate edge and rigid, stationary bridge loosens with brush wear.

Although in line with the above considerations stationary rigid joints and bridges are possible, it is more likely that one will utilize flexible bridges and flexible joints in accordance with FIG. 10A. Flexible joints and bridges that move with the plates accommodate a reduction of circumference from some value, 2πR before brush wear, to 2π(R−δL_{B}) after δL_{B} brush length wear (i.e. a reduction of 2πδL_{B} of circumferential length through a δL_{B} average brush shortening.) This 2πδL_{B} length reduction will be distributed over 4 or 6 gaps, depending on whether 90° or 60° brush plates are used. For example, δL_{B}=2 cm will require an average shortening of 3.1 cm or 2.1 cm per joint or flexible bridge in the cases of 90° and 60° plates, respectively. This gap shortening may be accomplished by means of joints and bridges constructed from stacks of parallel foils, a solution that is adapted from ref.[13]. The mechanical stiffness of a foil (and similarly a fiber) may be modeled by a cantilever. For a foil diameter d_{F} the cantilever deflection under force F_{F} is proportional to 1/d_{F}⁴, whereas its electrical resistance is proportional to 1/d_{F}². Specifically, the spring force, F_{F}, of a uniform cantilever of width w, length L and thickness d_{F}, hence cross sectional area A_{F}, made of a material with Young's modulus E, at the elastic deflection At of its free end is:
F_{F}=(E d_{F}³ w/4L³)Δl=(E A_{F}d_{F}²/4L³)Δl (13)

Hence, disregarding friction among the foils, for N_{F} parallel foils of total material cross-sectional area A_{S}=N_{F} A_{F}, the spring force is:
F_{S}=N_{F}F_{F}≅(EA_{S}d_{F}²/4L³)Δl (14)
i.e. F_{S} drops sharply with decreasing foil thickness, while the electrical resistance of the foil stack from end to end is
R_{S}=ρL/A_{S} (15)
independent of foil thickness. Thus, replacing a certain segment of brush holder strip by double its length of separate thin foils that together occupy only one half the strip thickness in order to essentially eliminate friction among the foils, is electrically equivalent to tripling the length of the replaced segment. This effect will be relatively insignificant provided that the average bridge or joint length amounts to no more than ten percent of the machine circumference. Moreover the insertion of such flexible joints between rigid brush plates, as indicated by numeral 76 in FIG. 10A, would not too seriously interfere with brush placement because it provides for some of the needed gaps among brush strip segments for moisture access in gaseous atmospheres.

As to the mechanical forces due to the bridges, consider a, L=3 cm=3×10⁻² m long copper bridge in a square 1 cm by 1 cm holder strip for A_{S}=5×10⁻⁵ m² that deflects by Δl=1 cm=10⁻² m in order to accommodate 1.5 cm of brush wear. With E=1.2×10¹¹ N/m² for copper, the associated force would be, according to eq.14,
F_{S}≅1.2×10¹¹×5×10⁻⁵×d_{F}²×10⁻²/[4×(3×10⁻²)³][N]=5.56×10⁸d_{F}² (16)
i.e. for d_{F}=10 μm, an entirely negligible force of F_{S}=0.056N. More economically, foils of, say, d_{F}=25 μm thickness could be used and yield a still very low F_{S}=0.35N. Those skilled in the art will recognize that this is but one numerical example to illustrate the wide possibilities offered, in regard to mechanical behavior, by flexible joints and bridges inter-linking brush plates.

According to the present invention, insertion of insulators, making and attaching of bridges is accomplished by means of male (72) and female (73) connector plates illustrated in FIG. 10A. Herein the groups of foils that connect the parts of brush holder strips 65(1,a) to 65(N,a) could be directly fed through the male connector plate (72) to extend out of it from the other side in the form of being fused into one rigid metal strip 74(a) per foil group. Alternatively, the foils in any one group may be electrically connected, within the male brush plate, to their one correlated strip. Either way the strips must be mutually electrically insulated, as may be accomplished by making the bulk of the connector plate of an electrically insulating material, or by incorporating intervening insulating layers 48.

The construction of female connector plate 73 is similar except that the groups of foils are electrically connected to conductive slots 75 that are shaped to receive protruding metal strips 74(b) of male connector plate 72(b) of brush plates 68(b,1) and 68(b,2) to which they are to be connected. For creating a bridge, male and female connector plates from opposite sides (e.g. from the (a) and (b) side) are snapped or pushed together so that brush holder strip 65(n,b) is connected to strip 65(n+1,a).

Indicated plugs 42(b) and receptacles 42(b) are designed to insure the proper alignment between strips and slots. These perform the same function as the screw connectors integrated into the receptacles of printer cables that secure the proper alignment of the male and female parts. In fact, plugs and holes 42(b) of FIG. 10A might favorably be replaced by just such screw fasteners.

In FIG. 10A, labels 42(b) of the centering device, while the plates, strips and brushes are labeled 68(a) 65(a) and 27(a), respectively, indicate that the part shown in FIG.10A is meant to belong to the (a) side that in a machine will be connected to its corresponding part of the (b) side. Therefore plates 72(a) and 73(a), together with their counterparts 72(b) and 73(b) that are not shown, must have the previously discussed feature of linking strip 1 to strip 2, strip 3 to strip 4, strip 5 to strip 6, etc. on the left side of the drawing, say, and strip 2 to strip 3, strip 4 to strip 5, strip 6 to strip 7, etc. on the right side, in accordance with FIG. 7C. The plates may be labeled to facilitate their replacement.

Lastly, brush plates in motors must be connected to the terminals of power supplies, and similarly brush plates in generators must be connected to the terminals of the current user. For large machines this means that brush plates must be electrically connected to the corresponding rigid cables or buses, while at the same time they must be able to move easily in the course of brush wear. A preferable approach is to make said electrical connections between brush plates and terminals via substantially parallel contact plates that are rigidly fastened to the terminals and the brush plates, respectively, of which one is lined with a resilient multi-contact metal material under light pressure.

(e) Basic Overall Construction of Bipolar Machines with Circular Rotors

Having available brush plates in lieu of individual brushes in individual holders, and having means of suitably connecting them together electrically and mechanically by means of joints and bridges according to the present invention as discussed above, still leaves open the question of how to keep them in position within machines and how to apply the brush force. Several possibilities for positioning and advancing the plates towards the axle in the course of brush wear exist, e.g. guiding the plates between rails, or in slots, or by a kind of dove tailing. These means may be variously used, depending on conditions and cost. For precision and high performance the favored choice, however, is linear bearings. Fastened to the linear bearings are plates, which are rigidly fastened by means of adequately long and sturdy brackets to withstand possible shocks.

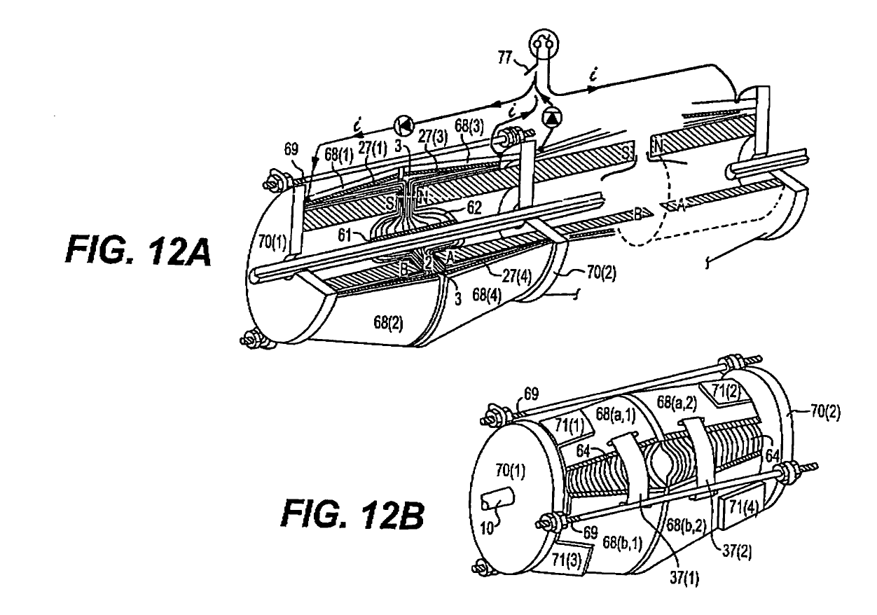

FIG. 12, which presents a perspective view with partial cut-out of two similar bipolar motors in tandem (FIG. 12A), and a perspective view of just one of them (FIG. 12B), indicates this feature by means of the linear bearing brackets 71(1) to 71(4) that are visible and their implied mirror image on the opposite side of the machine that are out of view. The linear bearings are to be fastened to the motor end plates 70(1) and 70(2) such that the brush plates can slide towards the center of the axle in the plane of the end plates 70(1) and 70(2). The geometry depicted in FIG. 12 comprises four 90° brush plates about the circumference of rotors 2(1) to 2(N/2)) of the first machine, of which 68(a, 1) and 68(b,1) are visible, and a symmetrical group of four 90° brush plates about the circumference of rotors 2(N/2+1) to 2(N) of which 68(a2) and 68(b,2) are visible, whereas an actual machine might well comprise six or even eight brush plates on each side. The mild inclination of the brush plates relative to the rotation axis takes account of (i) the overlapping rotor rims as indicated in FIGS. 7B and 8D, with cumulative rim thickness largest at the center (the plane of rotor 2(N/2) and feathering out to zero at the edges of rims 3(1) and 3(N) of rotors 2(1) and 2(N) at the extreme ends near the motor end plates 70(1) and 70(2). (ii) Potentially different initial brush lengths in order to take account of the higher sliding speed and thus higher brush wear rates at the center. (iii) Possibly different brush wear rates on the (a)- and (b)-sides. [0213] Thus, unlike the previous example of FIGS. 7C, 9C and 10, but in line with FIG. 8D, the brush plates are not cylindrical but conical. The reasons for potentially different brush wear rates on the (a)- and (b)-side is that they exhibit positive (brushes 27(n,a)) and negative (brushes 27(n,b)) electric potentials relative to the rotors. As a result, (a) and (b) brushes can exhibit moderately different brush resistances and wear rates at otherwise the same conditions. Even though the majority of bipolar or other homopolar motors will be required to occasionally reverse direction and thereby invert brush polarity, e.g. as in ship or car drives, most operation takes place in the same direction and correspondingly, if they are made of identical construction, brush plates 68(a,n) may tend to wear out faster, and in that case would have to be replaced more often than 68(b,n) brush plates, unless they accommodate initially longer brushes. [0214] The outlined geometry would not require the significant pair-wise separation of brush plates along the machine mid-plane as drawn in FIG. 12B since brush wear would be strictly in radial direction and would be accommodated by the joints and bridges described in connection with FIG. 1A. However, some pair-wise separation of brush plates will avoid the potential for strong axial stresses through temperature changes or shock loads when plates are firmly anchored between motor end plates 70(1) and 70(2) via their respective mounting brackets 71 (n) and linear bearings. Note, however, that the gap between plates 68(a, 1) and 68(a,2) and similarly 68(b,1) and 68(b,2), is exaggerated in FIG. 12 since it basically serves the function of expansion joints in bridges and large buildings and its width would be on the order of a percent or less of the overall motor length.

As in both FIG. 10A and FIG. 12, the brushes on the brush plates are loaded against the slip rings on the rotor rims by means of constant force springs 37(1) and 37(2) across joints 76 and/or bridges 64. Preferably, such “constant force” springs should be applied across every flexible junction between adjoining brush plates in order to achieve as uniform brush pressure about the circumference as possible. Also in long machines, more than one constant force spring may be advisable along the axial length of any one flexible part. Those skilled in the art will see that other types of brush loading are evidently possible, such as spiral springs or spring clips.

The desire to reduce brush wear and/or the need to permit reversal of machine rotation direction already discussed in conjunction with FIG. 8, will presumably not only be facilitated by scarfing of slip rings but also by slanting of brush fibers, as for example already indicated in FIG. 8D. The possible morphologies are (i) rotation of the average fiber direction about the axis in the plane of the interface, normal to sliding direction, as indicated in FIGS. 1 3A and 1 3B which give a perspective and plan view, respectively. When run on a slip ring parallel to the brush plate this causes sliding in leading or trailing direction. (ii) Rotating the fiber direction about the sliding direction as shown in FIG. 1 3C which results in scarfing orientation against a slip ring parallel to the brush plate. (iii) A combination of the two. Those skilled in the art will may apply the approach suitable for the particular circumstances.

(d) Manufacture, Replacement and Reliability of Brush Plates

The proposed flexible joints composed of thin foils between rigid brush plates and associated bridges (e.g. FIG. 10) according to the present invention lend themselves to mass production by using the same foil thickness throughout, as follows.

1) A sequence of rigid brush holder strips (65) with their brush strips (27) and intervening flexible joints (76) is made by stacking the requisite number of metal foils (e.g. copper or aluminum) in the intended shape and “potting”, in an electrically conductive hardenable adhesive, the intended lengths and positions of the future brush strips (65), while at the intended positions of flexible joints (76) the foils are left free.

2) The strips of brush material (27) (whose manufacture will be discussed further in section K) are affixed to the fused segments of the brush holder strips (65), e.g. by soldering, electrically conductive adhesive, or any other suitable method known to those in the field.

3) The resulting rigid strips (65) bearing fiber brush material (27) and the interlinked flexible joints (76) without fiber brush material are stacked with intervening insulating layers (48) and assembled into brush plate sections (68) preferably by gluing the rigid segments together using insulating adhesive, although other means of fastening and insulation, such as intervening electrically insulating separators, may be used between adjoining brush strips (49).

Low friction among the separate foils in the joints (76) may be achieved by cutting a fraction of them out from the joints, or the volume fraction of the “potting” material in the rigid parts must be made large enough so that without it the joints have an adequately low friction. Also, a lubricant may be applied to the foils in the joints, provided that it will not spread to, and contaminate, the brushes and slip rings.

Brush plates may be made of aluminum or other suitable foil instead of copper foil. At E_{AI}=6.5×10¹⁰ N/m² the elastic modulus of aluminum is just above one half that of copper, while on account of its electrical resistivity of ρ_{AI}=2.65×10⁻⁸ Ωm versus ρ_{Cu}=1.6×10⁻⁸ Ωm, for same electrical resistance the cross section A_{S} of Eqs.14 and 15 would need to be increased by only 60% .The use of aluminum foils for the construction of brush plates, joints, and/or bridges maybe appropriate for the circumstances, depending on criteria such as cost, deformability in manufacture, and availability.

Those skilled in the art will acknowledge that these brush plates may be implemented in a variety of ways that preserve their performance characteristics.

It may not be immediately apparent to some how best to place/replace brush plates on matching slip ring assemblies so that the individual brush strips make proper contact with their designated slip rings and are mutually electrically insulated by means of separators (49) as in FIG. 7B or slip ring extensions (33) as in FIG. 8D. This is no serious problem when slip rings and separators or slip ring extensions are relatively wide; however, this will become a challenge as the design may move to more compact, power-efficient machines with thinner and thinner separators or slip ring extensions. In terms of say, the left side of FIG. 7B, the question is how in installing brush plates one places the assembled brush strips so that brush 27(n,a) contacts slip ring 3(n) and none of its fibers straddle insulators 49(n−1) and 49(n) to cause a short-circuit between slip rings 3(n−1), 3(n) and 3(n+1). Similarly in terms of FIG. 8D, how does one install a brush plate so that fiber strips 27(1) . . . 27(N) smoothly fit into the spaces between slip ring extensions 33(1) . . . 33(N+1), without damaging the fiber strips.

Again, this is not difficult if one leaves sizeable gaps between neighboring brush strips 27(a) and similarly 27(b), but increasingly power-efficient machines will require increasingly slender separators. According to the present invention two primary methods are used as follows: (1) shaping brushes such that initially their running surfaces are compressed so as to leave gaps between neighboring brushes and (2) using temporary separators between brush strips, say, 27(n−1,a), 27(n,a) and 27(n+1,a) etc. that are withdrawn as the brushes slip between the respective separators 49(n−1), 49(n) and 49(n+1) or slip ring extensions 33(n−1), 33(n) and 33(n+1). Fortunately, too, it is now possible to produce rather shape-retentive fiber brushes that do not splay and are not too easily damaged. Additional methods will be further discussed in Section K(d)

Further, by the design of FIG. 12B, removal of brush plates would involve no more than detaching constant force springs 37, releasing connector plates 72/73 (not shown in FIG. 12), and detaching brush plates 68 from their linear bearing brackets 71. Installation of new plates would be done by reversing these steps.

Laboratory experience indicates that erratic strong increases of brush resistance and brush wear rates, as seen with traditional graphitic brushes, are virtually non-existent for fiber brushes. Although resistance and wear rate of fiber brushes can fluctuate, the changes are gradual, occurring over hours or more and therefore, more predictable. Even so, at least for large machines, it will be advisable to install on or at each brush plate, firstly, a contact resistance monitor between plate and rotors and, secondly, a proximity gauge to monitor wear distances. In relation to the cost of large machines the cost of such monitoring and alarms in case of malfunction will be small.

Wear debris may be a problem for brushes in closely spaced individual brush holders. Inevitably, the rate of wear debris production is proportional to the area of active slip ring/brush interface, A_{S}, and thus can be sizeable in accordance with equation 3. Fortunately, the debris of multi-contact metal material is much less harmful than carbon dust shed by graphitic brushes; metal fiber wear debris is chemically inert and essentially non-conducting. Fiber brush wear debris do not significantly adhere to each other. Consequently, any current in accumulations of multi-contact metal brush wear debris would be transported across large numbers of contact spots in series, and which are very small on account of the small forces among them, even while the intervening film resistivity tends to be large. By contrast, carbon wear debris is chemically reactive, and the particles adhere to each other to produce a remarkably low electrical resistivity.

The concern that multi-contact metal fiber wear debris could lodge in narrow brush tracks and interrupt conduction is remote. It has not been observed, except when the fiber material was strongly contaminated with organic substances, such as that from commercial wire drawing. Even in such a case, (i) wear particles may be flushed either periodically or continuously as part of machine cooling, best with water; or (ii) wells may be provided where wear debris is likely to settle in a machine, to capture and draw wear debris away from circulation in the machine.

(f) Mechanical Structure and Assembly of Machines

The weight of magnets (specifically 4(1) to 4(4) as in FIGS. 8 and 12), rotors, and brush assemblies must be mechanically supported, as well as the force of attraction among the magnets. In FIG. 12 this is done by the use of strong, non-rotating endplates, 70(1) and 70(2), through which axle 10 passes; or a common endplate in the case of tandem machines (i.e. plate 70(2) in FIG. 12A). The magnets could be attached to the endplates at their outer ends by customary means, such as bolts, screw threads about the magnet circumference and matching treaded openings in the base plates, or by soldering, brazing, glue, or other means. Altematively, the magnets could be mounted into a suitable framing (or stator structure), e.g. with struts fitting into gaps 78(1) to 78(4), and the framing could be fixed to the machine endplates either directly or indirectly via tie rods 69 or other supports by means of which the motor endplates are attached to each other.

Endplates 70, shown in FIG. 12, may not only be parallel flat, and solid, but other shapes or structures may be used. Thus, endplates 70 could be curved (e.g. for less drag in a fluid environment), perforated or be made of grids or meshwork (e.g. to decrease the machine weight or to facilitate cooling), and in any of these cases, could be made of metal, ceramics, plastics, composites, combinations thereof, and any material suitable for the application. Endplates 70 could be eliminated in favor of structure, whether tubing, or other suitable material, capable of supporting. For example, supports could span the circular openings at either or both ends and encircle the axle by means of low-friction bearings. Those skilled in the field will adapt the specific solutions to the various parameters needed, such as strength, volume, weight, corrosion resistance, acoustic properties, shock resistance, and/or cost. The specific design of FIG. 12 is depicted mainly because of its simplicity, but it is not meant to be exclusive in any way.

Much the same flexibility regarding shape and choice of material apply other structural details of the machine, including, for example, the means of fastening the motor to the axle. The solution depicted in FIG. 7B, namely a cylindrical attachment between rotors and axle is one embodiment, but is not meant to be exclusive.

Assembling the rotors into sets, once all of the requisite sizes have been made, requires nothing but mechanical stacking while the rotors are still wet from dipping them into some suitable lacquer or other hardenable polymer or cement that on drying will glue them together at small layer thickness of insulating material. Next the magnets may be put into place and fastened to their respective motor end-plate, or may be placed into the annular spaces on opposite ends of the rotors by any conventional means after they have already been attached to the endplates, and similarly the linear bearings with their brackets. The endplates would be joined by tie-bars 69 and the brush plates 68 would probably be installed last in the already described manner. The order in which the enumerated steps are performed in constructing a bipolar machine is optional, but the indicated sequence appears to be practical

(g) Optimizing the Ratio of Machine Diameter to Power

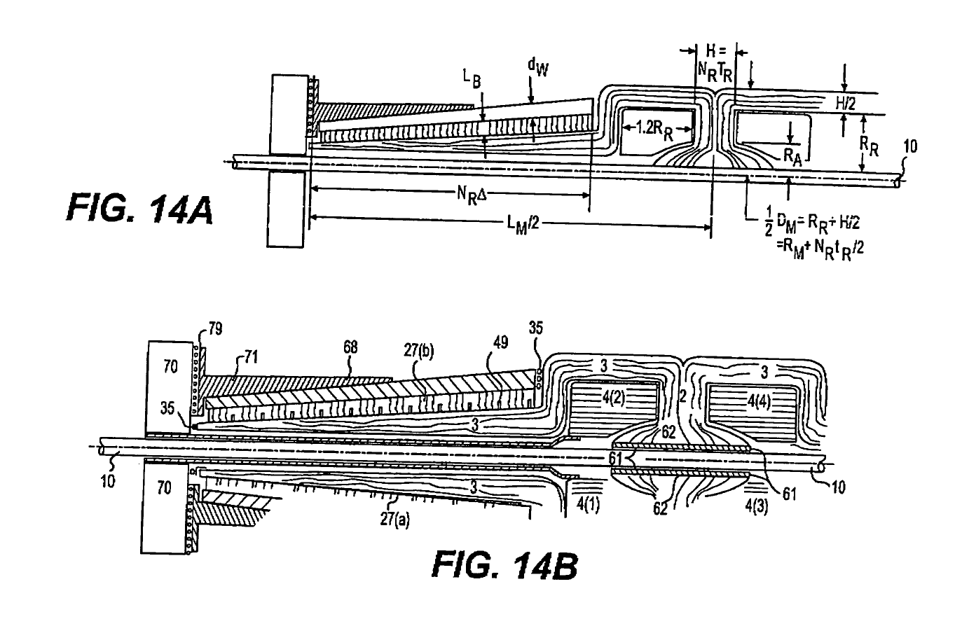

In a number of applications, specifically for podded ship drives, there is a premium on small diameter to machine power ratio while the machine length is of little concern, provided it does not much exceed a length to diameter ratio of six or seven. Altematively, there may be a premium on reduced slip ring diameter so as to reduce brush speed and thereby to extend brush life. The design of FIG. 14 accomplishes these goals by extending rotor rims 3 beyond the length of magnets 4, and thereby bringing them closer to axle 10.

Such applications may face a reduced motor efficiency and increased complexity. For example, some such embodiments may have to be constructed in two halves, e.g. the (a) and (b) half separately. The slip rings will then have to be accurately assembled and will have to have a very low run-out, e.g. no more than 0.001″=25 μm.

(h) Numerical Values for Bipolar Machines with Circular Rotors

The power of a homopolar machine is limited by the maximum permissible fractional loss,
L=V_{Ω}/V_{M} (17)

It is dominated by the voltage drop on account of the internal resistance of the machine, i.e.
V_{Ω}≅i Rᵢₙₜ≅V_{M}L (18)

Therefore for a machine operating with current i and voltage V_{M}, of .nominal machine power W_{M}, it is
W_{M}=iV_{M}=V_{M}²L/Rᵢₙₜ (19)
while
V_{M}=N_{R 1}V_{R}≅N_{R}v_{R}R_{R}B (20)
according to eqs. (4) and (5)
W_{M}≅(N_{R}v_{R}R_{R}B)²L/Rᵢₙₜ (21)

However, R is mostly proportional to N_{R}/R_{R} since the current path lengths are proportional to N_{R} R_{R} and the conductor cross sections to 1/R_{R}² while Rᵢₙₜ is proportional to N_{R}. Hence, to a first approximation, the maximum machine power is
W_{M}∝V_{R}² R_{R}³ B²L (22)
i.e., it rises:
linearly with the permissible loss, L,—which is problematic because the waste heat must be removed by forced cooling;
in proportion with v_{R}², i.e. the rotation speed,—whence the great advantage of increasing v_{R} beyond the maximum brush velocity of about 30 m/sec, as by the design in FIG. 14, but whence also the difficulty of designing homopolar ship drives with slow rotation speeds;
with the third power of the rotor radius, i.e. in essence linearly with the machine volume and mass;
in proportion with the square of the magnetic flux density, B², whence the advantage of superconducting magnets, with B in the range of 4, whereas B≅1 tesla for permanent and electro magnets.

Eq.22 is useful for estimates of the maximum power of homopolar motors with circular rotors. Specifically the internal resistance per rotor, Rᵢₙₜ/N_{R}, was estimated for the particular motor of FIG. 14 with R_{A}=R_{R}/2, i.e. α=½ (see eq.5), and with uniform thickness of rotor and rim of t_{R}≅R_{R}/N_{R}, as follows:
1) The resistance of the two half-circle annular areas, i.e. in the gap and leading the rims back towards the axle after passing the magnets and current traverse in part (a) and part (b) is, for a single rotor, (4ρ/πt_{R})ln(R_{R}/R_{A})=ρ0.88/t_{R}.
2) The resistance of the two half-cylinders formed by the rim along the magnet height of 1.2 R_{R} is 2×ρ1.2/πt_{R}=ρ0.76/t_{R}.
3) The resistance of the two half-cylindrical rims of average length N_{R}Δ is 2×ρ N_{R}Δ/πt _{R}R_{R}=0.64×ρΔ/t_{R}².
4) The resistance of the brush holders and bridges correlated with the (a) and (b) side of the rotor and of width d_{w} is 2πρR_{R}/d_{W}t_{R}.

The total internal resistance per rotor is thus

$$\begin{matrix}{}_{1}^{}{R}{}_{int}^{} = ρ \{ ( 4 / π {t}_{R} ) ln ( {R}_{R} / {R}_{A} ) + 2.4 / π {t}_{R} + 2 {N}_{R} Δ / π {t}_{R} {R}_{R} + \\ 2 π {R}_{R} / {d}_{W} {t}_{R} \} \\ \approx ρ \{ 0.88 / {t}_{R} + 0.76 / {t}_{R} + 0.64 Δ / {t}_{R}^{2} + 2 π {R}_{R} / {d}_{W} {t}_{R} \}\end{matrix} \qquad ( 23 )$$

Introducing numerical values shows that the internal resistance is dominated by the fourth term, i.e. the brush holder, so that in first approximation one may write, with 0.75 R_{R}≅N_{R}t_{R}
₁Rᵢₙₜ≈ρ2πN_{R}/d_{W} (24)

Hence with eq. 19
W_{M}=(N_{R}V_{R}²/Rᵢₙₜ)L ≈[V_{R}² d_{W}/ρ2π]L (25)
and with eq.5 and n=2, α=½ and d_{W}/R_{R}=δ_{W}
W_{M}≅[V_{R}²d_{W}/ρ2π]L≅(0.12 V_{R}² B²R_{R}³δ_{W}/ρ) (26)

By use of the typical values of V_{R}=20 m/sec, B=1Tesla and ρ=1.6×10⁻⁸ Ωm for copper, the simple relationship
W_{M}≅3×10⁹δ_{W}R_{R}³ (27)
follows. Based hereon, remarkably high possible values for the power of bipolar machines of this type follow. This topic would be further pursued, were it not that bipolar machines with cylindrical rotors are even more effective.

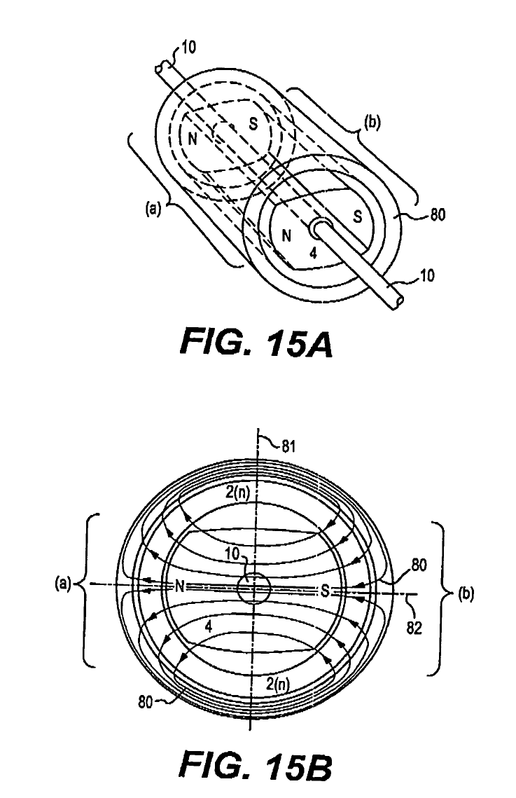

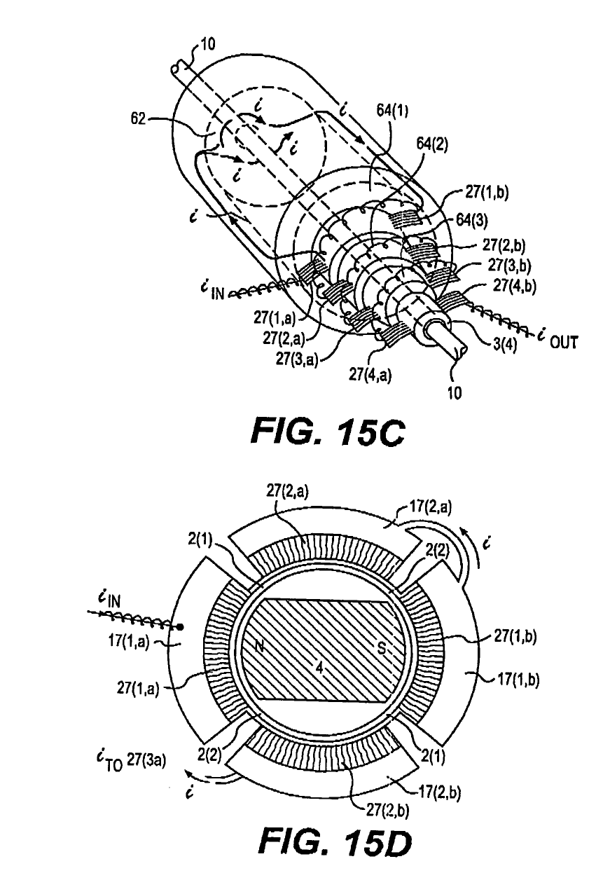

C. Bipolar Machines with Cup-Shaped or Cylindrical Rotors (FIGS. 15 to 22)

(a) Bipolar Machines with Cup-Shaped Rotors

FIGS. 7B and 14 suggest that preferably the magnetic field should penetrate the elongated cylindrical rims 3 rather than the geometrically smaller circular rotors 2 of the machine, which form the bottoms of nested cups, rather than the other way around, while maintaining the feature of bipolarity, i.e. n=2. According to one form of the present invention, this is accomplished by enclosing an axially extended bar-type magnet 4, whose direction of magnetization is normal to its long axis, in a set of rotors 2(n) in the form of axially extended cups. The cups are provided with current channel insulation layers on the cylindrical parts but are free of such at their bottoms 62, in the pattern of FIG. 6C, but in this case with the current channel insulation layers intersecting the outer circumference 20. Further, the described set of cup-shaped rotors is surrounded with a cylindrical flux return 80, as indicated in FIG. 15A.

In the described geometry, the magnetic field penetrates the cylindrical parts of the set of rotors with maximum intensity within two zones that are axially extended and are situated in diametrically opposite locations adjacent to the N-pole and the S-pole of magnet 4, respectively. The magnetic field is at maximum in symmetry plane 82 in 15B. Within the zones of strong magnetization, that together comprise roughly one third to one half of the cylindrical part of the rotors, the magnetic field is substantially radial and, being anti-mirror-symmetric with respect to plane 81 at right angles to the direction of magnetization, vanishes where that plane intersects the cups. Furthermore, within the rotors the magnetic field direction is substantially parallel to the magnet's direction of magnetization and has the same orientation in both zones of strong flux penetration. This is shown in FIG. 15B, which indicates the approximate geometry of the magnetic field by means of arrowed lines.

Dubbing the zone of strong flux penetration nearer to the N-pole the (a)-zone and the zone of strong flux penetration nearer to the S-pole the (b)zone, it follows that a positive current flowing from the outside circumference in the (a)-zone to the bottom of the cup will give rise to a clockwise torque, and on a return journey from the bottom to the outside circumference in the (b)-zone that current will similarly give rise to a torque of same strength and also in clockwise direction.

FIG.15C is a simplified perspective sketch of a bipolar motor with cup-shaped rotors of staggered lengths that shows the current path. In general terms, taking the example of a bipolar motor with cup-shaped rotors, the current is driven by an applied voltage between brushes 27(1,a) and 27(N,b) (where N=4 in FIG. 15C). Consequently, on account of the “bridges” 64(n) between brushes sliding on slip rings of neighboring rotors, a voltage drives the current from brush 27(n,a) to 27(n,b) which brushes slide on a slip ring at the outside circumference (20) of rotor (2n), wherein brush 27(n,a) is located in the (a)-zone and brush 27(n,b) is located in the (b)-zone. However, due to slots, cuts or other current channel insulation (18) that intersect the outside circumference 20 of the rotor, these two brushes are electrically connected only via the bottom of the cup (62) that is free of current channel insulation (18). Therefore, constrained by the current channel insulation the current flows from brush 27(n,a) in zone (n,a) axially along rotor n until it reaches bottom of the cup 62(n), as shown in FIG. 15C by means of the arrow line labeled i. Here the current is unconstrained and flows about axle 10 that penetrates through it toward zone (n,b) From there, again constrained by current channel insulation, the current travels axially along zone (n,b) to brush 27(n,b).

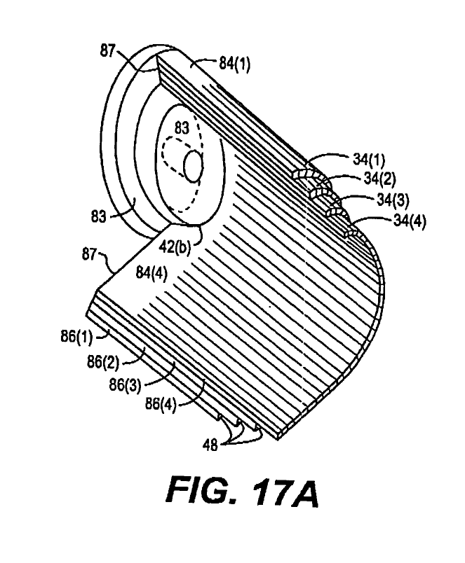

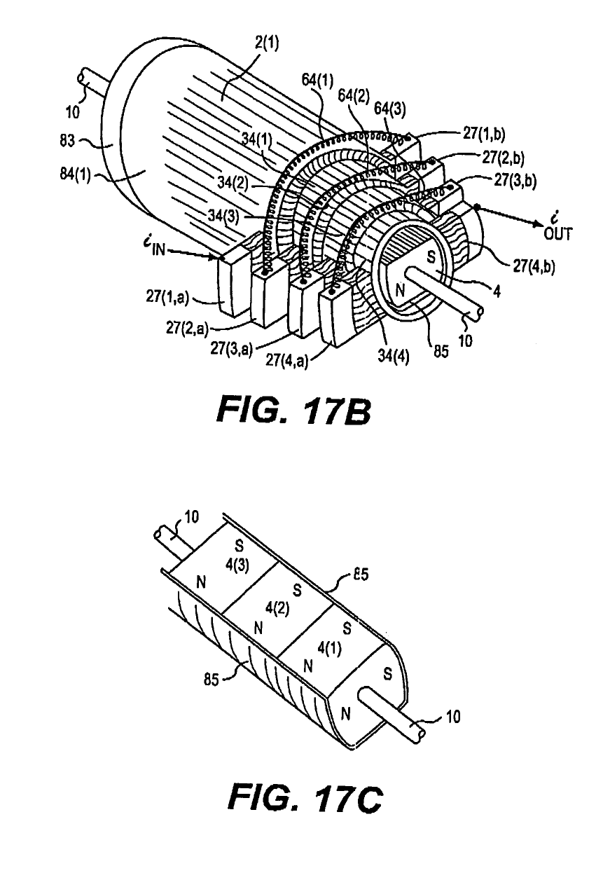

The outlined progression of the current path from rotor to rotor, successively from rotor I to rotor N, beginning with brush 27(1,a) in the (a)-zone of rotor 2(1) and ending at brush 27(N,b) in the (b)-zone of rotor N, is accomplished by electrically connecting brushes 27(n,b) and 27((n+1,a) via bridges 64(n). These are shown as spiraled lines in FIG. 15C but in actual fact could be flexible cables or, more likely in large machines, be parts of bridges 72/73 of brush plates as in FIG. 10A. Especially if the number of brushes is fairly large, brush plates will be a preferable solution and the considerations given in their regard, in connection with FIGS. 7C to 14, are applicable except that in bipolar motors with cup-shaped or cylindrical rotors, bridges can be used from both sides of the two zones, e.g. there could, and favorably should, be counterparts to bridges 64(1) to 64(3) above the slip rings in the view of FIG. 15C also underneath, and similarly in FIG. 17B. This doubling of bridges provides a considerable advantage since as shown in the calculation of the internal resistance for the bipolar machine with circular rotors, the brush strips and bridges are liable to be the dominant contributors to the internal machine resistance. By making bridges from both directions, that is not possible with circular rotors, the corresponding resistance is halved.

The set of rotors (label 2(n) in FIG. 15B and for clarity not shown in FIG. 15A) rotates in the space between magnet 4 and flux return 80. The strip-shaped bar-type magnet 4 that provides the magnetic flux could in principle be a permanent magnet, an electromagnet or a superconducting magnet, as may be deemed most suitable. However, if space is a concern, then permanent magnets may be preferable. Also, axle 10 must pass through the magnet, and similarly the axle will pass through what amounts to the bottom of cup 62 in FIG. 15C.

Typically slip rings are located beyond the geometrical extent of the magnet and thus in positions of low or negligible magnetic field strength. The brushes on them are positioned to connect with the conductive paths that are separated by current channel insulation (i.e., “current channels”) within zones (a) and (b) of strong magnetic flux density. Correspondingly, in both FIGS. 15C and 17B, brushes 27 are shown as geometrically in line with the magnetic N- and S-poles, i.e. about symmetry plane 82 shown in FIG. 15B. This is not necessary, though, because the current channels could be spiraling in the slip ring part of the rotors. In fact, by applying such spiraling in different strengths and/or directions in individual rotors, it will be possible to distribute brushes more or less evenly about the circumference, and shorten the lengths of “bridges.” This is shown in FIG. 15D. Such an arrangement may be desirable by the use of individual brush holders but probably not with brush plates.

The cups in the machines are stacked in much the same geometry as utilized for the machine with circular rotors of FIG. 14. Also in the present case it is possible to reduce the slip ring diameters below those of their rotors. Whether or not one will opt for reducing the slip ring diameters relative to the diameter of the cylindrical part of the cup, depends on whether it is more desirable to reduce the brush sliding velocity by means of reduced slip ring diameters as in FIG. 14, or is more important to reduce brush current density by means of larger slip ring circumferences. In practice, the diameters of the slip rings are liable to represent a compromise between low brush sliding speed and low brush current density (compare the numerical examples below).

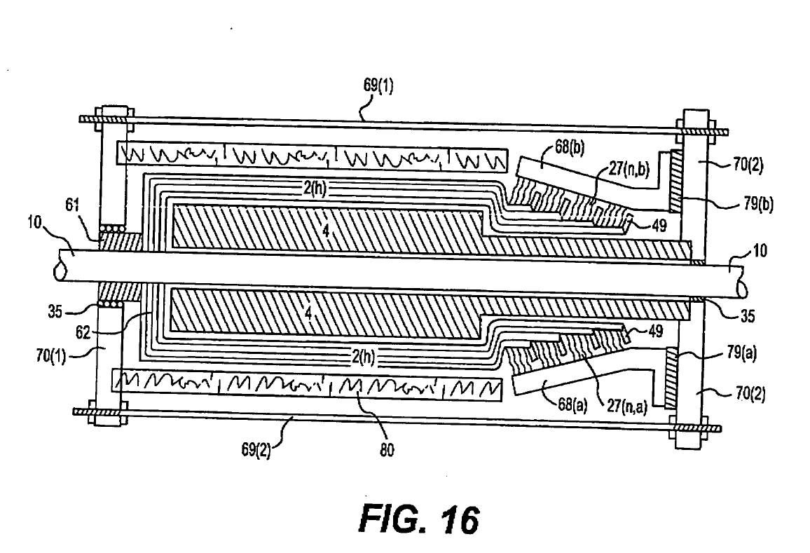

The mechanical construction of one embodiment of the machine is shown in FIG. 16. Set of rotors 2 rigidly rotates with axle 10, and is rigidly fastened to it as indicated by label 61 in FIG. 16. Magnet 4, flux return 80, brushes 27 and their individual holders or their brush plates 68, as the case may be, will be mechanically attached to motor endplates 70(1) and/or 72(2), in whatever method or arrangement may be appropriate. In the example of FIG. 16, flux return 80 is fastened to motor endplate 70(1) and the remainder, i.e. magnet 4, and the brush holders are attached to motor endplate 70(2). The shapes and means of mutual attachment of the magnet etc to the endplates is subject to wide variations and, again, the design of FIG. 16 is just an example. Further, the endplates 70(1) and/or 72(2) may be hexagonal, quadratic, or circular etc. They may be joined by tubing or by angle iron or other profiles instead of or in addition to, tie rods 69. Nor need the endplates be solid, but as already discussed in connection with bipolar machines with circular rotors, they may be perforated or may be in the form of grids, especially if direct water cooling is employed. Further end-plates may be replaced by struts or other structure incorporated into a stator,

(b) Bipolar Machines with Cylindrical Rotors and Their Manufacture

Three Simple Methods of Making Bipolar Machines. The above discussed embodiment of an axially extended bipolar machine with cup-shaped rotors, as shown in FIG. 16, for many applications is inferior to a second embodiment of the invention, namely that based on nested open-ended cylindrical rotors. The reason for that superiority is mainly cost and ease of manufacture. Namely, making multiple nested, elongated cup-shaped rotors of small wall thickness, whether or not comprising rims of decreased diameter relative to the rotors, and which cups rotate with the machine axle and whose interior contains a stationary elongated magnet, poses severe (perhaps insurmountable) precision manufacturing problems if it should be attempted to deep-draw the rotors individually.

By contrast, according to the present invention, in bipolar machines with cylindrical rotors the three-dimensional complication of cup bottom 62 is avoided by providing a bottom strip 84 that is free of current channels (i.e., free of current channel insulation) and extends beyond the end of magnet 4 on the side opposite to the slip rings. In this strip the electrical cross connection is made between brushes 27(n,a) and 27(n,b). Thereby the opportunity is generated to avoid deep drawing or other complex methods in favor of winding sheet metal stock onto rollers. As a further bonus and as discussed below, a machine with cylindrical rotors is more easily adapted to alternative use with DC and AC.

Three alternative methods are herewith proposed by which to manufacture bipolar machines with open-ended cylindrical rotors. The descriptions of the first two methods focus on the particular case that slots or cuts are used to create current channels, since these pose particular challenges that are not encountered by the use of other current channeling structures, e.g. rotors made of a current channeling material such as a composite of metal fibers in a polymer matrix. However, the first two methods are directly adaptable, and are intended to be used, also for machines with other current channeling structures, and in particular also with rotors comprising current channeling material. Method 3, by contrast, is specifically tailored to the use of current channeling material for rotors, i.e. rotors that are inherently structured for current channeling such as made of polymer matrix/metal fiber composites.

Method 1: A first approach is indicated in FIG. 17. Herein 86(1) to 86(4) (and in general an arbitrary number 86(N)) is a set of mutually electrically insulated but mechanically joined metal sheets (e.g. by means of lacquer that is still soft when adjoining pieces are fitted together) of the desired material and thickness t_{R}. Sheets 86(n) comprise current channeling structures in the indicated configuration, which may be, but not necessarily are, slots or cuts that are filled with an insulating adhesive material (e.g. stop-off lacquer or an insulating epoxy). The border at the left edge 84(4) is the aforementioned bottom conductive strip that is free of insulation and hence electrically connects all points along the right hand edge of sheet 86(4) that in the rolled-up configuration forms the innermost rotor, and similarly for all of the other sheets.

The widths of layered sheets 34 are graded as shown, so as to form the series of slip rings 34(1) to 34(4) of the machine once the sheets have been rolled up into rotors, as indicated in FIG. 17B. The sheets 34 are shown in the partly rolled-up condition in FIG. 17A Their lengths are graded so that in the fully rolled condition the two long edges are flat and “butt-end,” to be joined with an insulating adhesive for forming the machine as in FIG. 17(B).

Part 83 at border 84 is made of a mechanically strong material that serves as the means of mechanically fastening the set of cylindrical rotors 2(1) to 2(4) (and in the general case 2(n) from 2(1) to 2(N)) releasably to axle 10 such that there is no electrical contact among any of rotors 2(n) (i.e. the rolled-up sheets from 86(1) to 86(N)), and thereby 83 serves the same function as 61 in the previous figures. The shape of 83 in FIG. 17A is just one possible embodiment of a great variety of shapes that could be used for that purpose. For example, part 83 could be a simple cylindrical disk that only contacts sheet 84(4), or its vertical rim could extend over only part instead of all of the collective rotor end surface 87 radially and/or circumferentially. Part 83 could be made of metal or an insulator, and could be glued by means of some suitable adhesive to both axle 10 and rotor parts 62(n), or it could be fastened via shrink-fit to the axle, or via a collar and set-screw, or via a low-melting solder to either or both sides. However, importantly, the different rotors must be electrically insulated from each other. As throughout, this could be accomplished by means of insulating adhesive layers 48 such as a lacquer or an epoxy.

In manufacturing, however, the sketched disk-shape of 83 as the only support for rolling up the stack of sheets 86(n) may be unsatisfactory because the rotors must be fabricated with precision for the required low run-out of the slip rings (brushes wear out too fast unless the run-out is kept below about 0.001″). Therefore, the sheets should be rolled onto, and be made to close upon themselves on a precisely made cylinder, and either 83 must be elongated into such a cylinder, or the sheets have to be wound and glued together on a suitable cylinder, then be removed therefrom and then part 83 be inserted. In a continuous manufacturing processes, those skilled in the art may adapt a tool of the kind used in manufacturing of tubing for this purpose.

The butt-end joining of the two long edges of the stack of sheets 86(n) may have to be done with insulating adhesive or lacquer, if it should prove to be too difficult to conductively join the respective free edges of sheet 86(n) without inadvertently creating short circuits among neighboring layers. Such an insulating axial glue joint would create a current barrier in the axial direction across all of bottom strips 84(1) to 84(N) so as on average to double the ohmic resistance of the current in strips 84(n) on the path between brushes 27(n,a) and 27(n,b). However, as will be shown later, the corresponding contribution to the internal machine resistance will be insignificant compared to the other terms provided that the width of bottom strips 84(n) is a not too small fraction of the rotor radius R_{R}.

Making a motor of the type in FIG. 15 after obtaining the set of rotors in the form of a rolled-up cylinder according to FIG. 17A will require some care. In particular, it will be necessary to avoid a significant elastic twist of rotors and magnets that would cause misalignment between cuts, and thus misalign the current path and the zone of magnetic penetration. If a continuous method as in the manufacture of tubing already mentioned is used, staggering of lengths, as shown in FIG. 17A, may be impossible and pre-formed slip ring assemblies may have to be attached as further described in connection with method 2 below.

In view of the typically poor mechanical properties of permanent magnets, and the cost of continuous, long magnets, it is proposed to use several or many smaller magnets in a shaped tubing, or in tray 85 as shown in FIG. 17C, in lieu of a single magnet. This will certainly cut cost of magnet material and will not affect machine operation. The force due to the machine torque may be supported by the tray or other structure, such as shaped tubing.

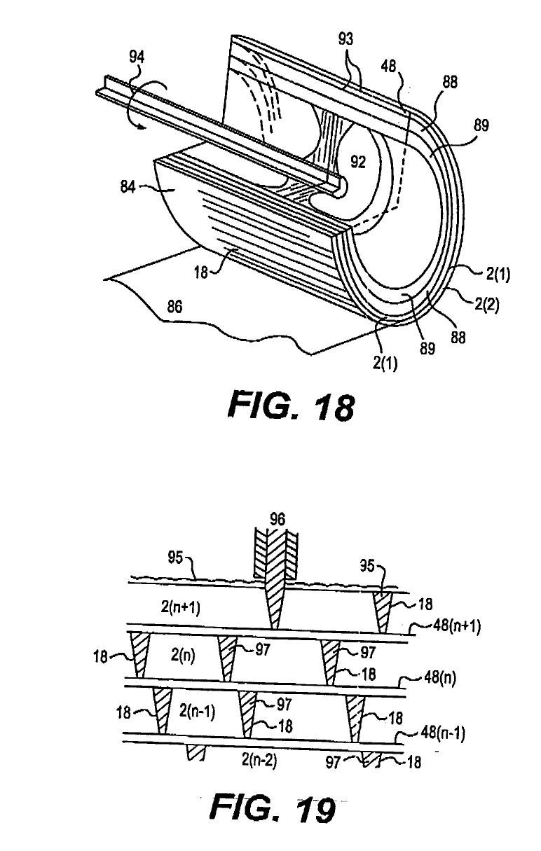

Method 2: Method 1 yields slip rings of same diameter as the corresponding rotors, such that it may be difficult to reduce or increase slip ring diameters while maintaining low run-out. Also, a nonconductive barrier across the bottom strips 84(n) may be undesirable. Therefore according to a second embodiment of the present invention, illustrated in FIGS. 18 to 21, there is provided a configuration which permits independent choices of rotor and slip ring diameters. It has additional benefits of being more accurate and economical.

In this approach, as illustrated in FIG. 18, continuous metal sheet stock 86 of thickness ≧t_{R}, (i.e., smaller than or equal to the desired thickness of the rotors in the stack), is wound onto roller 89 in successive intervals of the desired rotor thickness t_{R}, and cuts are made, either continuously or at the completion of an interval. After the completion of any one t_{R} thick layer, (i.e., rotor), the sheet stock 86 is cut off and an insulating layer 48 is supplied before the next layer.

FIGS. 18 to 20 provide further details, including the production of slip rings. To begin with, the very first layer of the first t_{R} thick interval is deposited on roller 89 or on an insulating layer 48(1) that has been coated with an adhesive (preferably, but not necessarily insulating). Similarly, the first layer of each t_{R} thick interval, in general the nth layer, is glued to an insulating layer 48(n) that in turn is glued to the topmost layer of sheet stock of the previous interval, preferably but not necessarily by means of insulating adhesive.

On account of the force of tension, a stack of rotors may be wound in the outlined manner without the use of adhesive except as may be required to prevent unraveling from the outermost layer. This approach may be the quickest and least costly. However, in order to form solid rotors of maximum strength from the described layering of wound metal sheet stock, adhesive is continuously applied to the surface of the sheet stock, i.e. while sheet stock is laid down within any one t_{R} interval. Thereby each turn or layer is bonded to the turn or layer of sheet stock underneath, until a strong, solid cylindrical rotor of wall thickness t_{R} is completed.

For maximum electrical conductivity, the adhesive applied among the turns forming a single rotor, should be conductive. However, if so, the slots or cuts for current channeling cannot easily be made on individual layers or on small groups of layers because the cutting blade is liable to smear conductive adhesive into the cuts, possibly causing shorts between the two sides. Conversely, by the use of insulating adhesive and a suitable cutting technique, as illustrated in FIG. 19, still liquid or viscous insulating adhesive 95 may be dragged into the cut and at the same time prevent accidental short circuits between the sides of a cut and provide mechanical strength on hardening. Of course, current channels configured in a way that does not involve slots or machined cuts at this point would avoid both situations.

One may therefore choose to apply insulating adhesive and make any cuts continuously on single turns as they are being wound, at the penalty of somewhat increased electrical rotor resistance. Alternatively one may choose to bond the windings into rotors by means of conductive adhesive and defer making the cuts until a predetermined fraction of the intended wall thickness has been generated or a whole layer of thickness t_{R} has been formed, then make the cuts by the use of insulating liquid or lightly viscous adhesive 95 as indicated in FIG. 19.

In a simple modification of generating rotor sets by means of winding onto rollers, sheet stock widths may be staggered, comparable to FIG. 17A, so as to provide parallel slip rings of same diameter as the rotor to which they belong. In that case, one begins with the widest sheet for the innermost rotor (comparable to sheet 86(4) in FIG. 17A, but in the following outline labeled sheet 86(1)). Further, roller 89 is dimensioned to yield the desired inner diameter, R_{A}, of the set of rotors.

Preferably, according to the present invention, winding should either start with one or more layers of an insulating, low-friction material such as teflon to facilitate removal of the completed set of rotors from permanent roller 89. Alternatively, wind the sheet stock onto thin-walled tubing 88 that will be permanently incorporated into the machine.

Elaborating on what has already been outlined above, the steps of method 2 are as follows: If using metal sheet stock 86 of thickness t_{R} and of width L(1), apply (in any desired manner, e.g. by brushing, spreading, spraying, dipping, etc.) an electrically insulating adhesive or cement to the surface of inner tubing 88 or insulating layer 48(1). Wind on one turn of sheet 86 and, in any desired order, cut off from the remaining sheet stock, apply insulating adhesive to all of the outside of sheet 86, except for a width A that will form slip ring 34(1), make cuts over the whole sheet 86 except for bottom strip 84(1). Next place or wind onto the adhesive-covered sheet 86, complete with cuts (now rotor 2(1)), an insulating barrier material 48(2) covering sheet 86 completely, except for slip ring 34(1). Continue with rotor 2(2) by using the same method, but with sheet stock of width L(2)=L(1)−Δ that is aligned with rotor 2(1) at the current return strip edge 87.

Optionally, another embodiment involves use of a thinner sheet stock, especially t_{R}>≅1 mm, or thickness just below (to make allowance for the adhesive) t_{R}/2, t_{R}/3, t_{R}/4 and in general t_{R}/n. In that case the same procedure is followed except that as much sheet stock is wound onto the roller as needed to generate wall thickness t_{R}. Further, by the use of sheet stock of thickness≦t_{R} inhibits the opening of cuts on account of winding tension, and greatly increases the strength of the resulting set of rotors by continuously applying adhesive until rotor thickness t_{R} is reached. As explained above, the choice between conductive and non-conductive adhesive between the layers that form any one individual rotor may be a choice between maximum electrical conductivity and the ease of cutting.

In any case, either continuously or when a suitable fraction if not a complete t_{R} layer thickness of conductive rotor wall has been laid down, apply cuts in an axial direction over the whole width of every layer, except for bottom strip 84 that in the completed machine serves as current path between brushes. In this operation, care must be taken not to mechanically open up the cuts through the winding tension in the sheet stock, or to fill cuts with conductive adhesive. It is therefore advisable to make the cuts at intervals or after a single rotor winding has been completed, and preferably not while there is still moist conductive adhesive present that could infiltrate into the cuts and permit current conduction. One alternative is to use non-conductive adhesive throughout, for embodiments in which the resulting marginal increase of rotor resistance is of no concern.

According to the present invention, one method for generating current channel insulation of high electrical resistance as well as radial tensile strength, is indicated in FIG. 19. Herein the slots or cuts are visualized as being made by mechanical cutting, which presumably is the fastest and most economical way, but other methods will be equally acceptable, e.g. etching, or ion beam cutting, or laser cutting. Further, for this embodiment the cuts preferably should be made at least a quarter turn from the point of beginning winding where the sheet already adheres to the layer below, so as to inhibit mechanical spreading of the cuts through winding tension. The actual cutting may be done after the sheet has been coated with non-conductive adhesive, and while the adhesive is still fluid or lightly viscous, so that the cuts are immediately filled with the non-conducting adhesive.

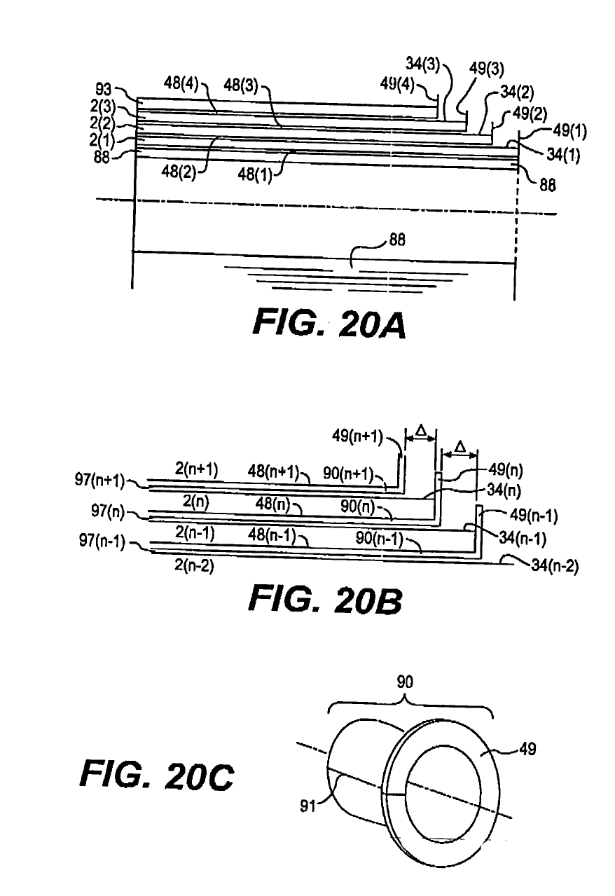

According to the present invention, with the use of sheets of staggered widths, the rotors are formed and insulating layers 48(n) and separators 49(n) between adjoining slip rings are introduced as illustrated in outline in FIG. 20A and in greater detail in FIG. 20B. The procedure includes the following steps.

(i) Onto the completed layered rotor 2(n−1), made of L(n−1) wide metal sheet stock, apply (by any desired method) a thin layer of adhesive 95 except for the width of that shall form slip ring 34(n−1).

(ii) Unless this has been done already, create current channeling insulation, such as by making cuts filled with fluid or “tacky” insulating adhesive 95 as in FIG. 19, or by any other suitable method,

(iii) Onto the still tacky adhesive 95 on rotor 2(n−1),place insulating layer 48(n) of width, say, L₍ₙ₋₁₎−2.5Δ, and thereby form an adhesive bond between the surface of rotor 2(n−1) and insulating layer 48(n). Note that insulating layer 48(n) may be in the form of a single layer or consist of a plurality of windings joined by means of insulating adhesive.

(iv) Onto the still tacky adhesive on the 1.5Δ wide strip between slip ring 34(n-1) and insulating layer 48(n), similarly place, and thereby glue on, part 90(n) that is shown separately in FIG. 20C. It is a ring of somewhat flexible insulating material that comprises barrier 49(n) as a kind of flange and is placed to butt-end with the edge of its cylindrical part against the free edge of insulating layer 48(n). For convenience part 90 may be cut through by an axial cut 91 as indicated in FIG. 20C, so that it may be placed into position by forcing it over the roller and then be allowed to snap back into its original shape. Alternatively, part 90(n) may be made without such a cut, and be slipped over and past slip ring 34(n−1) from the free edge of the roller with its windings.

(iv) Cover insulating layer 48(n) and insulating part 90(n) with a thin layer of adhesive.

(v) Begin winding rotor 2(n) by gluing metal stock of a width L₍ₙ₎=L₍ₙ₋₁₎−Δ onto insulating layer 48(n) and the cylindrical part of 90(n).

(vi) Complete winding rotor 2(n) by continually gluing a thin layer of (preferably, but not necessarily conductive) adhesive.

(vii) Optionally make slots or cuts continually as the material is wound but make sure that the cuts are not mechanically opened by tension nor short-circuited by inadvertently being partly or completely filled with conductive adhesive, as already explained

(viii) Cut off from the remaining sheet stock.

(ix) Apply a thin layer of electrically insulating adhesive.

(x) Unless this has already been done, make current channel insulation cuts as indicated in FIG. 19.

(xi) Begin new cycle by spreading adhesive onto all but width A for slip ring 34(n)

(xii) Glue on insulating layer 48(n+1) and part 90(n+1) in the already described manner and continue until the last rotor is completed.

As indicated by the labels 97(n−1), 97(n) and 97(n+1) at the left of FIG. 20(B) that signify a cured adhesive between adjoining layers, it is anticipated that the adhesive hardens speedily already in the course of the winding operation. However, this is not necessary and the adhesive may be allowed to harden to its full mechanical strength by storing at ambient temperature or it may be cured by heating in an oven or by any other method of heating.

Refined Methods 1 and 2 and Slip Rings with Reduced Diameter

According to the present invention, a modification of methods 1 and 2 permits making machines with arbitrary, typically reduced, slip ring diameters as follows.

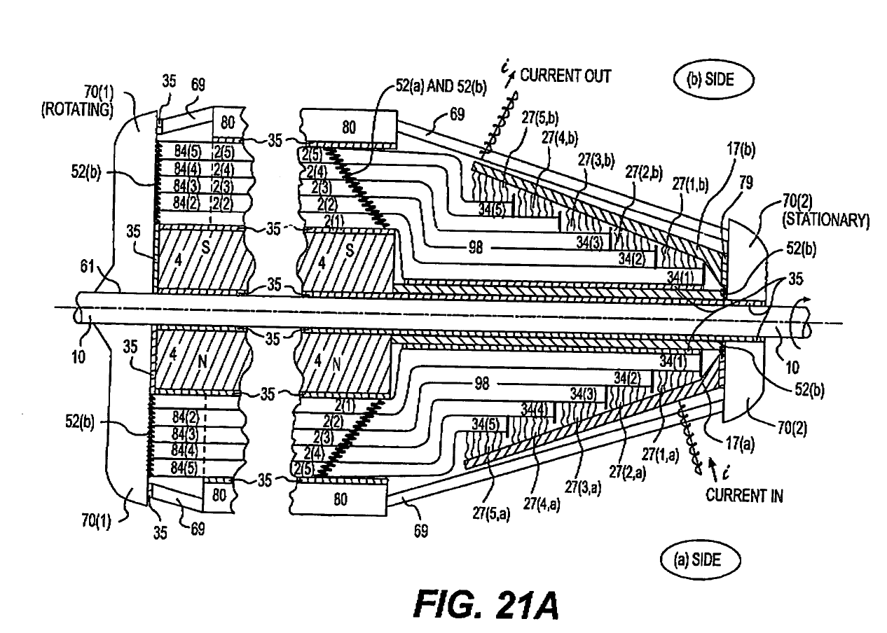

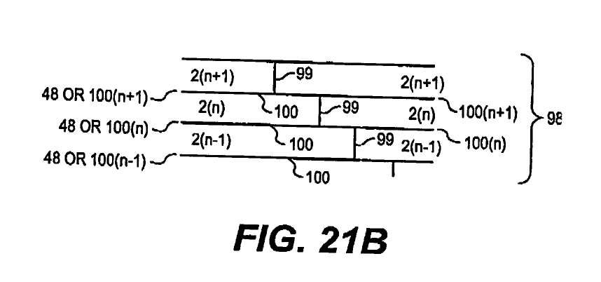

Make all rotors of same or similar length with cuts as before but wind onto a roller 89 that is modestly longer than the width of the sheet stock. Then at the completion of winding rotor 2(n), slip over the free edge of the assembly a pre-formed part 98(n) that at its wide end snugly fits over the previous layer 98(n−1) and at its narrow end comprises the slip ring 34(n) and separator 49(n) of reduced diameter that in turn fit snugly over the previous slip ring part of part 98(n−1), as illustrated in FIG. 21. Glue part 98(n) to the underlying part 98(n−1), and conductively glue or otherwise join together the butt-ends of rotor 2(n) and of part 98(n). Next apply insulating layer 48(n+1) and proceed with winding 2(n+1).

Returning to machines not made with current-channeling material, a lengthwise cross section of a completed machine with cylindrical rotors and reduced slip ring diameters by means of part 98 is shown in FIG. 21A, while FIG. 21B clarifies the described joining method between rotor(s) and slip rings. Shown in FIG. 21B is an enlarged view of the joints between rotors 2(n−1), 2(n) and 2(n+1) on the left and their correlated parts of the slip ring assembly on the right for the case of nested separate rotors. The slip rings had been pre-formed as parts 98(n−1), 98(n) and 98(n−1) but are now simply a continuation of the respective rotors. Herein, label 99 designates electrically conductive bonding, and 100 electrically insulating bonding, optionally including a dielectric breakdown interlayer, (see section Je).

These joints are preferably fabricated to be mechanically strong enough to sustain some part of the torque between axle 10 and rotors 2(1) to 2(N). It is for this reason that collectively the joints between rotors and preformed slip rings are stepped, which provides a greater bonding area. Any number of adhesives or cements could be used, some conductive and some insulating, depending on position and the application. For high demand uses, such as insulating joints between conductors, (e.g. for filling cuts in slip rings), cements used by dentists are an attractive choice.

Method 3—Rotors Made of Current Channeling Material: The present invention includes a third method for making rotors, namely making them wholly or partly of current channeling material. This method permits simplification in manufacturing rotors, slip rings, and bottom strips free of current channeling structures. In this preferred method, the rotor is current channeling, i.e. fabricated with or composed of a material with structurally inherent current channeling, aligned to the desired direction, such as a composite of continuous conductive fibers in a non-conductive matrix. With a rotor made of such material, it is not necessary to physically delineate concentric rotors. Instead of fastening individual rims 3(n) with slip rings 34(n), and individual bottom strips 84(n) to individual physically delineated rotors, one may fasten these pair-wise to one and the same concentric cylindrical zone in a monolithic rotor made of a current channeling material. Preferably, for this arrangement, the current channeling elements will be accurately and axially aligned, so that a majority of them extend through the whole length of the future rotor. Under these conditions, any one cylindrical zone between correlated slip rings 34(n) and bottom strips 84(n) that electrically connect to opposite ends of the same metal fibers represents one cylindrical rotor; the entire cylindrical rotor made of current channeling material represents a set of rotors. Thus, for some arrangements, it is not necessary that the fibers be axially aligned, but only that they extend between a correlated pair of slip ring and bottom strip. Thus conductive fibers in current channels could spiral, as discussed in connection with FIG. 15D.

The use of materials with structurally inherent current channeling for making rotors is shown in FIG. 22. Inherent current channeling has two principal benefits: 1) It eliminates the need for imposing current channeling structure onto an embodiment, such as accommodating, machining, and making slots or cuts, as discussed in conjunction with FIG. 19. 2) The length of rotor may be almost arbitrarily extended. These two benefits are somewhat offset by moderately increased internal electrical resistance attributable to the volume fraction of insulating material in the rotors.

In FIG. 22, rotor 2 is “monolithic”, i.e. has no internal subdivisions. It is made of current channeling material, e.g. conductive fibers or other extended metal shapes such as tubing or strips or small cross sectional dimensions that are embedded in an insulating or non-conducting matrix material so as to be mutually insulated. The embedded conductors may be made, for example, of oxidized aluminum. This material offers the advantages of low weight and the possibility of using very high packing densities. With oxidized aluminum, electrical contact, and potential short-circuiting between parallel current “turns,” is prevented by the high resistance aluminum oxide layers as it is by non-metallic embedding material. Anyway, for most embodiments, the embedded and mutually electrically insulated current conductors in any shape are (i) continuous with any one conductor extending from end to end of the rotor, and (ii) start and end at the same radial distance from the rotor axis (In FIG. 22 indicated by the central dash-point-dash line).

In the example shown in FIG. 22A, rims 3(1), 3(2) and 3(3) with slip rings 34(1), 34(2) and 34(3) are supplied with slip ring extensions 33(1), 33(2) and 33(3) that are conductively and firmly fastened to monolithic rotor 2 so as to each make low-resistance electrical contact the metal fiber ends in one of three concentric cylindrical zones, which at the other end of the rotor are conductively connected to bottom strips 84(1), 84(2) and 84(3). Those three concentric zones play the role of three concentric rotors, as indicated in FIGS. 22A and 22B by means of dash-point-dash lines. These are marker lines only, without physical structure, and an embodiment may have any number of slip rings 34 and bottom strips.84 suitable to the application. Ordinarily, dielectric breakdown bonding should be put to use on brush plates as in FIGS. 22D, E and G, and between slip rings as in 22B only for very special reasons.

As already indicated, on the opposite end of the concentric cylindrical zones that define concentric rotors, matching cylindrical bottom strips free of current channeling structures, 84(1), 84(2) and 84(3), are firmly fastened so as to make low-resistance electrical contact, respectively, with the same fibers to which slip rings 34(1), 34(2) and 34(3) are electrically connected.

The low-resistance firm connection between the rotor material and the slip rings and bottom strips, respectively, may be accomplished by various means. For the embodiment in FIG. 22, metal screws 25 supplement electrically conductive joints 99(1s), 99(2s) and 99(3s) at the butt-ends of the slip rings and 99(1b), 99(2b) a 99(3b) on the slanted joints at the bottom strip side Joints 99(n) may be glued with a thin layer of conductive glue and/or may be soldered. Soldering may be facilitated, using a suitable choice of materials that will not wet most non-metal matrix materials. A typical embodiment will facilitate current flow in the axis direction as much as possible while minimizing current conduction along the conductive joint, and thus between the different “turns”.

Preferably, neighboring slip rings will be electrically insulated from each other. In the example of FIG. 22A, separators 49(1s) and 49(2s) on the slip ring side and 49(1b) and 49(2b) on the side of the bottom strips provide the requisite insulation. These are shown to extend into the rotor 2. Thin, cylindrical strips of a suitable plastic may be fitted and glued into the slip ring assembly on one side and into narrow matching grooves cut into the rotor material on the other side, and similarly at the bottom strips. Such strips have an additional advantage of increasing the shear strength against axial torque

A minor amount of undesirable short circuiting between neighboring slip rings along conductive joints may be eliminated by using diameters of the fibers (or other conductors) that are smaller than the thickness of the separators, so as to virtually eliminate the incidence of fibers which straddle the boundaries between neighboring slip rings. However, slender separators are preferably as narrow as possible since they interrupt current flow between, into and out of the rotor. Further, in order to reduce accidental short-circuiting, slip ring extensions are covered with insulating layers 48 on the side facing the next slip ring,

In the same manner as for all bipolar machines, slip rings 34(1), 34(2) and 34(3) that are not made of current-channeling material, must be provided with current channel insulation, such as slots, in order to electrically insulate the brushes on the a- and b-side from each other, as shown in FIG. 22C. Typical brushes may be brush strips extending from brush plates, and any of the modifications of geometry, such as those introduced in FIG. 8, may be employed, including simple cylindrical slip rings. Examples in addition to those already given in FIG. 8 are shown in FIGS. 22B, 22C and 22D, which also depict some other ways of joining the slip rings and bottom strips to the rotor. One objective of the different configurations of the slip rings shown is to provide geometries that simplify the placement of brushes into series of potentially large numbers of narrowly spaced slip rings, and the reduction of the danger of accidental electrical contact between brushes on neighboring slip rings.

A simplification relative to FIGS. 22A to D is possible by sliding the brushes on suitably machined strips on the rotor itself, as illustrated in FIGS. 22E to G. Advantages of slip rings in the form of machined bands on the rotor itself, are: (1) simplified construction compared to the designs in FIGS. 22A to D that will doubtlessly lower manufacturing costs (2) elimination of the need for providing current channel insulation on the slip rings, (3) elimination of potentially weak joints between slip rings and rotor, and (4) almost 100% utilization of current conduction cross section on the slip ring side.

An overall view is shown in FIG. 22E, and in greater detail in FIG. 22G. According to this embodiment of the present invention, the slip ring end of the rotor is machined into a profile of cone-shaped sections that serve as slip rings which are separated by narrow zones of opposite slope. The slip ring zones, i.e. 34(1), 34(2) and 34(3) in FIG. 22E, slope away from the working section where the rotor is intersected by the magnetic field between magnet 4 within the rotor and the flux return 80 that surrounds the rotor. The narrow zones separating the slip rings are sloped in the opposite direction. As seen in FIGS. 22E and F, these narrow zones impede mechanical and electrical contact between neighboring brush strips 27(1), 27(20 and 27(3) in FIGS. 22E and 22F. For extra safety, the brushes themselves may be coated with insulating spray or other surfacing.

The narrow zones between slip rings 34(1), 34(2) and 34(3) form mechanical barriers against touching of brushes on neighboring slip rings, e.g. of 27(2) and 27(3) without any loss of conductive paths, as with separators 49 in accordance with FIGS. 22A to 22D, except due to inaccuracies in the alignment of the fibers or other conducting members, provided that they are slender. This is shown in FIG. 22G by the lines in axial direction that indicate the axially aligned conductive elements in the current channeling material. As seen, in the proposed geometry, the current line that just barely misses the “downhill” edge of, say, brush 27(3), arrives at the top edge of brush 27(2), and similarly, the element that just misses the lower edge of brush 27(2), arrives at the upper edge of brush 27(1). The specific profile in FIGS. 22E and 22F are examples of a wide range of profiles with this feature that is possible by varying the relative widths and slopes of the slip ring as compared to the barrier zones.

When slip rings as part of the rotor are provided with current channeling structures throughout, they need no further machining or treatment to create current channels. Construction as in FIGS. 22E and 22F with increased opposing slope in the narrow barrier zones will permit quite closely spaced narrow slip rings, and thus many turns, limited mainly by the conductor diameter and accuracy of conductor alignment. The slip rings may be operated in open atmosphere if the conductors and the brushes are of a noble metal, otherwise they may be operated in a protected atmosphere. If aluminum is used as conductor material, it preferably will be plated with a noble metal in both cases.

The construction on the bottom strip end may be simpler than at the slip ring end, but entails some lowering of conductive cross section. The embodiment shown in FIGS. 22E and 22G, envisages making very narrow, shallow cuts at the positions of the insulating layers 48 between adjoining bottom strips 84 that preferably but not necessarily will be filled with insulating material. If conductive joint 99 is very thin, it will inhibit current conduction between adjacent bottom strips. Again, the geometry of joining the bottom strips in FIGS. 22E and 22G to the rotor is by way of example. Many variations are possible, such as interposing cylindrical barriers between sloping sections in joint 99, fluting or saw-tooth-ing for improving bonding strength, etc.

Those skilled in the art will appreciate that the method for manufacturing the monolithic rotors will depend on the form of the starting material. For example, if the current channeling material is obtained in the form of sheets or foils, the rotors may preferably be formed by Methods 1 or 2, but if it is supplied in the form of rods, cylinders, or plates, then rotors may be formed through conventional machining, e.g. boring or turning in a lathe. Similarly, if the starting material is a powder or ceramic, or if the conductors are nanotubes intended for a micro-electro-mechanical system, then the method of assembly will necessarily derive from the field of application. The above descriptions are intended to be by way of example, and not limitation.

Finally, and in summary, current channeling materials may be used to fashion monolithic rotors that have no cylindrical insulating layers (48) to delineate nested rotors of a set. Such delineation is not needed, provided the rotor material inhibits all cross currents. Further, if desired the current channeling structures in such a material need not have strictly axial orientation but, if desired, may be spiraled or waved in cylindrical surfaces, i.e. with constant radial distance from the rotation axis. Two basic objectives for low-loss functioning of a machine with a rotor made of current channeling material are (1) small size and precise alignment of the current channeling structures in the rotor and (2) precise alignment of the bottom strips with the slip rings

Extra-Long Machines

An additional advantage of monolithic rotors of current channeling material is the potential for producing extra long rotors for machines with correspondingly large voltages (eq.4). Indeed, a drawback of method 2 is the restricted length of obtainable rotors. In this regard method 1 is superior, because it is amenable to continuous curling and butt-joining of stacks of sheet in much the same method that is used for making commercial tubing, as pointed out above. Method 2 and 3 may not be easily amenable to production of rotor lengths for large machines. These may need to be fitted together in segments of manageable lengths, e.g. of current-channeling material or of wound sheet stock, as indicated in FIG. 23. With rotor wall thickness of t_{R}>1 mm, this fitting together will presumably not pose any serious problems; but care must be taken to avoid inadvertent electrical shorts among different rotors. Winding and alignment before joining sections must thus be done accurately, and if need be the thickness of the insulating layers 48 may be increased, although this will lead to a corresponding increase of internal resistance and a decrease of machine efficiency. The joining of sections, as in FIG. 23, will be required only for medium sized to large machines in where internal ohmic resistances tend to be relatively small and no great loss of efficiency results from raising them moderately.

The preceding discussion regarding joining methods in connection with method 3 apply also here. Actual joining for minimum electrical resistance at the interfaces between conductors may be done by means of conductive adhesives, soldering, or equivalent. In the former case, it may be possible to pre-fabricate peel-off sheets with the correct pattern of still “tacky” conductive adhesive applied. As to soldering, it is a great aid that solder tends not to wet insulators. Therefore a thin layer of solder may be applied over the whole interface and yet only the metal layer will bond and no conductive paths will be established in-between. Still other means of joining may be feasible, and be developed as the need may arise.

Machine Structure

Most of the various methods and morphologies described for slip rings and bottom strips of machines with rotors made of current channeling material, apply also to layered rotors, i.e. made by methods 1 and 2. This includes machining slip rings directly onto a rotor as in FIGS. 22E and 22F. However, fitting slip rings onto rotors as in FIGS. 20 and 21 is required for obtaining slip rings of reduced diameter. Slip rings of reduced diameter that will permit achieving higher machine rotation speeds than would otherwise possible if it were limited by permissible brush sliding velocities. Proposed methods according to the present invention have already been discussed in conjunction with FIG. 21.

Several features in FIG. 21A are the same as in FIG. 16 or are closely parallel to these, although elimination of the cup bottom parts of the rotors will greatly simplify machine assembly. In fact a wide variety of specific structures for bipolar machines according to the present invention is possible even beyond those already discussed. The drawings herein are meant to illustrate exemplary embodiments of the invention and to document that it can be translated into practice by comparatively simple methods. They are not meant to be exhaustive.

The major difference in the machine structures in FIGS. 16 and 21 is the treatment of back plate 70(1), away from the slip rings. While 70(1) is stationary and rigidly fastened to back plate 70(2) in FIG. 16, it rotates with the rotors in FIG. 21. Both constructions have their advantages and disadvantages and future decisions for actual machines will be based on these. For example, keeping the rotating mass as small as possible will aid in keeping kinetic energy needs and vibrations low. Therefore in future machine constructions the designers will carefully examine all aspects including the question to what degree back plates may be variously modified or dispensed with in favor of other constructions as already discussed above. However, the machine of FIG. 21 is visualized as being bigger and longer than that in FIG. 16, and to deliver a larger torque. Therefore the rotors in FIG. 21 would need a strong mechanical support and be fastened very stably to the axle. In view of the other requirements on the rotors and the possible need for occasional repairs, i.e. that the machine can be disassembled without destroying it, a rotating back plate seemed to be more suitable.

Those skilled in the art will appreciate that large length to diameter aspect ratios and large torques, at the least medium-sized to large bipolar machines may require low-friction bearings at certain interfaces, such as those between (i) axle and magnet(s), (ii) magnet(s) and innermost rotor, (iii) outermost rotor and flux return. Additionally, since the rotors rotate relative to one or the other motor endplate, the corresponding bearings at the endplates may be useful. Such bearings are indicated in FIG. 21 with labels 35 whereas on FIG. 16 they would probably also be used, somewhat depending on size, but are shown only between axle 10 and back plate 70(2), respectively part 61 that connects rotors 2(n) to axle 10 and back plate 70(1). Mostly but not necessarily, those bearings will be ball bearings or roller bearings.

Bearings named under numerals (i), (ii), and (iii) above, are likely to operate under sizeable forces normal to their sliding direction on account of the strong magnetic field and hence strong force of attraction between the magnet and the flux return. Even so, since the effective coefficient of friction of, say, ball or roller bearings is in the order of 1%, the resulting friction loss is liable to remain below 1% of machine power.

Other noteworthy features in FIG. 21 are the linear bearings 79 of the brush plates. These will enable smooth motion of the plates under the comparatively small brush forces as brushes wear. Not shown are the cables or bus bars by which the brush plates are electrically connected to the terminals of the current supply or consumer. According to the present invention those linkages are made via resilient multi-contact metal material as already indicated in section Dc.

Struts 69 support the flux return that in large machines can weigh tens of tons, and may in practice take a variety of shapes, or be incorporated into the static structure (or stator), including a more complex scaffolding that stabilizes the whole structure. Note, however, that the magnet only the first part of the cavity within the innermost rotor, instead of all of it (i.e. the cut shown in FIG. 21 is in the plane of the magnet-symmetry plane 82 of FIG. 15B.)

Finally, medium sized to large machines may require outside supports 101(1) and 101(2) as part of the static structure in FIG. 23, wherein the machine is visualized as having been assembled from three sections, 102(1), 102(2) and 102(3), as outlined above, but with keyed profile for extra mechanical strength.

D. Machine Operation with DC, AC and/or 3-Phase Current (FIGS. 12 and 23)

(a) Two Machines in Tandem

Motor control may accord with standard practices available in the field. Motor control is expected to be relatively simple since homopolar machinery requires no electric circuitry besides the interconnections among brushes in order to obtain multiple current turns. In addition there may be circuitry for recommended monitoring systems, including of brush plates, if any. Therefore, in general terms, (i) the power of homopolar machines, including bipolar machines, may be controlled by controlling the magnitude of the current; (ii) the rotation direction may be reversed by reversing the current direction, and (iii) the machines may be idled by interrupting the current through the rotors, e.g. opening switch 77 in FIG. 12A. Also, as in the case of basic homopolar motors, (iv) any desired number of bipolar machines may be operated on the same axle. Next, in the case of multiple homopolar machines operating on the same axle, (v) the power delivered to or extracted from the rotating axle may be controlled by the number of powered machines, as compared to idling machines, and/or by the power delivered to or extracted from at least one machine.

The arrangement of two similar homopolar machines operating on the same axle may be called “in tandem”. The following advantages accrue from teaming two homopolar machines in tandem, as in FIG. 12, whether they are used as motors or generators. Firstly, if connected in series their voltages add, in essence because the current flows through the rotors of both machines, doubling N_{R}. Secondly in the motor mode, as shown in FIG. 12A, by the use of an AC supply in conjunction with rectifiers in opposite directions in the circuits of the two machines, one will be driven by the positive phase and the other will be driven by the negative phase. Thus, two homopolar motors operating in tandem can be used with either AC or DC or three-phase current, indeed of any frequency, by employing rectifiers with the positive phase feeding one motor and the negative phase the other, as in FIG. 12A. The two modes of operation can be changed by a switch, simply by alternatively turning the AC and DC power sources on and off.

When the option of both direct and alternating current is desired, (e.g. in a submarine that might be powered with alternating current when surfaced and battery powered while submerged), the switching from one to the other may readily be automated, (e.g. by appropriately connected rectifiers, plus bypassing cables), that can be switched by means of relays. These relays would be connected to coils that surround the power cable to be activated by the induced currents when, and as long as, it carries alternating current.

(b) Individual Bipolar Machines Replacing Two Machines in Tandem

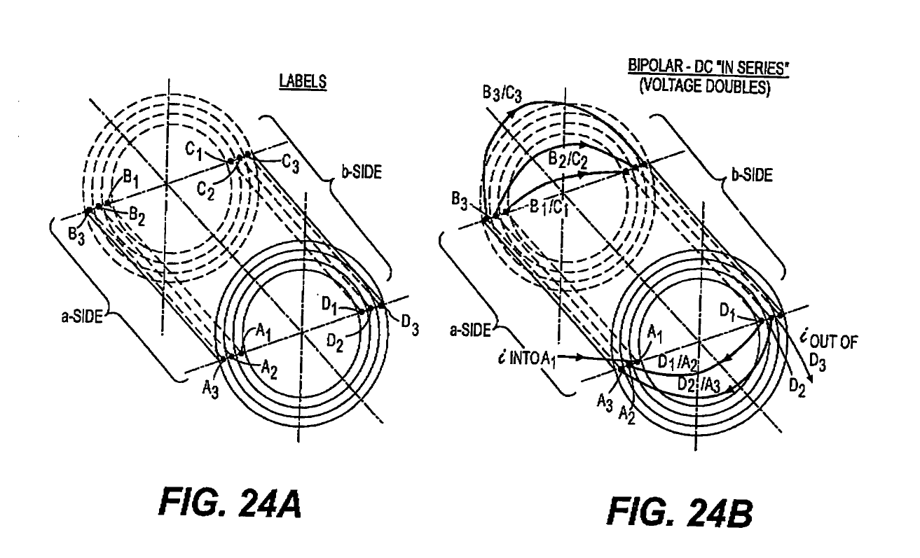

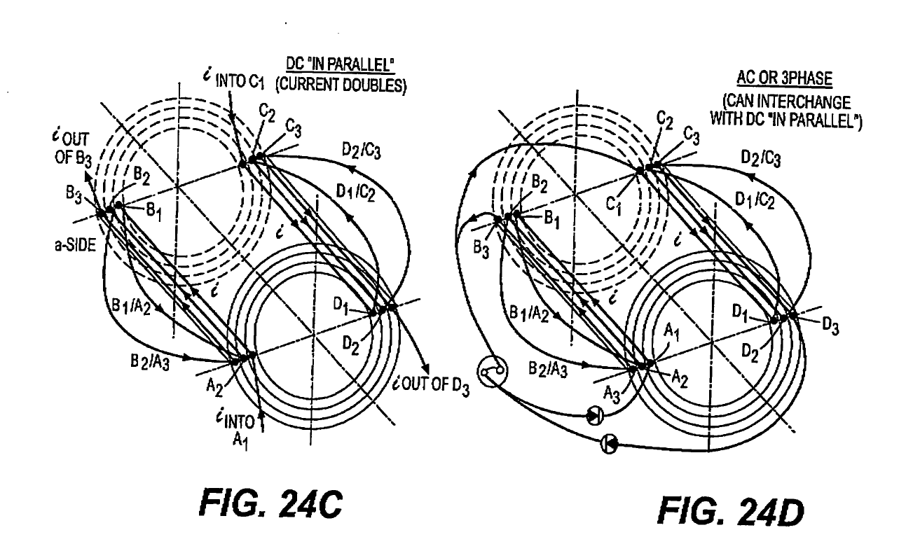

According to the present invention, bipolar motors with cylindrical rotors with current channel insulation that extends from end to end and that are fitted with brushes on both ends, can be operated in the same manner as in tandem machines and thus can be similarly used with DC, AC or 3-phase current. This is clarified in FIG. 24 by the example of a machine with three rotors, each of which has been provided with current channel insulation along the whole length. For clarity, not shown in FIG. 24 is magnet 4 that is enclosed in the rotors in the manner of bipolar machines, e.g. as illustrated FIGS. 15, 17 and 25. Specifically, in FIG. 24A the entry brush(es) on rotor 1 on the a-side (i.e. in the (a)-zone, facing the North pole of the magnet(s)) is labeled A₁ and is indicated by a dot. Similarly the brushes on rotors 2 and 3 are indicated by dots labeled A₂ and A₃. The terminology for brush(es) is used where applicable because in medium sized to large machines, the (a) and (b)zones may be extended and each may require several if not many brushes.

Via their respective rotors, brushes A₁, A₂ and A₃ are electrically connected to the brushes on the opposite end, here called B₁, B₂ and B₃ and similarly indicated by black dots. The corresponding brushes on the b-side (i.e. the (b)-zone, facing the South pole of the magnet(s)) are labeled D₁, D₂ and D₃ and C₁, C₂ and C₃. All of these brushes slide on slip rings of their respective rotors (i.e. an Al brush would slide on slip ring 34(1) on rim 3(1) of rotor 2(1) and be labeled 27(1,a), in the same manner already disclosed above for all brushes in the present invention. Similarly, brush C₂ would slip on a slip ring at the return end of rotor 2 and be labeled 27(2,b,r).

On account of the current channel insulation between them, in the arrangement of FIG. 24 and similarly for machines with an arbitrary number of rotors, the brushes on the a-side are electrically isolated from the brushes on the b-side. Therefore, the two sides can function like two independent conventional homopolar motors in tandem, either connected in parallel or in series when powered by DC, or they may be operated with AC. Most simply, such a machine with current channel insulation along the whole length of the rotors functions like a bipolar machine if brushes interconnected by cables replace the bottom strip free of current channel insulation, label 84, as illustrated in FIG. 24B.

Electrically and mechanically the arrangement of FIG. 24B is the equivalent a bipolar machine without rim 84 or also of two homopolar machines in tandem and connected in series. Specifically, in the example of FIG. 24B, the current may enter at brush(es) A₁, from there flow to brush(es) B₁, along rotor 1 guided by the current channel insulation, and flow to brush(es) C₁ via a cable that in FIG. 24B is indicated by a curved line labeled B₁/C₁, whence the current flows to brush(as) D₁, axially along rotor 1 in the current channel, again guided by the current channel insulation. From there, cable D₁/A₂ leads the current to brush(es) A₂ to begin a new cycle, i.e. the current flows from brush(es) A₂ parallel to the current channel insulation along rotor 2 to brush(es) B₂, and via cable B₂/C₂ axially along rotor 2 to brush(es) D₂ and on, in general for an arbitrary number of cycles.

Electrically and mechanically, machines with current channel insulation extending over the length of the rotors are symmetrical with respect to their mid-plane at right angles to the rotation axis. Therefore, the current need not enter an A₁ brush, but could enter a B₁ brush, and similarly it could enter the b-side from D₁ instead of C₁, as in the present example of FIG. 24. In fact, physically the naming of the two rotor ends is arbitrary.

As already indicated, in the present choice of labeling, cables B₁/C₁, and in general Bₙ/Cₙ, replace the bottom strips of the rotors that are free of current channel insulation 84, whereas cables DₙAₙ₊₁ take the role of bridges 64, and may have the same physical shape. The curved lines in FIG. 24 indicate electrical connections between brushes. Connections Dₙ/Aₙ₊₁, together with the brushes to which they are connected, will preferably be made into brush plates 68, and similarly Bₙ/Aₙ. Connections Bₙ/Aₙ₊₁ and Dₙ/Cₙ₋₁ in FIGS. 24C and D (to be discussed presently), as shown, physically span the length of the rotors and therefore, unlike connections Dₙ/Aₙ₊₁ and Bₙ/Aₙ, cannot be accommodated in linear extensions of the rotors.

Since the complication of the Bₙ and Cₙ brushes in FIG. 24B can be avoided by simply substituting a bottom strip free of current channel insulation 84, the configuration in FIG. 24B will be for rare applications. However, configurations 24C and 24D are physically the same and represent the “in series” tandem configuration of FIG. 12, as follows (from here on using abbreviated wording in lieu of the entirely equivalent more elaborate wording that was used for FIG. 24B).

In terms of a motor, driven by an applied voltage, possibly, between A₁ and B₃, or more generally between A₁ and B_{N}, the current enters at A₁ on the a-side and flows through rotor 2(1) to B₁. From there, via electrical connection B₁/A_{2,} the current will flow to A₂ to repeat the cycle through rotor 2(2) and so on until it exits at B₃ in the example of FIG. 24C, or at B_{N} in the general case. Similarly, driven by a voltage applied between C₁ and D₃, and in the general case between C₁ and D_{N}, the current will flow from C₁ successively through rotors 2(1) to 2(3) until it exits at D₃, or will flow successively through rotors 2(1) to 2(N) to D_{N}, in general. Similarly, for the case of a generator, the input of mechanical work through rotation of rotors 2(1) to 2(N) in clockwise direction, a voltage is induced between brushes A₁ and B(N) and will drive the current in the same manner. FIG. 24C indicates that current path by means of bold lines with arrows in the expected current direction.

As discussed, FIG. 24C illustrates the application of DC power to a motor with current channels extending through the whole length of the indicated cylindrical rotors, and shows the resulting currents if used as a generator. FIG. 24D illustrates the same machine as in FIG. 24C but with application of AC power, whether conventional, 3-phase, or any number of phases, and of any arbitrary frequencies, regular or irregular, that may be suitable for a motor (i.e. not radio frequencies). Exactly the same current flow directions will result as in FIG. 24C when one side, in the case of 24D the a-side, is powered by the positive current, gained by means of a rectifier as indicated, and the other side is powered by the negative current component, similarly gained by means of a rectifier. Thus the two arrangements in FIGS. 24C and 24D are exactly the same except for the source of power and therefore may be switched at will between the two types of power, in the same manner as already explained for in tandem motors as in FIG. 12. The disadvantage of the arrangement of FIGS. 24C and D is the need for the connections Bₙ/Aₙ₊₁ and Dₙ/Cₙ₊₁. According to the present invention these can be consolidated into appropriately shaped and mounted bridges 64 between brush plates on the two ends, which bridges extend alongside the flux return 80.

(c) Machine Power Control via Bipolar Machines

According to the present invention, the idea of machines in tandem is extended to any two or more machines, not necessarily alike and not necessarily powered by the same source. Thus the use of rectifiers to power homopolar machines in tandem with DC or alternating or three-phase current outlined above, can be extended to more than two machines by appropriate connections to the individual machines. Further, a single bipolar machine with cylindrical rotors that are supplied with current channel insulation over the whole length of the rotors can be used in the same independent manner if driven by DC power. This gives additional flexibility that may be very useful in machine operation and control. For example, the a-part could provide the machine power used in the ordinary running condition, e.g. cruising for a ship, and the b-part could be used to rapidly increase machine power if needed.

Similarly, in the case of bipolar generators, the a-side may be used in standard power generation, e.g. from wind or tides, while the b-side may kick in for extra demand or supply (e.g. high winds). One advantage herein would be extended brush life, especially useful if the role of the two sides should be periodically switched.

E. Cooling of Homopolar/Bipolar Machines

In many cases, e.g. in electric or hybrid cars, bipolar as other homopolar motors could be cooled in any appropriate manner known to those skilled in the applicable art; for example, as with a gasoline engines that they may replace, they could be cooled by fan-assisted air flow. Such air cooling could be even more effective and might not need to be assisted by fans in especially favorable positions, e.g. if mounted within an air stream, on car axles, for example. For other applications, bipolar and other homopolar motors could be cooled by means of a suitable circulating protective gas (traditionally moist CO₂, see ref.12). Even more effective would be cooling by direct immersion in water. A preliminary casual test by W. M. Elger and N. Sondergaard at the David Taylor Annapolis Naval Ship Laboratory (circa 1999) suggests that such direct immersion in water is easily possible with homopolar/bipolar machines as these would continue operating smoothly even when entirely flooded with water. The reason for this option is the fact that homopolar machines employ large currents flowing in current paths of as low electrical resistance as possible under relatively low potential differences among neighboring elements. Thus, any currents that might leak through the ambient water would face a very much higher electrical resistivity than in the deliberate current path, so current leakage would be negligible. Those skilled in the art will be able to adapt the structure to the media of its cooling (e.g., an aerodynamic structure adapted for air stream flow).

Where open water is easily available, such flooding would provide efficient cooling at low expense, as for podded ship drive motors or for energy extraction from tides or waves by means of homopolar/bipolar generators, especially if the pods and/or other structural supports were provided with perforations for water circulation. Specifically for water cooling by immersion in water, e.g. in a pod attached to a ship, the motor endplates 70(1) and 70(2) of single machines or endplates 70(1) to 70(3) for tandem machines, may be perforated or in the form of gratings to permit the freest possible water flow. For similar flooding of machines with circulating cooling water in vehicles of any type, including ships, the machines would be provided with enclosures that do not significantly leak. However, a modest amount of leakage though seals could be easily tolerated if minor, or if the leaked water is naturally dissipated, and/or if measures are taken to collect the leaked water and to replenish the water volume in the machine as needed.

In general it is expected that homopolar/bipolar machines submerged in a liquid will operate essentially undiminished provided that the liquid will not interfere with the proper functioning of the electric brushes and has an electrical conductivity that is at least four orders of magnitude lower than that of the rotors. Correspondingly, for cooling by direct immersion into water, it is not necessary that the water is purified. In fact, even ocean water would presumably be acceptable, and in fact the leak currents would have the benefit of killing marine organisms, presumably on account of the small amount of chlorine that would be generated, so as to inhibit fouling by microscopic organisms and barnacles.

A particular advantage of flooding with water is an anticipated decrease of brush wear rates. Preliminary observation is that specifically copper brushes running on copper while submerged in water resist tarnishing and have lowered wear rates. Theory would support this expectation since in successful fiber brush operation actual sliding, on the microscopic level, also in gases, occurs between two monolayers of waters adsorbed on the two sides and not directly between metals or metals and adsorbed water [12]. Wear debris formation occurs where the opposite sides sterically interlock and a wear particle is formed through shear. In water, layer thickness between the opposing sides may theoretically be increased three or four times, which is expected to reduce wear and greatly lower friction, albeit at increased film resistivity. On account of reduced friction coefficient, the total losses due to brushes immersed in water and similarly other suitable liquids, may therefore be reduced to or below the total brush loss in air or a protective atmosphere, by significantly increasing the brush pressure, even while wear is also reduced.

F. Favored Applications for Bipolar Machines According to the Present Invention

a) Generators in Conventional Applications

The described bipolar machines will work equally efficiently as motors or DC generators. A feature when employed as a conventional generator is their adaptibility to a wide range of power levels, depending on rotation speed. Electrically and acoustically quiet operation and typically high efficiency are additional features of bipolar generators. Bipolar generators according to the present invention would be particularly useful for large sizes, including power generation in private, commercial, or public power stations, such as those at Hoover Dam.

(b) Bipolar Generators for Renewable Energy, e.g. Tidal and Wind Power

These bipolar generators have the ability for generating high voltages even at low rotation speeds. Bipolar generators can extract power even from low-density power sources, as similarly bipolar motors can run on a wide range of mechanical power. Consequently bipolar generators are well suited for current generation from wind, tidal and/or other intermittent power sources with wide variations of power density.

(c) Bipolar Motors

Features of bipolar motors according to the present invention, especially those with cylindrical rotors, include:
generally high efficiency
mechanical as well as electrical silence
high power to weight density
simple construction
expected low cost in mass production
adaptability to a wide range of rotation speeds, voltages and currents
potential for use with DC as well as AC in a wide range of frequencies including 3-phase or other multi-phase currents
slender shape as an aid in cooling
potential for immersion in water and other suitable fluids for cooling.

Relative to conventional electro motors with graphitic brushes, on account of the multi-contact metal brushes in bipolar machines, the following advantages may be added to the above list:
improved reliability
longer service life
less maintenance
freedom from obnoxious wear debris.

Correspondingly, bipolar motors with cylindrical rotors according to the present invention have the potential of gradually displacing conventional internal combustion engines and electro motors in a wide range of applications, from the very large to the small. To name just a few examples: On the low end of the size scale, conventional battery-driven electro motors, e.g. in hand-held tools, have an efficiency of only about 65% or less, mainly due to the inefficiency of their graphitic brushes. Bipolar motors with cylindrical rotors of comparable volume and weight can potentially increase the efficiency to 90% and better. In the range of modestly higher power levels, motors of electric wheel chairs suffer erratic unpredictable failures caused by malfunctioning or rapidly worn out graphitic brushes. Next, in many transport applications, the slender shape of bipolar machines with cylindrical rotors can aid in cooling and offers opportunities for novel placement, e.g. the already mentioned placement on car axles. Similarly bipolar motors and/or generators may be distributed to various locations in larger vehicles, e.g. military tanks. At still higher power, bipolar machines would be suitable for rail transportation, e.g. trams and electric trains.

Perhaps one of the more attractive applications of bipolar motors with cylindrical rotors according to the present invention are ship drives at a wide range of power levels from, 10 hp to 10⁵ hp, whether naval, commercial, or recreational shipping. Specifically these motors are eminently adaptable as ship drives when given a streamlined, elongated shape, whether inboard or podded, from life boats to cruise liners or aircraft carriers. In commercial shipping, such ship drives would be adaptable for large tankers, small freighters, and pleasure boats of all sizes—outboard or inboard. Bipolar motors may also be useful for water pumps of all sizes and other marine applications.

G. General Equations and Symbols Used for Bipolar Motor with Cylindrical Rotors

(a) Symbols Used

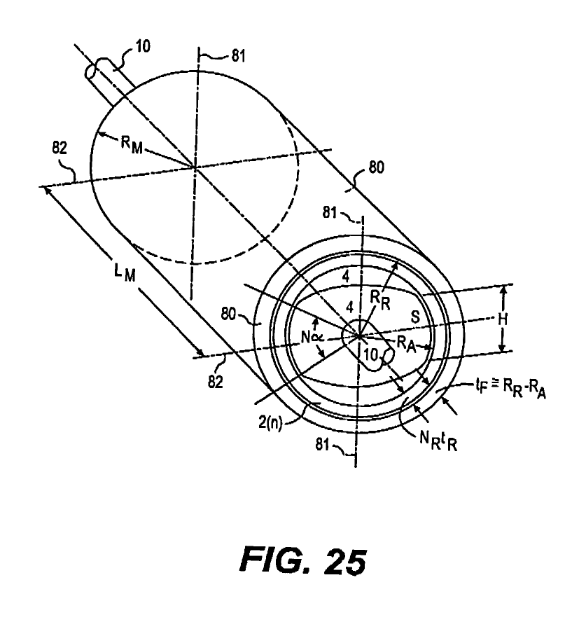

Symbols shall be the same as before and as shown in FIG. 25, plus a number of additional symbols as follows:
A_{S}=N_{R} i/j_{S}=active slip ring area (eq.38)
B=magnetic flux density (normal to rotors)
d=mechanical density (assumed to be d=7.5×10³[kg m³], as average between Cu with d=8×10³[kg/m³] and iron/steel with d=7.1×10³[kg/m³])
d_{W}=thickness of brush plate
D_{M}=outer machine diameter≅2R_{F}=3R_{R}
f_{B}=slip ring surface covered by brush foot print (safe limit for moisture access f=50%)
F=approximate machine volume in units of R_{R}³
H=Height of magnet≅R_{R}
i=machine current
j_{B}=2×10⁶ Amp/m² (estimated upper safe limit of current density in brushes in humid gases)
jₛ=f_{B} j_{B}=10⁶ Amp/m² (estimated upper safe current density on slip rings in humid gases)
L=V_{Ω}V_{M}=loss through internal machine resistance
L_{b}=width of the bottom strip (code 84)
δL_{B}=permissible brush wear length
L_{BS}=length of brush foot print in sliding direction
L_{E}=thickness of endplate (code 70, assumed to be ⅔ R_{R})
Lⱼ=R_{R}=active circumferential slip ring length
L_{M}=length of machine
L_{R}=length of cylindrical rotor equal to the length of the magnet
Lj=R_{R}=active slip ring length in tangential direction
L_{S}=N_{R}Δ=active slip ring length in tangential direction
m_{corr}=machine mass if the flux density in the flux return is 1.8 tesla
m_{F}=mass of flux return
m_{M}=machine mass (if B=1 tesla is assumed throughout)
M_{M}=W_{M}/ω=machine torque
N_{R}=number of rotors
N_{R} t_{R}=cumulative thickness of the set of cylindrical rotors (assumed to be R_{R}/3).
R_{A}=inner rotor radius
R_{F}=outer radius of flux return=R_{R}+H/2=1.5R_{R}
R_{P}=radius of axle
R_{R}=outer rotor radius
₁Rᵢₙₜ=internal resistance per rotor
Rᵢₙₜ=N_{R 1}Rᵢₙₜ.=internal ohmic machine resistance excluding brushes and brush holders
R_{Bridge}=ohmic resistance of “bridge” between brushes on adjoining rotors
t₆₁=length of the mechanical mechanism 61 fastening the rotors or endplate to the axle
t_{F}=wall thickness of flux return (assumed to be ≅H/2 in bipolar machines)
t_{R}=wall thickness of individual rotor (assumed to be R_{R}/3N_{R}, eq.30
T_{B}=estimated average brush wear life or life expectance of brush plates
v_{R}=average rotor surface speed
V_{M}=N_{R 1}V_{R}=machine voltage
₁V_{R}=induced voltage per rotor
V_{B}.=voltage loss per brush
V_{Ω}=potential difference on account of internal machine resistance
W_{M}=i V_{R}=i N_{R 1}V_{R}=machine power
α=angle subtended by magnet on the cylindrical rotors in bipolar machines (≅60° assumed)
β=R_{R}/L_{b}
δm_{M}=machine weight reduction for B=1.8 tesla in flux return (eq.45d)
δ_{W}=d_{W}/R_{R}=relative thickness of brush plate
γₑₗ=elastic shear strain in machine on account of torque M
δL_{B}=permissible brush wear length (in numerical examples assumed to be 2 cm)
Δ=width of slip ring
Δₘᵢₙ 0.25 cm=minimum slip ring width
λ=L_{R}/R_{R}
ρ=electrical resistivity of rotor material (1.65×10⁻⁸Ωm for copper

(b) Relations Among Parameters

In the following, numerical estimates are made regarding the major characteristics of bipolar machines of different sizes. These are based on simplifications, e.g. loss of efficiency on account of intermediate insulating layers or embedment material has been neglected as also the fact that in a set of rotors the rotor diameters are graded. Also, the characteristics of the magnets and flux return are not well known. Correspondingly, the values presented below are guidelines without high quantitative accuracy.

To begin with, a reasonable estimate of the optimum gap width between the magnetic poles and the flux return, within which the rotors of total thickness N_{R} t_{R} slide, is about H=R_{R}/3. Too wide gaps will have low values of B on account of depolarization, and too narrow gaps do not permit an adequate number and wall thickness of rotors. Further, at same flux density in the magnet and flux return, the wall thickness of the flux return must be t_{F}=H/2 and a suitable value for the angle α that the magnet subtends on cylindrical rotors is α≅60°, so that
H=2R_{R} sin(α/2)≅R_{R}=2t_{F} (28)

Consequently the motor diameter is, approximately and neglecting the narrow gaps between the rotor and the magnet on one side and the flux return on the other,
D_{M}=2R_{F}=2(R_{R}+t_{F})=2R_{R}+H=3R_{R} (29)

Next, the gap width of R_{R}/3 must accommodate the cumulative thickness of N_{R} rotor cylinder walls of thickness t_{R} each, i.e.
t_{R}≅R_{R}/(3 N_{R}) (30)

With α=60°, the two brush plates, if any, do not require flexible joints, as discussed in connection with FIG. 11. This is a considerable advantage of bipolar machines because (i) only one linear bearing or other device would be needed on each side to keep the brushes in their intended relative position and orientation and to advance them in course of wear, (ii) because brush loading could be simply effected by two springs between the (a)- and (b)-side brush holders, such as 37 in FIG. 12. According to the present invention, and assuming the expected development of mass-produced brush plates and their attached brush strips, the large number of required brushes that used to be an important drawback of homopolar motors, will therefore be of no concern in regard to bipolar motors with cylindrical or cup-shaped rotors. Since also the methods of rotor winding and slip ring production discussed in preceding sections are amenable to mass production techniques, the choice of N_{R} in bipolar machines is unlikely to greatly affect the cost and performance of bipolar machines with cup-shaped or cylindrical rotors. The voltage can accordingly be adapted to other needs, with no particular concern about large N_{R} values, provided only that both slip ring widths and rotor wall thickness remain above some practical minimum, at present believed to be about Δ≅0.25 cm and t_{R}≅0.2 mm. And also L_{b}/R_{R}=½ is at this point assumed to be a good choice. Further, two brushes and brush holders each contribute about 0.4V per rotor, provided the bridges are made with an adequately large cross sectional diameter.

(c) Internal Ohmic Machine Resistance, Loss and Machine Efficiency

With the above relationships, i.e. H=R_{R} and t_{R}=R_{R}/(3 N_{R}), disregarding for the moment brushes and brush holders, one finds for the internal resistance per rotor, naming R_{R}/L_{b}=β and L_{R}/R_{R}=λ,
₁Rᵢₙₜ=ρ[2L_{R}/Ht_{R}+πR_{R}/2L_{b}t_{R}]=(ρN_{R}/R_{R})[6λ+3πβ/2]=Rᵢₙₜ/N_{R} (31)
Next, the motor loss is
L=V_{Ω}/V_{M}=i² Rᵢₙₜ/W_{M}=W_{M} Rᵢₙₜ/V_{M}² (32)
i.e. with V_{M}=N_{R 1}V_{R}
W_{M}=V_{M}² L/Rᵢₙₜ=V_{R}² R_{R} L/[ρ(6λ+3πβ/2)] (33)
Further, by the use of eq. 4, i.e. ₁V_{R}=2v_{R} BL_{R}=2v_{R} BλR_{R},
W_{M}=4 v_{R}²R_{R}³ B² λ²L/[ρ(6λ+3πβ/2)] (34a)
or if λ>>β,
W_{M}≅⅔ v_{R}²R_{R}³ B² λL/ρ (34b)

Hence in a first approximation the machine power is independent of N_{R}, but proportional to L, the cube of the rotor radius, R_{R}, and the square of both velocity V_{R} and magnetic flux B.

Comparison with the corresponding eqs. 23 to 27 for bipolar motors with cup-shaped rotors will reveal a benefit of the arrangement with cylindrical rotors over circular rotors in terms of achievable power density. Correspondingly it is expected that future bipolar machines may by and large be of the cylinder design, on account of its higher power density, lower demands on cooling, and greater ease of construction. Even so, when space requirements greatly favor a squat design, bipolar machines with circular rotors are an option, and in any event they are superior to previous homopolar motors.

Eq.34 is an overestimate since, firstly, 2V_{B}≅0.4V must be subtracted from the machine voltage on account of brushes and brush holders. However, this is a minor effect since with very roughly B=1 tesla and even very modest values of L_{R}, e.g. 1 m, and v_{R}, e.g. 5 m/sec, yield ₁V_{R}=10V. Secondly, the resistance of the bridges has been neglected. If they are part of brush plates of thickness d_{W}, their resistance per rotor is
R_{Bridge}≅ρπR_{R}/t_{R}d_{W}≅10ρN_{R}/d_{W} (35)

It also follows that, unlike the case of the bipolar machine with cup-shaped rotors, the brush and brush holder resistance is typically minor, provided that the brush plate thickness, d_{W}, is made, say, of thickness R_{R}/4 or larger. Anyway, the estimated machine efficiency is, including an estimated 2% loss through drag of ambient medium and bearings,
E_{M}≅100%(1−2%−L−0.4[V]/₁V_{R}) (36)

(d) Considerations Regarding Brushes, Brush Holders and Slip Rings

As already discussed above, the area coverage of brush foot print on slip rings, f_{B}, should not exceed 50%, and a safe estimated upper limit for the current density in the brushes is j_{B}=2×10⁶ [A/m²], so that
j_{S}=f_{B} j_{B}=10⁶ [A/m²] (37)
is a good value for the average current density on slip rings in both zones Moreover, in bipolar machines with cylindrical rotors, brushes can be usefully applied only in zones (a) and (b), i.e. over circumferential lengths of
Lⱼ≅H=R_{R} (38)
on each side. For a current i therefore, a slip ring area of
A_{S}=N_{R} i/j_{S} (39)
is required on each side, (a) and (b). For a given slip ring area, this results in the individual slip ring width
Δ=A_{S}/N_{R}Lⱼ=(i/j_{S}Lⱼ) (40)
and a total axial length of slip rings and hence brush plate length (neglecting separators 49 or slip ring extensions 33)
L_{S}=N_{R}Δ=N_{R} i/j_{S} Lⱼ (41)

The expected brush wear life, T_{B}, is proportional to the permissible wear length of the brushes, δL_{B} and inversely proportional to the sliding velocity (mostly assumed to be v_{R}) and the dimensionless wear rate that is conservatively estimated at 5×10⁻¹¹, i.e.
T_{B}=δL_{B}/(v_{R} 5×10⁻¹¹ [seconds]) (42)

Further in regard to brushes and slip ring dimensions, the spacing of the current channels should preferably be smaller than the length of the brush sections in the brush holder strips, L_{BS}, to improve current channeling and so that the current is not significantly interrupted as brushes slide from one current channel to the next, which could give rise to arcing. Since current channel insulation may add to the machine cost and cause some extra brush wear, there is some motivation to minimize their number while still meeting the design requirements for that machine. Several current channels per active slip ring length will minimize current ripple and improve the current channeling effect. Thus, preferably the current channel width will be no larger than one half the width of the brush. Also, as already indicated, in a humid atmosphere, the continuous footprint of any brush in sliding direction should not exceed L_{BS}=5 cm=2″ in order not to inhibit moisture access. However, this number is subject to adjustment as experience with fiber brushes increases, and it is expected to be unlimited in liquid water.

At any rate, pending gradually accumulating information, eddy current barrier spacings between 0.2 and 1 cm would seem to be a good choice for machines with R_{R}>20 cm, e.g., and preferably the spacing should be mildly irregular, again to reduce current ripple. But in any event, the current channel insulation layers will preferably be spaced closely enough to suppress eddy current loss to below, say, ½%. With brushes in the form of L_{BS}=5 cm long brush strip segments, the number of brushes on N_{R} slip rings (with two brushes per slip ring, sides (a) and (b)) each of length L_{S}=R_{R}, then is
N_{B}=2N_{R}(R_{R}/L_{BS}) (43)

(e) Machine Weight or Mass

Naming the thickness of the motor endplates L_{E}, the machine length is
L_{M}=L_{R}+2L_{E}+L_{b}+L_{S}≅(λ+4/3+1/β)R_{R}+L_{S} (44)
where L_{E} is assumed to be ⅔ R_{E} which is an intuitively plausible number that is used pending engineering determinations of the size and construction of the endplates. Thus the machine mass is approximately
m_{M}≅πd{(L_{R}+2L_{E}+L_{b})[(D_{M}/2)²−R_{P}²)+L_{S}(R_{R}²−R_{P}²)]=FπdR_{R}³ (45a)
with
F=[(λ+4/3+1/β))[(1.5)²−(R_{P}/R_{R})²]+(Lₛ/R_{R})[(1−(R_{P}/R_{R})²] (45b)

However, this is an overestimate if the magnetic flux density in the flux return should not be B=1 tesla but, say, 1.8 tesla as seems to be achievable, while in the gap B might remain at 1 tesla. In that case the flux return wall thickness and hence its weight, i.e.
m_{F}=d πL_{R}(1.5² R_{R}²−R_{R}²)=3.93dλR_{R}³ (45c)
is reduced to by the factor 1.8 to
m_{Fcorr}=m_{F}/1.8 (45d)
for a machine weight savings of
δm_{M}=0.44m_{F} (45e)

A much larger weight savings can be achieved by an increase of B to 1.8 tesla also in the gap (i.e. its value in the rotors), since thereby the induced voltage would at a same magnet and rotor length be similarly increased by the factor 1.8 in accordance with eq.4. Correspondingly, for the same machine power the active rotor and magnet length could be reduced by the factor of 1.8 and, except for slip rings, brushes, end-plates, and mechanical structure the machine mass would be reduced by factor 1.8, i.e. down to minimally
mₘᵢₙ=m_{F}/1.8 (45f)

Alternatively, the rotor radius could be reduced, or a designer could pursue a combination of these options, and similarly for any other deviation of B from the generally assumed value of 1 tesla.

Finally, if the magnetization and geometry of magnet and flux return shall remain unchanged, according to the present invention the magnets and/or flux return may be made of a permanent magnetic material of perhaps smaller density than iron and iron alloys. This could result in a substantial weight reduction of the machines. For the time being, the average density, d, of the machine's materials, is tentatively assumed to be 7.5 [tonnes/m³] as the average between the densities of steel and copper. At the same dimensions, if the rotors and brush plates were made of aluminum the loss would be modestly higher and the weight lower.

Note also that with the assumed relatively large radius of the axle, i.e. R_{P}=⅔ R_{R}, the magnets (that constitute the magnetic field source and that, in all but small machines, should preferably be composed of several or many magnets contained in tubes or trays as in FIG. 17C) may have to bow out about the axle more strongly than shown in FIG. 25.

(f) Mechanical Stresses and Mechanical Stability of Machines

An important consideration are the shear stress, τ, in the rotors and in the connection (61) between the rotors and the axle that arises from the torque, M_{M}, generated by the motor. Specifically, considering a single rotor, at the junction between the single rotor and the axle of radius R_{P} it is
₁M_{M}=τ2πR_{P}R_{R} t_{R}=τ 2π R_{P}R_{R}²/3N_{R} (46
But
₁M_{M}=(W_{M}/N_{R})ω=(W_{M} R_{R}/N_{R}v_{R}) (47
so that
τ=₁M_{M} 3N_{R}/2πR_{P}R_{R}²=3W_{M}/(2π R_{P}R_{R}v_{R}) (48a)

We find the resultant elastic shear strain, γₑₗ, by comparing τ with the shear modulus, G, which for copper is G=8×10¹⁰ N/m² and for aluminum G=2.7×10¹⁰ N/m². Thus. with R_{P}=⅔R_{R} as probably a fairly typical value,
γₑₗ=3W_{M}/(2π R_{P}R_{R}v_{R}G)≅0.71 W_{M}/(R_{R}²v_{R}G) (48b)

Adapting the above calculation to the shear stress exerted on the fastening 61 between back plate and axle, as in FIG. 21A, one finds the stress in the joint between the axle and the mechanical fastening device 61, of width t₆₁, as
τ_{E}=W_{M}/2πR_{P}t₆₁v_{R}=γ₆₁G (49)

A safe value of γ₆₁=2×10⁻⁴ may be achieved, for example, by the use of a hard solder joint. With a shear modulus of, say, G₄₁=10¹⁰ N/m², one would thus require
t₆₁≧W_{M}/(2πR_{P}v_{R}γ₆₁G) (50a)
i.e.
t₆₁≧3.7×10⁷ [watt]/(2π×0.4×6.3×2×10⁻⁴×10¹⁰ [N/sec]=1.2[m]=2R_{R} (50b)

The above relationships will be considered for various motors, beginning with large podded ship drives, generally assuming B=1 tesla in the gap.

H. Numerical Examples

(a) Large Motors Suitable for Ship Drives

(1A) Large Ship Drive, 50,000 hp, 100 RPM, 9000V, L_{M}=9 m, E=96.6%, 0.4 mAxle

Selected Parameters
W_{M}=50,000 hp=3.7×10⁷ watt
V_{M}=9000 Volt
i=4100 Ampere
R_{P}=⅔R_{R}=0.4 m (axle bore radius through magnet for propeller shaft)
R_{R}=0.6 m=2 ft
H=R_{R}=0.6 m (i.e. α=60°)
D_{M}=3R_{R}=1.8 m=6 ft (eq.29)
L_{b}=R_{R}/2=0.3 m=1 ft (i.e. β=2) (width of bottom strip free of current channel insulation)
L_{E}=⅔ R_{R}=0.4 m (width of endplates)
Lⱼ=R_{R}=0.6 m=2 ft=active slip ring length on each side
L_{R}=12R_{R}=7.2 m=24 ft (i.e. λ=12)
ω=100 RPM=1.67 rev/sec=10.5 [rad/sec]
v_{R}=ωR_{R}=6.3 m/sec=21 ft/sec
L=1% (selected for computing W_{M} in accordance with eq.33)
N_{R}=100
B=1 tesla
ρ=1.65×10⁻⁸ωm (for copper)
L_{BS}=0.05 m=2″ (length of single brush segment in sliding direction)
δL_{B}=2 cm (permissible brush wear length)
G=8×10¹⁰ N/m² (for copper)

Derived Parameters
t_{R}=R_{R}/3N_{R}=0.2 cm=0.079″ (rotor wall thickness) (eq.30)
₁V_{R}=2v_{R}BL_{R}=90 [V] (eq.4 with n=2)
V_{M}=N_{R 1}V_{R}=9000 [V]
Rᵢₙₜ=N_{R 1}Rᵢₙₜ=(ρN_{R}²/R_{R})[6λ+3πβ/2]≈0.023 (eq.31)
W_{M}≅⅔ v_{R}²R_{R}³B² λL/ρ=3.7×10⁷ [watt]≅50.000 (eq.33)
E_{M}≅100%(1−2%−L−0.4[V]/₁V_{R})=96.6% (eq.36)
M_{M}=W_{M}/ω=W_{M}R_{R}/v_{R}=3.5×10⁶[Nm]=2.6×10⁶[lb ft]
d_{w}=R_{R}/4=R.sub.R/4=0.15 m
Lⱼ=R_{R}=0.6 m=2 ft (active slip ring length each in zone (a) and in zone (b)) (eq.38)
A_{S}=N_{R} i/10⁶[A/m²]=0.41 m²=4.6 ft² (active slip ring area) (eq.39)
Δ=A_{S}/N_{R}Lⱼ=0.68 cm=0.27″ (width of individual slip ring) (eq.40)
L_{S}=N_{R}Δ=0.68[m]=2.3 ft (total axial extent of slip ring surfaces) (eq.41)
L_{M}=L_{R}+2L_{E}+L_{b}+L_{S}=(7.2+0.8+0.3+0.68)[m]=9 m=30 ft (eq.44)
T_{B}=δL_{B}/(v_{R}×5×10⁻¹¹)=6.4×10⁷ seconds=2 years (eq. 42)
N_{B}=2N_{R}(R_{R}/L_{BS})=2400 (eq.43)
F=[(λ+4/3+1/β))[(1.5)²−(R_{P}/R_{R})²]+(Lₛ/R_{R})[(1−(R_{P}/R_{R})²]=25.6 (eq.45b)
m_{M}=FπdR_{R}³=130 tonnes (eq. 45a)
m_{F}=3.93dλR_{R}³=76 tonnes (eq45c)
δm_{M}=0.44 m_{F}=33.5 tonnes (eq. 45e)
m_{corr}=m_{M}−δm_{M}=97 tonnes
mₘᵢₙ=m_{M}/1.8=72 tonnes (eq. 45f)

$$\begin{matrix}{γ}_{el} = τ / G \\ = 3 {W}_{M} / ( 2 π {R}_{P} {R}_{R} {v}_{R} G ) \\ = 3 \times 3.7 \times {10}^{7} / [ 2 π \times 0.4 \times 0.6 \times 6.3 \times 8 \times {10}^{10} ] \\ = 0.015 \%\end{matrix} \qquad ( eq . 48 )$$

Comments

The large number of brushes, N_{B}=2400, would be of concern if brushes were to be fitted into individual holders and placed on slip rings individually. In fact with individual holders the required Δ=A_{S}/N_{R}L_{S}=0.68 cm slip ring width would probably be unattainable. Consequently, with the use of individual brush holders, N_{R} would have to be considerably decreased. However, according to the present invention, all brushes on the (a)-side, and similarly all brushes on the (b)-side, will be mounted on, and be applied through, just one or perhaps up to three brush plates on each side, which as far as the user is concerned are installed and, when worn out, replaced in a single operation. In the method of the present invention, therefore, the number of brushes on the brush plate is of only academic interest. The wall thickness, d_{W}, of the brush plate of d_{W}=R_{R}/4=15 cm is adjusted to present only a fraction of the internal resistance.

Of concern is the value of γₑₗ=0.014% as it is just about the fatigue strength limit of pure copper, whereas for aluminum with G=2.7×10¹⁰ N/m², it would be γ=0.04% and probably no longer safe. Hence the above particular example of a bipolar machine with cylindrical rotors according to the present invention is feasible also mechanically, but not by a large margin. Correspondingly, the rotors should preferably be made of some low-concentration Cu alloy, such as used for commutators, in order to boost their fatigue strength.

With the present values, the shear strain in the endplates where they join the axle would be δel=0.0073 and thus safe. The endplates could be substantially perforated, as was envisaged for the case of direct cooling in water. A conventional connection may be made to attach the endplates and the rotors to the axle (1B) as 1A but Shortened to L_{M}=5.6 m.

Selected Parameters
W_{M}=50,000 hp=3.7×10⁷ watt
V_{M}=9000 Volt
i=4100 Ampere
R_{P}=⅔ R_{R}=0.4 m (radius of axle/bore through magnet for propeller shaft)
R_{R}=0.6 m=2 ft
H=R_{R}=0.6 m=6 ft (α=60°)
D_{M}=3R_{R}=1.8 m=6 ft (eq.29)
L_{b}=R_{R}/2=0.3 m=1 ft (i.e. β=2)(width of bottom strip free of current channel insulation)
L_{E}=⅔ R_{R}=0.4 m=1.3 ft (width of endplates)
Lⱼ=R_{R}=0.6 m=2 ft active slip ring length on each side
L_{R}=4R_{R}=2.4 m=8 ft (i.e. λ=4)
ω=100 RPM=1.67 rev/sec
v_{R}=ωR_{R}=6.3 m/sec=21 ft/sec
L→to be computed from input values)
N_{R}=300
B=1 tesla
ρ=1.65×10⁻⁸Ωm (for copper)
L_{BS}=0.05 m=2″ (length of single brush segment in sliding direction)
δL_{B}=2 cm (permissible brush wear length)
G=8×10¹⁰ N/m² (for copper)

Derived Parameters
t_{R}=R_{R}/3N_{R}=0.7 mm=28 thou (including insulating barrier 48) (eq.30)
₁V_{R}=2v_{R}BL_{R}=30 [V] (eq. 4 with n=2)
V_{M}=N_{R1}V_{R}=9000 [V]
Rᵢₙₜ=N_{R 1}Rᵢₙₜ=(ρN_{R}²/R_{R})[6λ+3πβ/2]≈0.083Ω (eq.31)
L=i²Rᵢₙₜ/W_{M}=3.8% (eq.32)i
E_{M}≅100%(1−2%−L−0.4[V]/₁V_{R})=92.9% (eq.36)
M_{M}=W_{M}/ω=W_{M} R_{R}/v_{R}=3.5×10⁶[Nm]=2.6×10⁶[lb ft]
Lⱼ=R_{R}=0.6 m=2 ft (active slip ring length each in zone (a) and in zone (b)) (eq.38)
d_{w}=R_{R}/4=0.15 m
A_{S}=N_{R} i/10⁶[A/m²]=1.23 m²=14 ft² (active slip ring area) (eq.39)
Δ=A_{S}/N_{R}Lⱼ=0.68 cm=0.27″ (width of individual slip ring) (eq.40)
L_{S}=N_{R}Δ=2.05[m]=6.9 ft (total axial extent of slip ring surfaces) (eq.41)
L_{M}=L_{R}+2L_{E}+L_{b}+L_{S}=(2.4+0.8+0.3+2.05)[m]=5.6 m=18 ft (eq.44)
T_{B}=δL_{B}/(v_{R}×5×10⁻¹¹)=6.4×10⁷ seconds=2 years (eq. 42)
N_{B}=2N_{R}(R_{R}/L_{BS})=7200 (eq. 43)
F=[(λ+4/3+1/β) )[(1.5²−(R_{P}/R_{R})²]+(Lₛ/R_{R})[(1−(R_{P}/R_{R})²]=12.4 (eq.45b)
m_{M}=FπR_{R}³=63 tonnes (eq. 45a)
m_{F}=3.93dλR_{R}³=25.5 tonnes (eq45c)
δm_{M}=0.44 m_{F}.=11.2 tonnes (45e)
m_{corr}=m_{M-}δm_{M}=52 tonnes
mₘᵢₙ=m_{M}/1.8=m_{M}/1.8 =35 tonnes (eq.45f)

$$\begin{matrix}{γ}_{el} = τ / G \\ = 3 {W}_{M} / ( 2 π {R}_{P} {R}_{R} {v}_{R} G ) \\ = 3 \times 3.7 \times {10}^{7} / [ 2 π \times 0.4 \times 0.6 \times 6.3 \times 8 \times {10}^{10} ] \\ = 0.015 \%\end{matrix} \qquad ( eq . 48 )$$

Comments

An outstanding virtue of both of the above examples is their high voltage and thus relatively low current, so that they do not strain the electric supply system beyond the mere fact that they draw a large power. At same rotation speed, diameter, voltage, current and power output, the present modified machine has a considerably reduced length, i.e. L_{M}=18 ft as compared to 30 ft, and correspondingly reduced mass, i.e. m_{M}=63 tonnes and m_{corr}=35 tonnes as compared to 130 tonnes and 52 tonnes, respectively. This weight reduction is bought at the expense of decreased machine efficiency (from 96.6% to 92.9%) and increased number of brushes (from 2400 to 7200).

Altogether, this would seem to be a very competitive design. Whether the large number of brushes poses a problem depends on the success of brush plates.

Following the present series of numerical examples, plans for mass production of brush plates in accordance with the present invention will be presented.

(1C) As 1A but with Voltage Lowered to 900V

Selected Parameters
W_{M}=50,000 hp=3.7×10⁷ watt
V_{M}=900 Volt
i=41,000 Ampere
R_{P}=0.4 m (radius of axle/bore through magnet to accommodate the propeller shaft)
R_{R}=0.6 m=2 ft
H=R_{R}=0.6 m=6 ft (α=60°)
D_{M}=3R_{R}=1.8 m=6 ft (eq.29)
L_{b}=R_{R}/2=0.3 m=1 ft (i.e. β=2) (width of bottom strip free of current channel insulation)
L_{E}=⅔ R_{R}=0.4 m=1.3 ft (width of endplates)
Lⱼ=R_{R}=0.6 m=2 ft active slip ring length on each
L_{R}=12R_{R}=7.2 m=24 ft (i.e. λ=12)
ω=100 RPM=1.67 rev/sec.
v_{R}=ωR_{R}=6.3 m/sec=21 ft/sec
N_{R}=10
B=1 tesla
ρ=1.65×10⁻⁸Ωm (for copper)
L_{BS}=0.05 m=2″ (length of single brush segment in sliding direction)
δL_{B}=2 cm (permissible brush wear length)
G=8×10¹⁰ N/m² (for copper)

Derived Parameters
t_{R}=R_{R}/3N_{R}=2 cm =0.8″
₁V_{R}=2v_{R}BL_{R}=90 [V] (eq.4 with n=2)
V_{M}=N_{R1}V_{R}=900 [V]
Rᵢₙₜ=N_{R 1}Rᵢₙₜ=(ρN_{R}²/R_{R})[6λ+3πβ/2]≅2.3×10⁻⁴Ω (eq.31
=L=i²Rᵢₙₜ/W_{M}=1% (eq.32) (same as for first example)
E_{M}25 100%(1−2%−L−0.4[V]/V_{R})=96.6% (eq.36) (same as for 1A)
M_{M}=W_{M}/ω=W_{M}R_{R}/v_{R}=3.5×10^{6[Nm]=}2.6×10⁶[lb ft]
Lⱼ=R_{R}=0.6 m=2 ft (active slip ring length each in zone (a) and in zone (b)) (eq.38)
d_{w}=R_{R}/4=0.15 m
A_{S}=N_{R} i/10⁶{A/m²]=0.41 m²=4.6 ft² (eq.39)) (same as for 1A)
Δ=A_{S}/N_{R}Lⱼ=6.8 cm=2.7″ (slip ring width) (eq. 40)
L_{S}=N_{R}Δ=0.68[m]=2.3 ft. (total slip ring width) (eq.41)(same as for 1A)
L_{M}=L_{R}+2L_{E}+L_{b}+L_{S}=(7.2+0.8+0.3+0.64)[m]=9 m=30 ft (same as 1A)
T_{B}=δL_{B}/(v_{R}×5×10⁻¹¹)=6.4×10⁷ seconds=2 years (eq. 42)
N_{B}=2N_{R}(R_{R}/L_{BS})=240 (eq.43)
F=[(λ+4/3+1/β))[(1.5)²−(R_{P}/R_{R})²]+(Lₛ/R_{R})[(1−(R_{P}/R_{R})²]=25.6 (Same as for 1A)
m_{M}=F_{πd}R_{R}³=130 tonnes (eq. 45a) (Same as for 1A)
m_{F}=3.93dλR_{R}³=76 tonnes (eq45c) (Same as for 1A)
δm_{M}=0.44 m_{F}=33.5 tonnes (45e) (Same as for 1A)
m_{corr}=m_{M-}δm_{M}=97 tonnes (Same as for 1A)
γel=τ/G=3W_{M}/(2π R_{P}R_{R}v_{R}G)=3×3.7×10⁷/[2π×0.4×0.6×6.3×8×10¹⁰]=0.015%

Comment

This version combines an undesirably large current with the undesirably high mass of the first example. Moreover, even while it has many fewer brushes, the same total brush area is required. The illusion of lessened demand for brushes arises on account of a tenfold increase of the slip ring width with only marginal advantages.

(1D) as 1B but with Voltage Lowered to 900V

(Most of the Repeated Values are not Listed)

Selected Parameters
W_{M}=50,000 hp=3.7×10⁷ watt
M_{M}=3.5×10⁶[Nm]=2.6×10⁶[lb ft]
V_{M}=900 Volt
i=41,000 Ampere
R_{R}=0.6 m=2 ft
D_{M}=3R_{R}=1.8 m=6 ft (eq.29)
L_{R}=4R_{R}=2.4 m=8 ft (i.e. λ=4)
ω=100 RPM
N_{R}=30
B=1 tesla

Derived Parameters
t_{R}=6.7 mm≈¼″
₁V_{R}=30 [V]
Rᵢₙₜ≈8.3×10⁻⁴Ω.
L=i²Rᵢₙₜ/W_{M}=3.8%
E_{M}92.9% (eq.36)
A_{S}=N_{R} i/10⁶{A/m²]=1.23 m²=14 ft² (active slip ring area)
Δ=A_{S}/N_{R}Lⱼ=0.68 cm=0.27″ (width of individual slip ring).
L_{S}=2.05[m] (added length for slip ring area)
L_{M}=5.6 m=18 ft
T_{B}=2 years (expected interval between brush plate replacements)
m_{corr}=52 tonnes

Conclusions Regarding Large Machines

The last example (1D) shares the low weight of the short-length version of the high-voltage machine (1B). The pattern demonstrated above is clear: One may tailor machine sizes and weights in accordance with machine length. However, at the same power and speed, the machine weight is not proportional to magnet length (and thus the voltage at same number of turns) on account of endplates that are determined by the machine power and total axial extent of slip rings. The latter grows in proportion with the number of rotors. The requirements on brushes for large machines as contemplated in the above example would be forbidding with individually held brushes, but are believed to be routine by the use of brush plates, as already discussed in connection with 1B above. The brush plate length is essentially the same as L_{S}, the total axial extent of the slip rings, and grows in proportion with the number of turns.

Contemplating actual requirements, the best choice for a 50,000 hp slow rotating, i.e. 100 RPM, ship drive motor, might be 4160V (to adapt to presently available naval voltage supplies), with i=8900 A, with a machine length a congruent 18 ft and weight ≅60 tonnes.

(b) Mid-Size Motor Suitable for Podded Ship Drives

(2) Mid-Sized Ship Drive, 5000 hp, 120 RPM, 4160V, L_{M}=5.4 m, 3 ft dia, B=1 tesla assumed.

Using the Same Parametric Relationships as before (i.e. eqs.4, 31-48)

Selected Parameters
W_{M}=5,000 hp=3.7×10⁶ watt (machine power at full speed)
ω=120 RPM=4π[rad/sec] (rotation speed at full power)
M_{R}=W_{M}/ω=2.9×10⁵ Nm=2.1×10⁵ ftlbs (torque at full current, independent of speed)
V_{M}=4160 Volt (applied voltage at maximum torque)
i=900 Ampere (current at maximum torque)
R_{R}=0.3 m=1 ft (rotor radius)
R_{P}=½R_{R}=0.15 m (axle radius)
D_{M}=3R_{R}=0.9 m=3 ft (diameter of flux return=machine diameter)
L_{R}=4.5 m=15 ft (i.e. λ=15)
L_{b}=0.1 m=4″ (i.e. β=3) (width of bottom strip free of current channel insulation)
L_{E}=⅔ R_{R}=0.2 m=0.67 ft (width of endplates)
Lⱼ=R_{R}=0.3 m=1 ft (active slip ring length on each side)
δL_{B}=2 cm (permissible brush wear length
v_{R}=3.8 m/s=12.6 ft/sec (brush sliding velocity at full speed)
₁V_{R}=2v_{R}BL_{R}=34V (voltage drop per rotor at full speed)
N_{R}=4160/34.2=122 (number of rotors)
t_{R}=R_{R}/3N_{R}=0.82 mm (rotor wall thickness, including insulation layer 48)
Rᵢₙₜ=(ρN_{R}²/R_{R})[6λ+3πβ/2]≈0.085Ω (internal electrical machine resistance).
L=i² Rᵢₙₜ/W_{M}=1.9% (loss due to internal electrical resistance at full current)
E_{M}≅100%(1−2%−L−0.4[V]/₁V_{R})=94.9% (efficiency including all losses)
A_{S}=N_{R} i/10⁶{A/m²]=0.11 m²=1.2 ft² (total active slip ring area)
Δ=A_{S}/N_{R}R_{R}=3 mm=0.12″ (width of individual slip ring including separator strip.
L_{S}=N_{R}Δ=0.37 m (added motor length due to slip ring area)
L_{M}=L_{R}+2L_{E}+L_{b}+L_{S}=5.4 m=18 ft (total machine length)
T_{B}=δL_{B}/(v_{R}×5×10⁻¹¹)=1.05×10⁸ seconds=3.3 years (expected time interval between brush plate replacements)
m_{M}≈(π/8)dD_{M}²(L_{M}+L_{R})=23.6 tonnes (machine mass at B=1 tesla throughout)
m_{F}=3.93dλR_{R}³=11.2 tonnes (mass of flux return at B=1 tesla)
δm_{M}=0.44m_{F}=5.25 tonnes (reduction of mass if B=1.8 tesla in flux return).
m_{corr}=m_{M}−δm_{M}=18.4 ton (mass with B=1 tesla in rotors and 1.8 tesla in flux return)

(c) Automotive Motors

(3) Car Motor, 150 hp, 4000 RPM, 150V, i=800 A, L_{M}=0.6 m=2 ft, B=1 tesla assumed.

Using the Same Parametric Relationships as before (i.e. eqs.4, 31-48)

Selected Parameters
W_{M}=1.2×10⁵ watt≅150 hp (machine power at full speed)
ω=4000 RPM=419 [rad/sec] (rotation speed at full power)
M_{R}=W_{M}/ω=290 Nm=210 ftlbs (torque at full current)
V_{M}=150 Volt (applied voltage at maximum torque)
i=800 Ampere (current at maximum torque)
R_{R}=0.1 m ≈4″ (rotor radius)
R_{P}=½″=1.25 cm (axle radius)
D_{M}=3R_{R}=0.3 m=1 ft (diameter of flux return=machine diameter)
L_{R}=0.45 m=1.5 ft (i.e. λ=4.5)
L_{b}=0.05 m=2″ (i.e. β=3) (width of bottom strip free of current channel insulation)
L_{E}=¼ R_{R}=0.025 m =1″ (width of endplates)
Lⱼ=R_{R}=0.1 m=4″ (active slip ring length on each side)
δL_{B}=2 cm (permissible brush wear length

Derived Parameters
v_{R}=ωR_{R}=42 m/s=140 ft/sec (perimeter velocity of rotors at full speed)
₁V_{R}=2v_{R}BL_{R}=37.8V (voltage drop per rotor at full speed).
N_{R}=V_{M}/₁V_{R}=4 (number of rotors)
t_{R}=R_{R}/3N_{R}=1.67 cm (rotor wall thickness including insulation layer 48)
Rᵢₙₜ=(ρN_{R}²/R_{R})[6 λ+3 πβ/2]≈1.1×10⁻⁴ Ω (internal electrical resistance of motor).
L=i²Rᵢₙₜ/W_{M}=0.1% (loss due to intemal electrical resistance at full current
E_{M}≅100%(1−2%−L−0.4[V]/₁V_{R})=97.5% (efficiency including all losses)
A_{S}=N_{R} i/10^{6[}A/m²]=2×10⁻³ m²=3.1 in² (required active slip ring area)
R_{SlipRing}=R_{R}/2=5 cm (reduced slip ring diameter to lower bush velocity)
v_{B}=ω R_{SlipRing}=21 m/sec (brush velocity at maximum speed)
Δ=A_{S}/N_{R}R_{SlipRing}=1 cm=0.4″ (required individual slip ring width with reduced slip ring diameter in order to reduce brush velocity)
L_{S}=N_{R}Δ=4 cm=1.6″ (added motor length due to slip ring area)
L_{M}=L_{R}+2L_{E}+L_{b}+L_{S}=0.6 m=2 ft (motor length)
T_{B}=δL_{B}(v_{R}×5×10⁻¹¹)=2×10⁷ seconds=5500 hrs (equal to expected life time of car!)
m_{M}≈(π/8)dD_{M}²(L_{M}+L_{R})=278 kg (motor mass at B=1 tesla throughout)
m_{F}=3.93dλR_{R}³=123 kg (mass of flux return at B=1 tesla)
δm_{M}=0.44 m_{F}=55 kg (reduction of mass if B=1.8 tesla in flux return)
m_{corr}=m_{M}−δm_{M}=223 kg (mass with B=1 tesla in rotors and 1.8 tesla in flux return)
mₘᵢₙ=m_{M}/1.8=154 kg (eq.45f) (minimum of motor mass with B=1.8 tesla throughout)

Comments

This appears to be an attractive but understated design. Certainly on account of the very low value of L, this motor could be driven to a much higher power output, or conversely at same power could be made lighter with somewhat lowered efficiency (compare numerical examples 1B versus 1A above).

(d) Motors Below Automotive Power

(4a) Ship Pump Motor, 10 hp, 400 RPM, 220V, i=50A, B=1 tesla assumed.

Using the Same Parametric Relationships as before (i.e. eqs.4, 31-48)

Selected Parameters
W_{M}=7,500 watt≅10 hp (power at full speed)
ω=400 RPM=42[rad/sec] (rotation speed at full power)
M_{R}=W_{M}/ω=179 Nm=131 ftlbs (torque at full current)
V_{M}=150 Volt (applied voltage at maximum toque)
i=50 Ampere (current at maximum torque)
R_{R}=0.05 m=2″ (rotor radius)
D_{M}=3R_{R}=0.15 m=½ ft (diameter of flux return=machine diameter)
L_{R}=0.6 m=2 ft (i.e. λ=12)
L_{b}=0.025 m=1″ (i.e. β=2) (width of bottom strip free of current channel insulation)
L_{E}=1/10 R_{R}=0.5 cm (width of endplates)
Lⱼ=R_{R}=5 cm (active slip ring length on each side)
δL_{B}=2 cm (permissible brush wear length)

Derived Parameters
v_{R}=ωR_{R}=2.1 m/s (brush sliding velocity at full speed)
₁V_{R}=2v_{R}BL_{R}=2.5V (voltage drop per rotor at full speed)
N_{R}=V_{M}/₁V_{R}=60 (number of rotors)
t_{R}=R_{R}/3N_{R}=0.83 mm (rotor wall thickness including insulation layer 48)
Rᵢₙₜ=(ρN_{R}²/R_{R})[6λ+3πβ/2]≈0.097 Ω (internal electrical resistance of motor)
L=i²Rᵢₙₜ/W_{M}=2.2% (loss due to internal electrical resistance at full current)
E_{M}≅100%(1−2%−L−0.4[V]/₁V_{R})=80% (efficiency including all losses)
A_{S}=N_{R} i/10⁶[A/m²]=3×10⁻³ m²=4.7 in² (required active slip ring area)
Δ=A_{S}/N_{R}R_{R}<Δₘᵢₙ i.e. choose Δ=Δₘᵢₙ=0.25 cm (individual slip ring width)
L_{S}=N_{R}Δₘᵢₙ=15 cm=6″ (added length due to slip ring area with Δ=Δₘᵢₙ=0.25 cm)
L_{M}=L_{R}+2L_{E}+L_{b}+L_{S}=0.79 m=2.6 ft (motor length)
T_{B}=δL_{B}/(v_{R}×5×10⁻¹¹)=1.9×10⁸ sec=6 years (compares to expected life time of pump)
m_{M}≈(π/8)dD_{M}²(L_{M}+L_{R})=92 kg=200 lbs (motor mass at B=1 tesla throughout)
m_{F}=3.93dλR_{R}³=44 kg=97 lbs (mass of flux return at B=1 tesla)
δm_{M}=0.44 m_{F}=19.5 kg (reduction of mass if B=1.8 tesla in flux return)
m_{corr}=m_{M}−δm_{M}=73 kg (mass with B=1 tesla in rotors and 1.8 tesla in flux return)
mₘᵢₙ=m_{M}/1.8=51 kg (eq.45f) (minimum of motor mass with B=1.8 tesla throughout)

(4B) Ship Pump Motor, 10 hp, 2500 RPM, 320V, i=24A, B=1 tesla assumed.

Using the Same Parametric Relationships as before (i.e. eqs.4, 31-48)

Selected Parameters
W_{M}=7,700 watt≅10 hp (power at full speed)
ω=2500 RPM=262[rad/sec] (rotation speed at full power
M_{R}=W_{M}/ω=29 Nm=21.6 ftlbs (torque at full current)
V_{M}=320 Volt (applied voltage at maximum toque)
i=24 Ampere (current at maximum torque)
R_{R}=0.05M=2″ (rotor radius)
D_{M}=3R_{R}=0.15 m=½ ft (diameter of flux return=machine diameter)
L_{R}=0.6 m=2 ft (i.e. λ=12)
L_{b}=0.025 m=1″ (i.e. β=2) (width of bottom strip free of current channel insulation)
L_{E}=1/10 R_{R}=0.5 cm (width of endplates)
Lⱼ=R_{R}=5 cm (active slip ring length on each side)
δL_{B}=2 cm (permissible brush wear length)

Derived Parameters
vR=ωRR=13.1 m/s (brush sliding velocity at full speed)
1VR=2vRBLR=15.7V (voltage drop per rotor at full speed)
NR=VM/1VR=20 (number of rotors)
tR=RR/3NR=0.25 cm (rotor wall thickness including insulation layer 48)
Rint=(ρNR2/RR)[6λ+3πβ/2]≈0.011 Ω (internal electrical resistance of motor).
L=i2 Rint/WM=0.08% (loss due to internal electrical resistance at full current)
EM≅100%(1−2%−L−0.4[V]/1VR)=96% (efficiency including all losses)
AS=NR i/106{A/m2]=4.8×10−4 m2=0.74 in2 (required active slip ring area)
Δ=AS/NRRR<Δmin i.e. choose Δ=Δmin =0.25 cm (individual slip ring width)
LS=NRΔmin=15 cm=6″ (added length due to slip ring area with Δ=Δmin=0.25 cm)
LM=LR+2LE+Lb+LS=0.79 m=2.6 ft (motor length)
TB=δLB/(vR×5×10−11)=1.9×108 sec=6 years (compares to expected life time of pump)
mM≈(π/8)dDM2(LM+LR)=92 kg=200 lbs (motor mass at B=1 tesla throughout)
mF=3.93dλRR3=44 kg=97 lbs (mass of flux return at B=1 tesla)
δm_{M}=0.44 m_{F}=19.5 kg (reduction of mass if B=1.8 tesla in flux return)
m_{corr}=m_{M}−δm_{M}=73 kg (mass with B=1 tesla in rotors and 1.8 tesla in flux return)
mₘᵢₙ=m_{M}/1.8=51 kg (eq.45f) (minimum of motor mass with B=1.8 tesla throughout)

(5) Wheelchair Motor, ¼ hp, 5500 RPM, 24V, 7.8A, 10 cm=⅓ ft Dia (B=1 Tesla Assumed). Using the Same Relationships, i.e. eqs.4, 31-48, as before. (for the Meaning of Symbols Ssee Above).

Selected Parameters
W_{M}=¼ hp=190 watt
V_{M}=24 Volt
i=7.8 Ampere
R_{R}=3.3 cm=1.3″
D_{M}=3R_{R}=0.1 m=⅓ ft
ω=5500 RPM=576 [rad/sec]
M_{R}=W_{M}/ω=0.34 Nm=0.24 lbft
v_{R}=19 m/sec
L_{R}=0.08 m (i.e. λ=2.4)
L_{E}=0.25 cm
L_{b}=0.3 cm (i.e. β=11)
δL_{B}=1 cm (permissible brush wear length)
₁V_{R}=2v_{R}BL_{R}=3V
N_{R}=V_{M}/₁V_{R}=8
N_{B}=16 (two brushes per rotor)

Derived Parameters
t_{R}=R_{R}/3N_{R}=2.8 mm (including insulation)
Rᵢₙₜ≈(ρN_{R}²/R_{R})6λ≈1.4×10⁻⁵ Ω
L=i² Rᵢₙₜ/W_{M}=4.5×10⁻⁶
E_{M}≅100%(1−2%−L−0.4[V]/₁V_{R})=84.7%
A_{S}=N_{B} i/10⁶ [m²]=1.3 cm²=0.2 in² (required active slip ring area)
Δ=A_{S}/N_{R}R_{R}=0.47 mm<Δₘᵢₙ i.e. choose Δ=Δₘᵢₙ=0.25 cm (slip ring width)
L_{S}=N_{R}Δₘᵢₙ=0.02 m (added length for slip ring area)
L_{M}=L_{R}+2L_{E}+L_{b}+L_{S}=10.8 cm=4.25″ (motor length)
T_{B}=δL_{B}/(v_{R}×5×10⁻¹¹)=1.05×10⁷ sec=4 months use before brush replacement
m_{M}≈(π/8)dD_{M}²(L_{M}+L_{R})=5.5 kg=12 lbs
m_{F}=3.93dλR_{R}³=2.5 kg
δm_{M}=0.44 m_{F}=1.1 kg
m_{corr}=m_{M}−δm_{M}=4.4 kg=10 lbs
mₘᵢₙ=m_{M}/1.8=3 kg=6.7 lbs

Comment

Except for the fairly high motor mass, this is an attractive design. It is dominated by the magnet and flux return, which might be mitigated by use of a ceramic composition. The remainder of the motor can be further lightened by using aluminum, i.e. by the factor d_{Cu}/d_{Al}=7.9/2.4=3.3.

(e) Small Motors

(6) Motor for Hand-Held Tool: ⅛ hp=100 watt, 12V, 8A, 20,000 RPM, B=1 Telsa. Using Eqs.4, 31-48, as Before. (For Meaning of Symbols See Numerical Example 4 Above).

Parameters
W_{M}=96 watt
V_{M}=12 Volt
i=8A
R_{R}=1.5 cm
D_{M}=3R_{R}=4.5 cm
L_{R}=R_{R}=12.8 cm (λ=8.5)
L_{b}=R_{R}/3 =0.5 cm
ω=15,000 RPM=250 rev/sec=1570 [rad/sec]
v_{R}=(ωR_{R}=23.5 m/sec
M_{R}=W_{M}/ω=0.061 [Nm]=0.53 lbin
¹V_{R}=2v_{R}BL_{R}=6[v] (eq.4 with n=2)
N_{R}=
N_{B}=4
t_{R}=R_{R}/3N_{R}=0.25 cm
ρ=1.65×10⁻⁸ Ωm (for copper)
Rᵢₙₜ≈(ρN_{R}²/R_{R})6λ≈2.2×10⁻⁴ Ω
L=i² Rᵢₙₜ/W_{M}=0.014%
E_{M}≅100%(1−2%−L−0.4[V]/₁V_{R})=91.3%
A_{S}=N_{B} i/10⁶ [m²]=0.32 cm²=0.05 in² (required active slip ring area)
Δ=A_{S}/N_{R}R_{R}=1 mm<Δₘᵢₙ i.e. choose Δ=Δₘᵢₙ=0.25 cm (individual slip ring width)
L_{S}=N_{R}Δ=0.5 cm (added length for slip ring area)
L_{M}=L_{R}+2L_{E}+L_{b}+L_{S}=14 cm=5.5″ (motor length)
δL_{B}=0.5 cm
T_{B}=δL_{B}/(v_{R}×5×10⁻¹¹)=4.3×10⁶ sec=1200 hours use before brush replacement
m_{M}≈(π/8)dD_{M}²(L_{M}+L_{R})=1.6 kg=3.5 lbs
m_{F}=3.93dλR_{R}³=0.84 kg
δm_{M}=0.44 m_{F}=0.37 kg
m_{corr}=m_{M}−δm_{M}=1.2 kg=2.7 lbs
mₘᵢₙ=m_{M}/1.8=0.89 kg=2 lbs

(f) Further Comments on Numerical Estimates and Regarding Bipolar Generators

In practice, machine mass can be a very important parameter, among others, for ship drives to hand-held tools. However, it is difficult to assess, and the above data for masses as well as other variables depend on construction details that in the future will presumably be optimized from case to case. Specifically, the above estimates were based on simple relationships between rotor radius, R_{R}, and other geometrical parameters, i.e. dimensions of magnet cross section and gap width. They thus depend on the particular relationship assumed. These are subject to variations according to preferences. The data are therefore only meant to serve as guidelines that reveal approximate values and trends.

Machines for hand-held tools are in the lower end of the size scale for bipolar motors. For these, rather high rotation speeds are desired but voltages are low and rotor diameters are restricted to, say, R_{R}=1.5 cm, as assumed above. Again, it would be desirable to lighten the motor. The best approach here may be the use of ceramic magnets.

The above are just a few examples to indicate the very wide range of applicability of bipolar motors. A similarly wide range of generators is, of course, possible since all of the above conceptual designs will operate equally well as motors and generators.

J. Additional Methods to be Used in Manufacturing Bipolar Machines

(a) Preferred Methods for Mass Production of Brush Holder Strips of Brush Plates

In section D(e), discussion of how to manufacture the fibrous parts of brush strips and how to attach them to the solid parts (e.g. as in FIG. 10A, whose thickness d_{w} will typically be comparable to R_{R}/4) was deferred. Preferably, these fibrous parts will be mass-produced and incorporated into brush plates, efficiently, with high quality control and at tolerable cost.

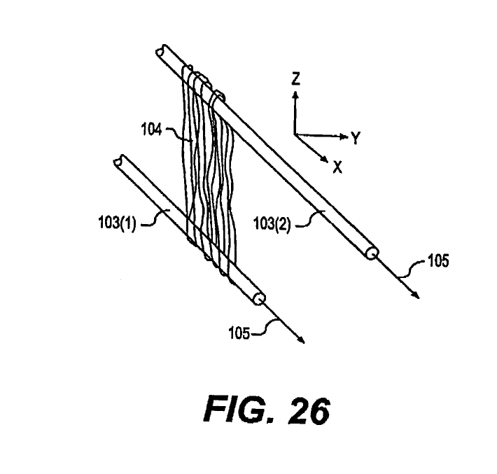

Those skilled in the field will acknowledge that various methods are available for manufacturing brush types of comparable morphology, e.g. tooth brushes, nail brushes, shoe brushes etc., The following method is an example of brush manufacturing, which is an adaptation and expansion of a method in ref. 11 (FIGS. 9 and 12A of ref 11), as explained below and in FIGS. 26 to 33:

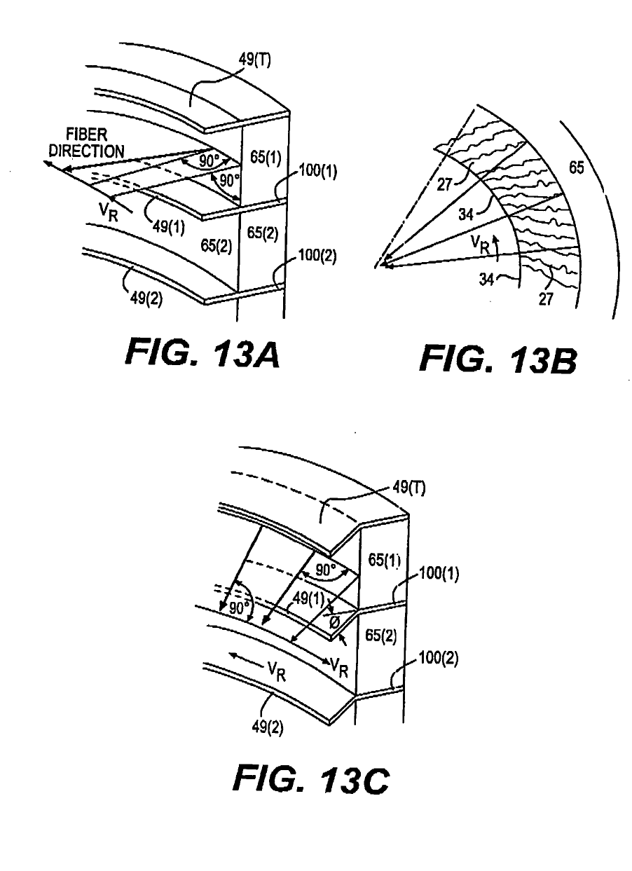

A preferable, but not exclusive, embodiment of brush fiber material are continuous metal fibers that have been kinked in order to provide “loft” (ref.11), and which have already been formed into tows of several to many individual fibers (104), so that they may be handled much like textile yarn. Other conductive fibers may be similarly used, singly or pre-assembled into strands. According to the present invention, such strands or tows will be wrapped or wound around parallel rails (103) of suitable size, shape and material, in a manner and orientation that will yield the desired metal fiber distribution and inclination relative to the strips as indicated in FIGS. 8 and 13 and illustrated in FIG. 26.

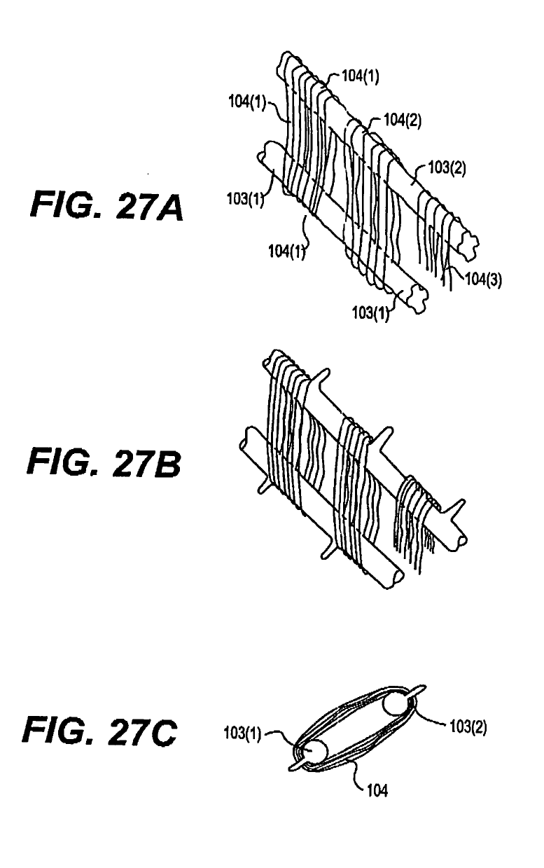

Typically but not necessarily, the rails (103) may be made of metal, (e.g. aluminum, copper, or their alloys), and the indicated winding or wrapping of the fiber tows (104) to their desired distribution along the rails will be done in a continuous fashion while the two rails advance in their long direction (105), i.e. the x-direction in FIG. 26. Advantageously, the cross section of the rails will be shaped to facilitate the wrapping/winding and/or to assure the secure subsequent positioning of the fibers in the further course of manufacture. Examples are indicated in FIG. 27, wherein the rails in FIG. 27A are roughened like concrete reinforcement bars, and those in FIG. 27B have posts that are shown in cross section in FIG. 27C. Also indicated in FIG. 27 is the fact that gaps are left between sections of fiber tow wrapping 104, that in the finished brush plates will be the gaps between fibers for moisture access. As already indicated, such gaps will presumably not be necessary if the machine operates while immersed in water and perhaps other fluids, in accordance with section (G).

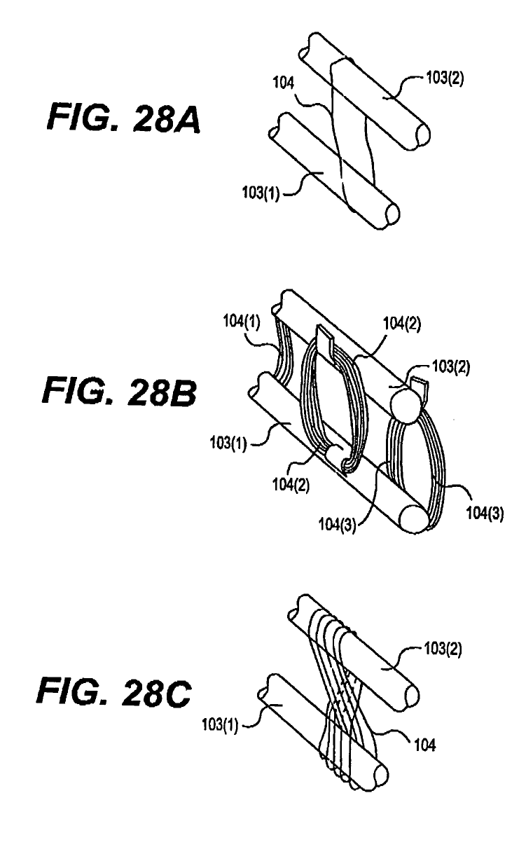

The discussed wrapping may take the form of ordinary looping about the two rails as in FIG. 28A, or it may be looping about protrusions from the rails as in FIG. 28B, or also, in the shape of figure eight's as shown in FIG. 28C. The choice among these and other conceivable modifications of wrapping will depend on manufacturing costs and effect on the final fiber distribution and properties. Specifically, the morphology of FIG. 28C will be advantageous for the eventual positioning of brush plates on closely spaced slip rings to which reference was made in section (De).

The indicated mechanical aids for fiber positioning may be replaced or supplemented by methods of adhesion of various forms, e.g. by coating the bars with a suitable adhesive or placing on them strips of two-sided adhesive foils etc.

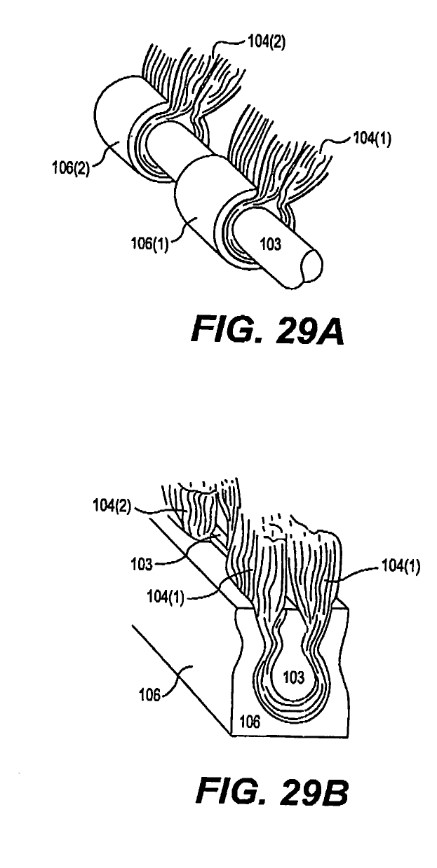

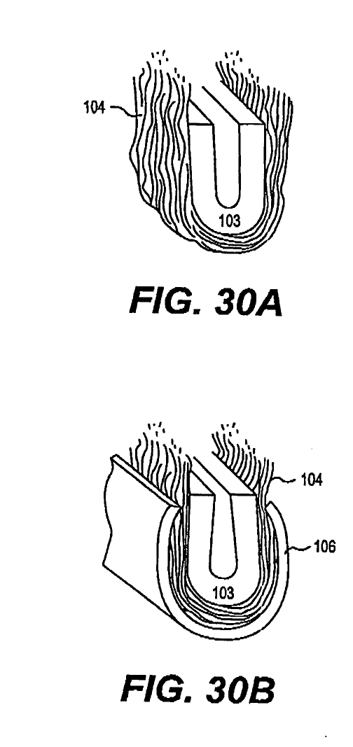

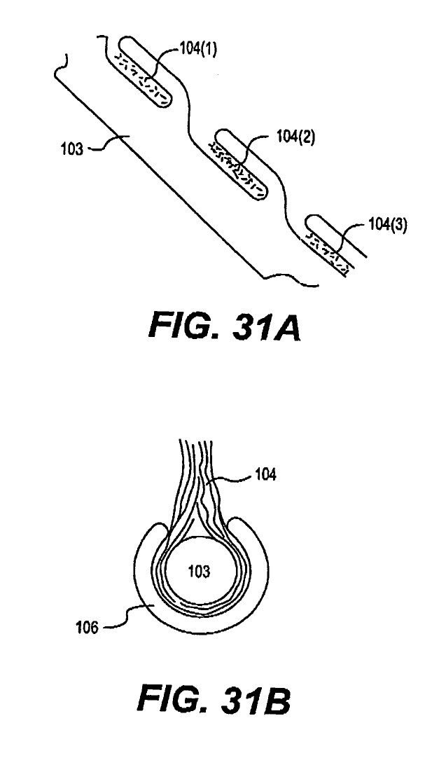

After obtaining the desired distribution of fibers on the two rails 103(1) and 103(2), they shall be covered with suitable plastically deformable metal sheath (106) either in the form of a continuous sheath as contemplated in FIG. 29B, or of pieces that are coordinated with the fiber distribution on the rails as in FIG. 29A. In either case the sheaths are crimped about the rails and fibers to form a firm mechanical, electrically conducting bond among the fibers and between the sheaths and the fibers, as indicated in FIG. 29. Possible loosening of the desired strong mechanical bond by elastic back-spring may be combated by leaving gaps in the rails, as indicated in FIG. 30 showing a cross section of a rail with cavity before (FIG. 30A) and after crimping (FIG. 30B). Also, tabs and/or protrusions extending from the rails as in FIGS. 27B and 28B will be flattened against the rails as indicated in FIG. 31A and thereby add to the mechanical bonding between rails 103 and fiber sections 104(1), 104(2) etc.

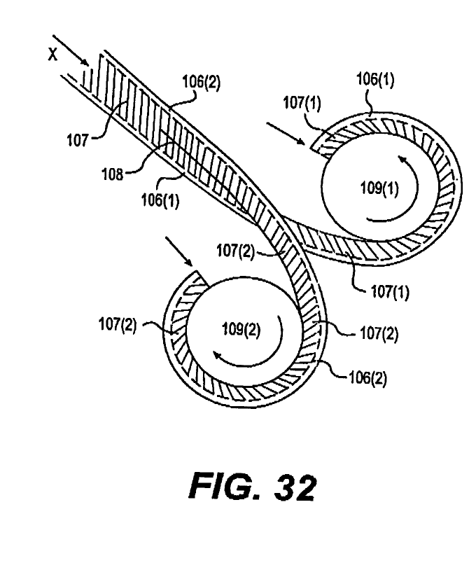

Preferably, the rails will be of an electrically conductive material, (e.g. copper, brass, aluminum or aluminum alloy), so that the mechanical bonding between rails and sheaths with the intervening fibers through the crimping will also be conductive between sheaths and rails, thereby reducing the eventual internal resistance of the resulting brush plates. In line with the previous indication regarding the use of adhesive as an aid in, if not the means of, positioning the fibers, the mechanical bonding through crimping may be supplemented, if not replaced by conductive adhesion, (e.g. by means of epoxy filled with metal or graphite powder.) Also soldering, brazing, or any other suitable method could be used. After the discussed crimping or other bonding method, the intended running surfaces must be shaped into rail strips. One method is to embed sheaths and fiber wrapping in a suitable hard material, or at least a zone of the fibers between the rails shall be so embedded, so as to permit making a lengthwise cut through the middle of the structure as indicated in FIG. 32. Herein label 107 indicates the embedded fiber material that is cut at position 108 in FIG. 32. At the time of cutting, the embedment material must be hard enough to permit making a clean cut through the fibers without unduly distorting their shape and distribution.

While the embedment of whatever material is still in place, the ends of the embedded fibers 107 can be machined or otherwise shaped to their final intended contour for sliding on the slip rings, with high precision, e.g. by cutting in a lathe, by grinding, by smoothing with emery paper and/or any other mechanical means. Thereafter the embedment is removed by dissolving, melting away, sublimation or any other suitable method and the fibers are cleaned from residue that might interfere with the later electrical conduction from brush plate to slip rings. Thereafter, the now completed fibrous part of the brush strip may be affixed to its designated brush plate strip 65 and on to final assembly into brush plates by any of the methods already discussed in conjunction with FIGS. 9 and 10, including soldering, conductively gluing, dove-tailing or other. The order of the steps enumerated above is given by way of example and is not exclusive. This may therefore be rearranged as may be most suitable, consistent with the production of serviceable brush plates, preferably of high precision and produced without undue expense.

(b) Fiber Embedment and Shaping the Running Surfaces of Brush Plates

Above reference was made to the proposed transient embedment of the fibers in order to permit cutting and shaping them. Such a temporary filler material is helpful for all brush sizes and is definitely necessary for fiber brushes with relatively large running surfaces, e.g. above a few millimeters diameter. Brushes of small running surface areas and relatively long lengths, may indeed be cut and shaped simply by cutting with scissors or a razor blade, e.g. while the fibers project out of a glass tubing.

(c) Preferred Filler Materials for Current Channel Insulation within Slots on Slip Rings

Above, stop-off lacquer has been repeatedly named as a favored material for filling slots or cuts. For cuts within the layered rotors, this is an excellent choice, especially also since it may at the same time serve as an insulating layer between adjoining rotors. Many other polymers, ceramics and composites will also be found useful.

(d) Methods for Placing Brush Plates on Slip Ring Assemblies

Preferred aids in placing brush plates on slip rings have already been discussed in section (De). In one embodiment according to the present invention, the fibrous parts of brush strips will be manufactured so that initially the fibers lean inward, (i.e. towards the length-wise mid-line of the slip rings), so as to leave distinct gaps between adjacent brush strips before use. The winding method shown in FIG. 28C will yield that desired shape. This is indicated in FIG. 31B, which shows the expected initial fiber morphology after crimping and cutting a fiber winding, as in FIG. 28C. In this method, care must be taken that the initial gaps are wide enough for placing the later, perhaps rather large, brush plates onto parallel slip rings with separators 49 or slip ring extensions 33, e.g. as in the morphology of FIGS. 8, 16, 21 and 22. Care should be taken in the brush construction that, in the course of use, the fibers spread out against the adjoining slip ring separators 49 and slip ring extensions 33 as little as possible.

According to the present invention, another preferred method for inserting fibrous brush strip parts on brush plates between slip ring separators (49) during brush plate installation, is to stitch the fibers together in two parallel lines before embedment. Cut (108) as in FIG. 32 will then be made between the two stitched lines, as indicated in FIG. 34. Preferably, said stitching will be easily removable. Preferably, also, the stitching will remain in place until the brush plate has been placed and may be removed as a late or perhaps the last step in brush plate installation.

(e) Protecting Machines Against Failure of Individual Brush Strips

Since the brush strips in brush plates, and similarly equi-potential brush sequences on consecutive slip rings, are “in series”, the failure of a brush strip or brush sequence may cause failure of the whole machine. This risk is expected to rise with the number of rotors, N_{R}. In order to prevent such failures (however unlikely, given the general reliability of fiber brushes, mass production techniques for brush plates, and their stringent quality control) according to the present invention the insulation between adjacent brush strips or brush sequences shall break down, and the affected brush strips thereby be automatically short-circuited once the potential drop between them increases beyond some predetermined limit, (e.g. 5×V_{M}N_{R}), and similarly for the insulation between adjacent brush sequences.

The desired automatic short-circuiting between adjacent slip rings on which the brushes fail may be accomplished by a variety of electronic means. A simple means to effect the discussed short-circuiting about failing brushes is the use of “dielectric breakdown bonding” (100), i.e. mechanical bonding that optionally incorporates an insulating material between adjacent brush strips or brush sequences whose dielectric breakdown voltage equals a pre-determined cut-off limit, (i.e. 5×V_{M}N_{R}) in the discussed specific case.

Various suitable insulators with pre-determined dielectric breakdown voltages are available. A preferred embodiment according to the present invention is oxidized aluminum foils of the kind widely used in commercial capacitors. Their dielectric breakdown electric field strength may be varied through varying their thickness and/or the thickness of their oxide layer that may be controlled through electrolysis.

In the discussed method of machine protection against the failure of a minority of brushes, according to the present invention, adjacent brush plate layers, 65(n), in brush plates, e.g. as in FIG. 10, would be glued together by means of electrically conductive adhesive applied to both sides and with the insulating foil of pre-determined dielectric breakdown field sandwiched between the two thin conductive layers of adhesive. In the normal mode of operation, the foil with predetermined dielectric breakdown voltage will serve as an insulating barrier among neighboring brush strips. However, should brushes fail and the voltage rise to the pre-determined limiting value, dielectric breakdown would occur and direct electrical connection would be established between the nearest still functioning brush strips.

### References

Each of the below references (1)-(18) are incorporated by reference herein
1. A. S. Langsdorf, “Principles of Direct-current Machines”, McGraw-Hill, NY 1959.
2. D. Kuhlmann-Wilsdorf; “Management of Contact Spots Between an Electrical Brush and Substrate”, U.S. and International (PCT) Patent Application, filed Oct. 22, 1999, U.S. Ser. No. 60/105,319.
3. G. R. Slemon, “Magnetoelectric Devices, Transducers, Transformers and Machines”, John Wiley and Sons, NY) 1966.
4. L. J. Petersen, D. Urciuol, M. Alma, T. H. Fiske, L. D. Stubbs, W. A. Lynch and N. A. Sondergaard (Naval Surface Warfare Center), D. Kuhlmann-Wilsdorf J. T. Moore and R. B. Nelson (UVA), M. S. Bednar, W. M. Elger, R. W. Johnson and R. J. Martin (Noesis) and M. Heiberger (General Atomics Corp.), “A Study of the Magnetic Field Effects upon Metal Fiber Current Collectors in a High Critical Temperature Superconducting Homopolar Motor”, Proc. Third Naval Symposium on Electric Machines 2000, Philadelphia, Pa., Dec. 4-7, 2000. (On CD).
5. J. E. Noeggerath, Trans. AIEE, 24, 1 (1905)
6. B. G. Lamme, Trans. AWEE, 31, (part II), 1811 (1912).
7. See Jim Treible, Mroquette Engineer, April 1955.
8. A. H. Barnes, U.S. Pat. No. 2,588,466, Mar. 11, 1952.
9. D. Kuhlmann-Wilsdorf, C. M. Adkins, and H. G. F. Wilsdorf, “An Electric Brush and Method of Making”, U.S. Pat. No. 4,415,635, Nov. 15, 1983.
10. D. Kuhlmann-Wilsdorf; “A Versatile Electrical Fiber Brush and Method of Making”, U.S. Pat. No. 4,358,699, Nov. 9, 1982.
11. D. Kuhlmann-Wilsdorf, D. D. Makel and G. T. Gillies, “Continuous Metal Fiber Brushes”, U.S. Pat. No. 6,245,440, Jun. 12, 2001.
12. “Metal Fiber Brushes”, D. Kuhlmann-Wilsdorf, (Chapter 20 in “Electrical Contacts: Principles and Applications”, Ed. p. G. Slade, Marcel Deldker, NY), 1999, pp.943-1017.
13. D. Kuhlmann-Wilsdorf “Holder for Electrical Brushes and Ancillary Cables”, U.S. patent application, filed Apr. 21, 2000, Ser. No. 09/556,829.
14. D. Kuhlmann-Wilsdorf and R. J. Martin, in Proc. Naval Symp. on Electric Machines (Office of Naval Research in coordination with Carderock Div. Naval Surface Warfare Center and Naval Undersea Warfare Center, Division Newport), Oct. 26-29, 1998, Annapolis, Md.), pp.191-198.
15. C. M. Adkins III and D. Kuhlmann-Wilsdorf, “Development of High-Performance Metal Fiber Brushes II—Testing and Properties”, Electrical Contacts—1979 (Proc. Twenty-Fifth Holm Conf on Electrical Contacts, Ill. Inst. Techn., Chicago, Ill., 1979), pp. 171-184.
16. D. Kuhlmann-Wilsdorf, “Eddy Current Barriers”, Provisional Patent Application Ser. No. 60/289,123, Filed May 8, 2001.
17. D. Kuhlmann-Wilsdorf, “A Novel Tubular Brush Holder”, Provisional Patent Application Ser. No. 60/286,969, Filed Apr. 30, 2001.
18. D. Kuhlmann-Wilsdorf “Optimizing Homopolar Motors/Generators”, Provisional Patent Application Ser. No. 60/297,283, Filed Jun. 12, 2001.

1. A homopolar motor configured to be driven by a current source comprising:
at least one rotor having a plurality of current channel insulation layers configured to create anisotropic current flow in predetermined current paths;
at least one stator;
at least one electrical brush pair fastened to the stator and electrically connected to the predetermined current paths between current channel insulation layers;
a magnetic field source, capable of generating a magnetic field penetrating the rotor and intersecting the predetermined current paths such that when the motor is driven by the current source a relative rotational force is created on the rotor.

2. A homopolar motor according to claim 1, wherein the current channel insulation layers are configured so as to inhibit transverse currents.

3. A homopolar motor according to claim 1, wherein the current channel insulation layers extend through the thickness of the rotor.

4. A homopolar motor according to claim 1, wherein the current channel insulation layers are spaced less than 1 cm apart.

5. A homopolar generator configured to generate a current when a mechanical torque is applied, comprising:
at least one rotor having a plurality of current channel insulation layers configured to create anisotropic current flow in predetermined current paths;
at least one stator;
at least one electrical brush pair fastened to the stator and electrically connected to the predetermined current paths between current channel insulation layers;
a magnetic field source, capable of generating a magnetic field penetrating the rotor and intersecting the predetermined current paths such that when the rotor is rotated by the mechanical torque, the magnetic field source induces a current within the predetermined current paths.

6. A homopolar generator according to claim 5, wherein the current channel insulation layers are configured so as to inhibit transverse currents.

7. A homopolar generator according to claim 5, wherein the current channel insulation layers extend through the thickness of the rotor.

8. A homopolar generator according to claim 5, wherein the current channel insulation layers are spaced less than 1 cm apart.

9. A homopolar motor according to claim 2, wherein the current channel insulation layers comprise a plurality of slots within the rotor.

10. A homopolar generator according to claim 6 wherein the current channel insulation layers comprise a plurality of slots within the rotor.

11. A homopolar motor according to claim 1, wherein the current channel insulation layers comprise the surfaces of assemblies of mutually electrically insulated, substantially parallel electrical conductors that are extended in the axial direction but have a narrow spatial dimension at right angles to both the tangential direction and the magnetic field.

12. A homopolar generator according to claim 5, wherein the current channel insulation layers comprise assemblies of mutually electrically insulated, substantially parallel electrical conductors that are extended in the direction of the induced current but have a narrow spatial dimension at right angles to both the tangential direction and the magnetic field.

13. A homopolar motor according to claim 1, wherein the rotor further comprises:
at least one conductive slip ring that is in electrical contact with the predetermined current paths, and that rotates with the rotor about the same axis, and
at least one electrical brush that is in sliding electrical contact with the at least one conductive slip ring, such that the at least one electrical brush is in electrical contact with the current paths.

14. A homopolar motor according to claim 13, wherein each of the predetermined current paths has a width in the transverse direction that is smaller than the width of the at least one electrical brush in the transverse direction.

15. A homopolar motor according to claim 13, wherein each of the predetermined current paths is smaller than one half of the width of the at least one electrical brush in the transverse direction.

16. A homopolar generator according to claim 5, wherein the rotor further comprises:
at least one conductive slip ring that is in electrical contact with the predetermined current paths, and that rotates with the rotor about the same axis, and
at least one electrical brush that is in sliding electrical contact with the at least one slip ring, such that the at least one electrical brush is in electrical contact with the predetermined current paths.

17. A homopolar generator according to claim 16, wherein each of the predetermined current paths has a width in the transverse direction that is smaller than the width of the at least one electrical brush in the transverse direction.

18. A homopolar generator according to claim 16, wherein each of the predetermined current paths has a width in the transverse direction that is smaller than one half of the width of the at least one electrical brush in the transverse direction.

19. A rotor for use in a homopolar motor or generator comprising:
a conductive rotor with predetermined current paths between current channel insulation layers, wherein the predetermined current paths between the current channel insulation layers are adapted to conducting an applied current in a motor or a current induced by a magnetic field in a generator; and
wherein the predetermined current paths are configured for anisotropic current flow between at least one pair of electric brushes.

20. A rotor according to claim 19, wherein the spacing of the current channel insulation layers is smaller than the widths of the brushes in the at least one pair of electrical brushes in the transverse direction.

21. A rotor according to claim 19, wherein the spacing of the current channel insulation layers is smaller than one half of the widths of the brushes in the at least one pair of electrical brushes in the transverse direction.

22. A rotor according to claim 19, wherein the current channel insulation layers are configured to interrupt eddy currents.

23. A current channel for use in a rotor of a motor or generator, comprising:
at least two current channel insulation layers situated contiguously with respect to a conductive current path and configured to enforce anisotropic current flow, and
wherein said current path is adapted to conduct an applied current in a motor or a current induced by a magnetic field in a generator between at least one electrical brush pair.

24. A current channel according to claim 23, wherein the transverse width of the current path is smaller than the width in the transverse direction of each of the brushes within the at least one electrical brush pair.

25. A current channel according to claim 23, wherein the transverse width of the current path is smaller than one half of the width in the transverse direction of each of the brushes within the at least one electrical brush pair.

26. A homopolar motor according to claim 1 wherein the rotor is cylindrical and the magnetic field source comprises a magnet that is situated within the rotor, and is elongated in the direction of the rotation axis of the rotor, and has an axis of magnetization that is at right angles to the rotation axis so as to generate in the rotor two diametrically opposed, axially extended zones in which the rotor is radially penetrated by a magnetic field of opposite sense of radial direction.

27. A homopolar motor configured to be driven by a current source comprising:
at least one electrically conductive rotatable rotor configured to flow a current in current path when the motor is driven by the current source;
a magnetic field source configured to apply a magnetic field penetrating the rotor and intersecting the current path when the motor is driven by the current source;
a multiplicity of current channel insulation layers through the thickness of said rotor provided so as to be parallel to said current path during rotation of said rotor; and
at least one electrical brush simultaneously electrically connected to the current path between at least three of said current channel insulation layers.

28. A homopolar motor configured to be driven by a current source comprising:
at least one electrically conductive rotatable rotor configured to flow a current in a current path when the motor is driven by the current source;
a magnetic field source configured to apply a magnetic field penetrating the rotor and intersecting the current path when the motor is driven by the current source;
a multiplicity of current channel insulation layers provided so as to be parallel to said current path during rotation of said rotor; and
at least one electrical brush whose width is at least two times larger than the spacing between said current channel insulation layers.

29. A homopolar generator configured to generate a current when rotated by a mechanical torque comprising:
at least one electrically conductive rotatable rotor configured to flow a current in current path when the generator is rotated by a mechanical torque;
a magnetic field source configured to apply a magnetic field penetrating the rotor and intersecting the current path when the generator is rotated by a mechanical torque;
a multiplicity of current channel insulation layers through the thickness of said rotor provided so as to be parallel to said current path during rotation of said rotor; and
at least one electrical brush simultaneously electrically connected to the conducting material between at least three of said current channel insulation layers.

30. A homopolar generator configured to generate a current when rotated by a mechanical torque comprising:
at least one electrically conductive rotatable rotor configured to flow a current in at current path when the generator is rotated by a mechanical torque;
a magnetic field source configured to apply a magnetic field penetrating the rotor and intersecting the current path when the generator is rotated by a mechanical torque;
a multiplicity of current channel insulation layers in said rotor provided so as to be parallel to the current path during rotation of said rotor; and
at least one electrical brush whose width is at least two times larger than the spacing between said current channel insulation layers.

31. A homopolar generator according to claim 30 wherein the current channel insulation layers are the electrically insulated surfaces of a plurality of slots within the rotor.

32. A homopolar generator according to claim 5 wherein the rotor is cylindrical and the magnetic field source comprises a magnet that is situated within the rotor, and is elongated in the direction of the rotation axis of the rotor, and has an axis of magnetization that is at right angles to the rotation axis so as to generate in the rotor two diametrically opposed, axially extended zones in which the rotor is radially penetrated by a magnetic field of opposite sense of radial.

33. A homopolar generator according to claim 5 wherein the rotor comprises a circular disk, and the magnetic field source comprises a first pair of curved horseshoe magnets on one side of the rotor and a second pair of curved horseshoe magnets in anti-symmetric mirror position on the other side of the rotor with respect to the first pair of curved horseshoe magnets.
